(19) United States
(12) Patent Application Publication
(10) Pub. No.: US 2026/0367750 A1
(43) Pub. Date: Nov. 19, 2026

(54) DEVICES, METHODS, AND GRAPHICAL USER INTERFACES FOR DISPLAYING CONTROLS OF A COMPUTER SYSTEM IN RESPONSE TO INPUT

(71) Applicant: Apple Inc., Cupertino, CA (US)

(72) Inventors: Matan STAUBER, Brooklyn, NY (US); Stephen O. LEMAY, Palo Alto, CA (US); Zoey C. TAYLOR, Los Angeles, CA (US)

(21) Appl. No.: 19/671,719

(22) Filed: May 8, 2026

Related U.S. Application Data
(60) Provisional application No. 63/808,178, filed on May 19, 2025.

(51) Int. Cl. G06F 3/04815; G06F 3/04847; G06F 3/0485; G06F 3/16

(52) U.S. Cl. CPC G06F 3/04815; G06F 3/04847; G06F 3/0485; G06F 3/165

(57) ABSTRACT

A computer system displays a control user interface of the computer system in response to detecting an input corresponding to a request to display the control user interface of the computer system. A computer system displays a volume control user interface that optionally includes a first volume control for controlling a volume level a first application in response to an input that corresponds to a request to expand a system volume control element.

### TECHNICAL FIELD

This application claims the benefit of U.S. Provisional Application No. 63/808,178, filed May 19, 2025, the entire disclosure of which is herein incorporated by reference for all purposes.

### TECHNICAL FIELD

The present disclosure relates generally to computer systems that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has (e.g., includes or is in communication with) a display generation component (e.g., a display device such as a head-mounted device (HMD), a display, a projector, a touch-sensitive display (also known as a “touch screen” or “touch-screen display”), or other device or component that presents visual content to a user, for example on or in the display generation component itself or produced from the display generation component and visible elsewhere). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with a three-dimensional environment. Such methods and interfaces may complement or replace conventional methods for interacting with a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In some embodiments, a computer system detects an input corresponding to a request to display a control user interface of the computer system. In some embodiments, in response to detecting the input corresponding to the request to display the control user interface of the computer system, the computer system displays the control user interface of the computer system. In some embodiments, the control user interface includes an immersive environment control user interface element configured to control one or more environment parameters of an immersive environment of the computer system and a plurality of system controls configured to control a plurality of system functions of the computer system.

In some embodiments, while displaying a system volume control element for controlling a volume level of a computer system via one or more display generation components, the computer system detects, via one or more input devices, a first input directed to the system volume control element corresponding to a request to expand the system volume control element. In some embodiments, in response to detecting the first input, in accordance with a determination that one or more first criteria are satisfied, including a criterion that is satisfied when a first application of the computer system is currently active on the computer system, displaying, via the one or more display generation components, a volume control user interface that includes a first volume control for controlling a volume level of the first application. In some embodiments, in response to detecting the first input, in accordance with a determination that the one or more first criteria are not satisfied due to the first application not being currently active on the computer system, displaying, via the one or more display generation components, the volume control user interface without displaying the first volume control for controlling the volume level of the first application in the volume control user interface.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating an operating environment of a computer system for providing XR experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in accordance with some embodiments.

FIG. 3A is a block diagram illustrating a display generation component of a computer system that is configured to provide a visual component of the XR experience to the user in accordance with some embodiments.

FIGS. 3B-3G illustrate the use of Application Programming Interfaces (APIs) to perform operations.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flow diagram illustrating a glint-assisted gaze tracking pipeline in accordance with some embodiments.

FIGS. 7A-7Y generally illustrate examples of a computer system detecting and responding to requests to display a control user interface of the computer system in accordance with some embodiments.

FIG. 8 is a flowchart illustrating an exemplary method for displaying a control user interface of a computer system in response to detecting an input corresponding to a request to display the control user interface of the computer system in accordance with some embodiments.

FIGS. 9A-9Z generally illustrate examples of a computer system detecting and responding to request to display a volume control user interface of the computer system in accordance with some embodiments.

FIG. 10 is a flow diagram illustrating an example method for displaying a volume control user interface in response to detecting an input corresponding to a request to expand a system volume control element in accordance with some embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, a computer system detects an input corresponding to a request to display a control user interface of the computer system. In some embodiments, in response to detecting the input corresponding to the request to display the control user interface of the computer system, the computer system displays the control user interface of the computer system. In some embodiments, the control user interface includes an immersive environment control user interface element configured to control one or more environment parameters of an immersive environment of the computer system and a plurality of system controls configured to control a plurality of system functions of the computer system.

In some embodiments, while displaying a system volume control element for controlling a volume level of a computer system via one or more display generation components, the computer system detects, via one or more input devices, a first input directed to the system volume control element corresponding to a request to expand the system volume control element. In some embodiments, in response to detecting the first input, in accordance with a determination that one or more first criteria are satisfied, including a criterion that is satisfied when a first application of the computer system is currently active on the computer system, displaying, via the one or more display generation components, a volume control user interface that includes a first volume control for controlling a volume level of the first application. In some embodiments, in response to detecting the first input, in accordance with a determination that the one or more first criteria are not satisfied due to the first application not being currently active on the computer system, displaying, via the one or more display generation components, the volume control user interface without displaying the first volume control for controlling the volume level of the first application in the volume control user interface.

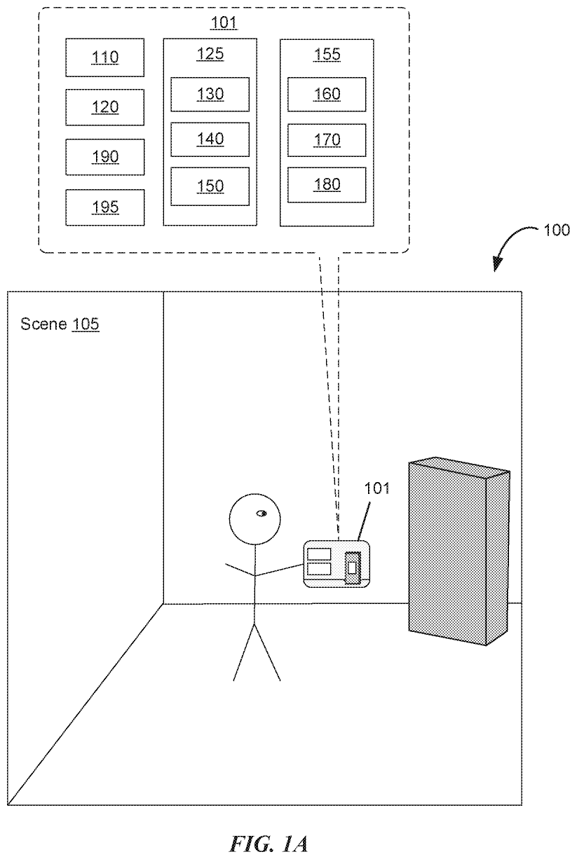

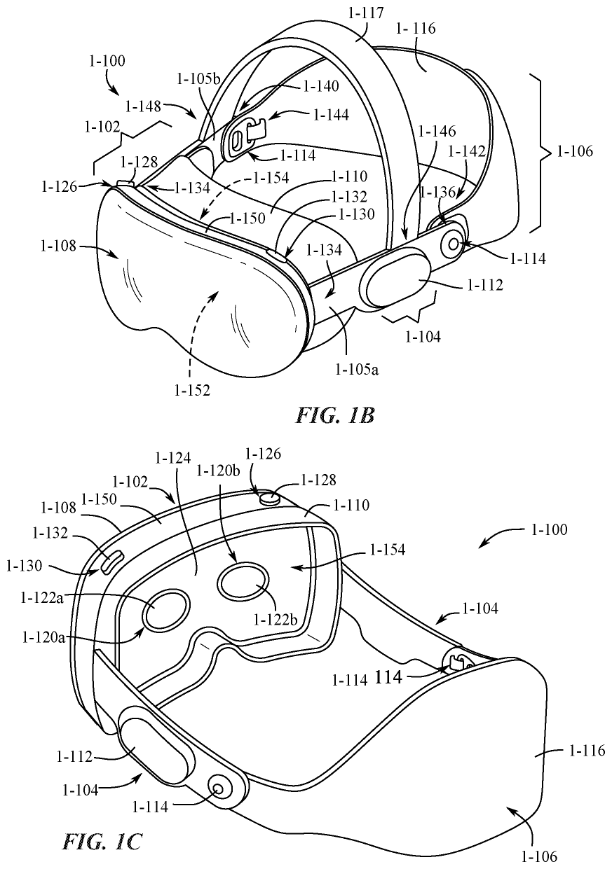

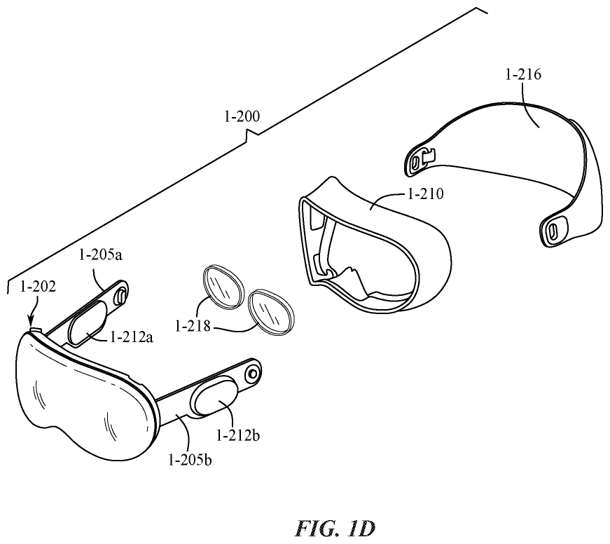

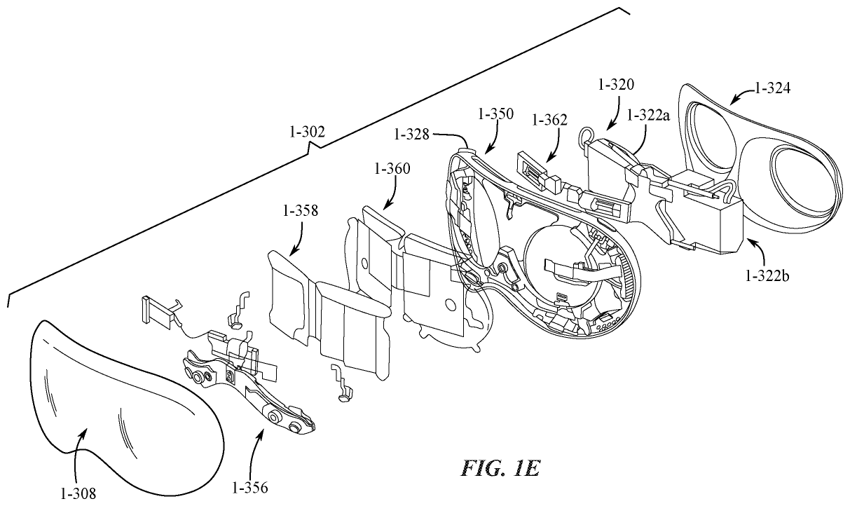

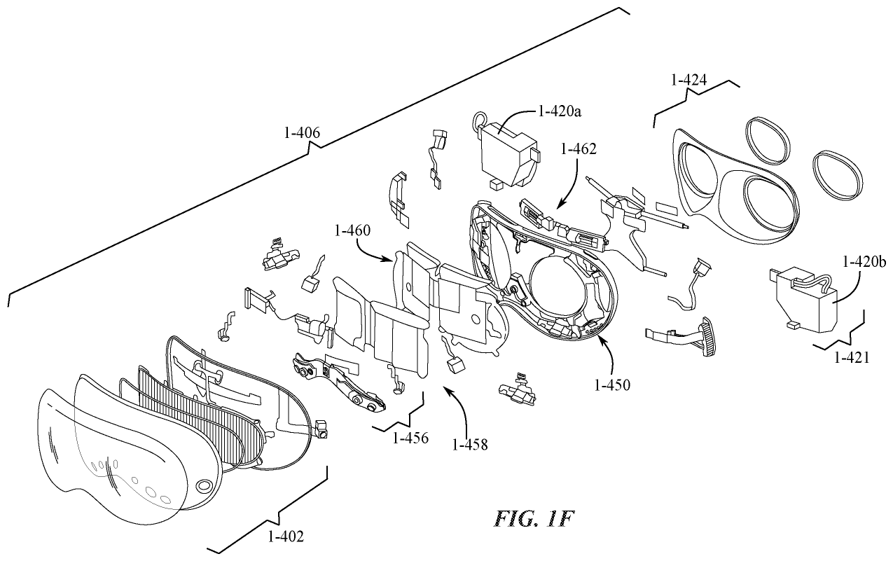

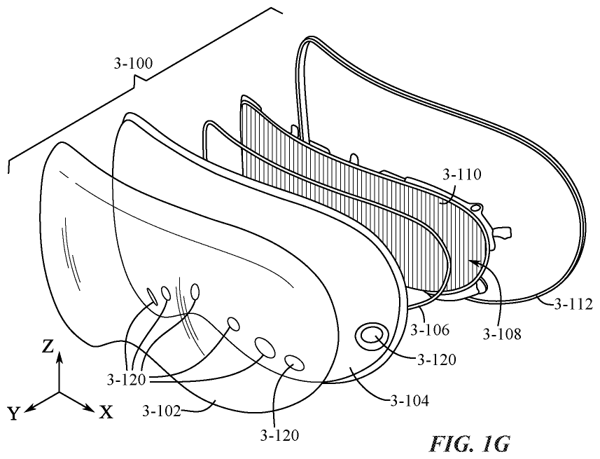

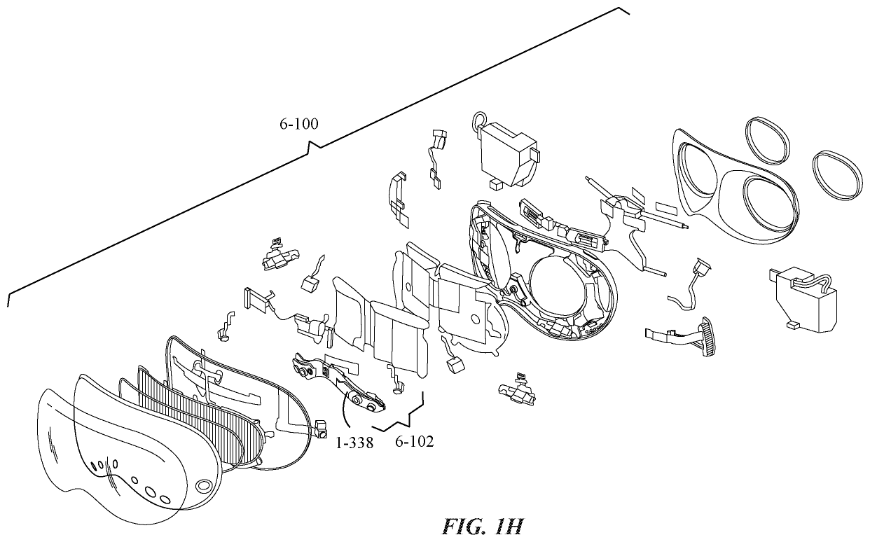

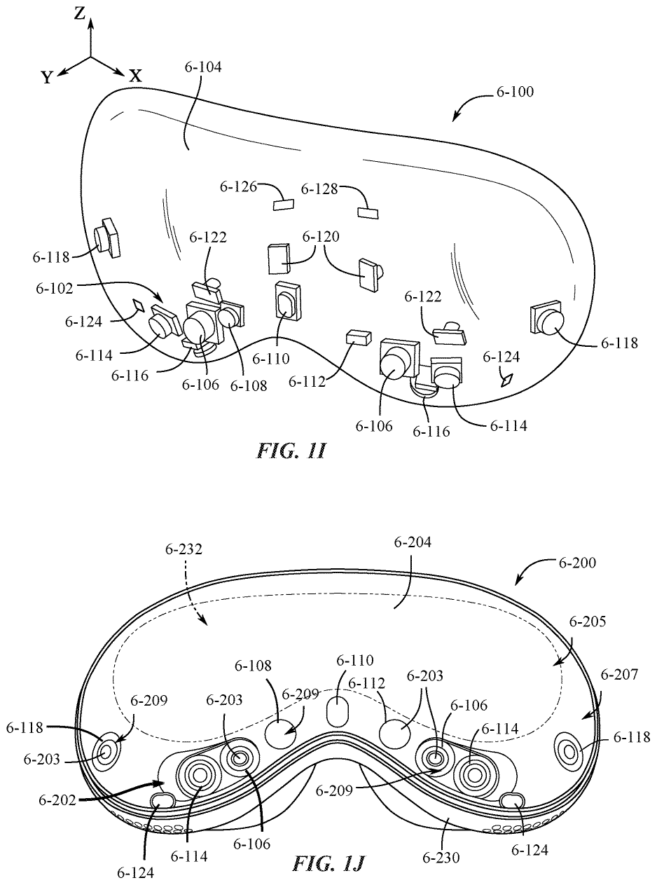

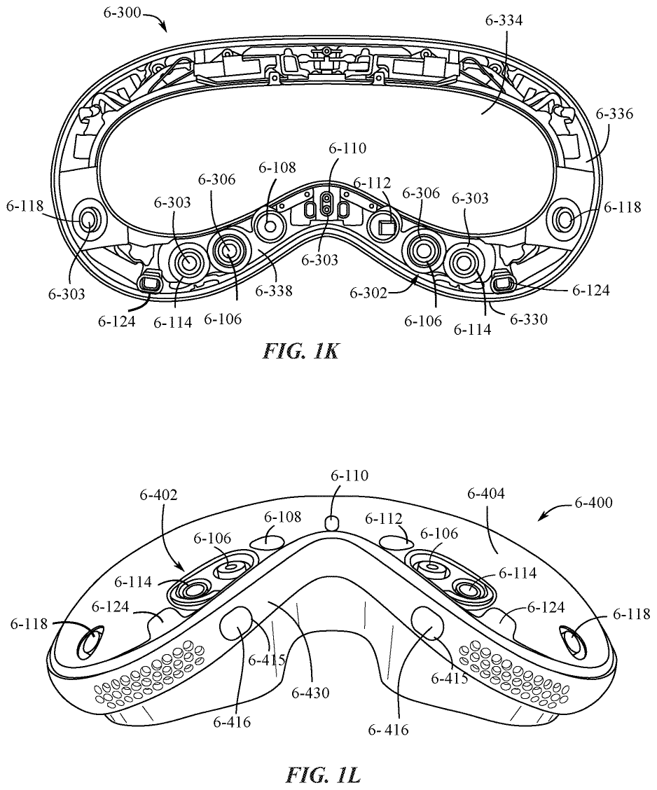

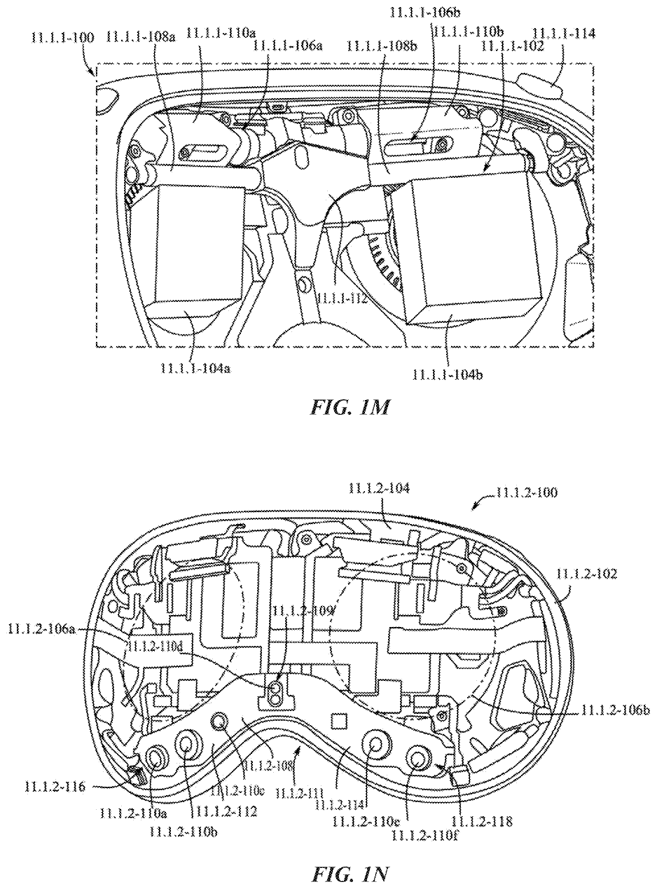

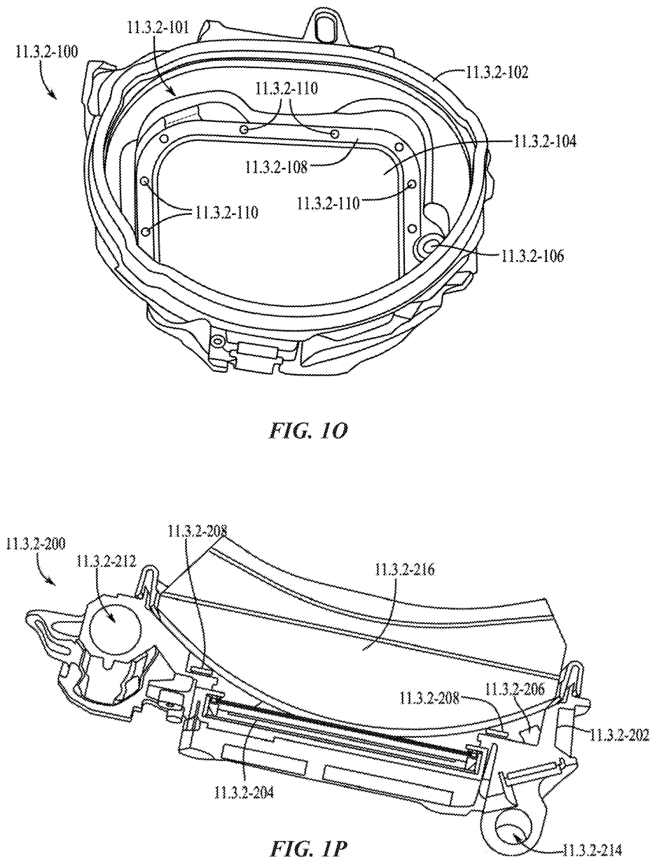

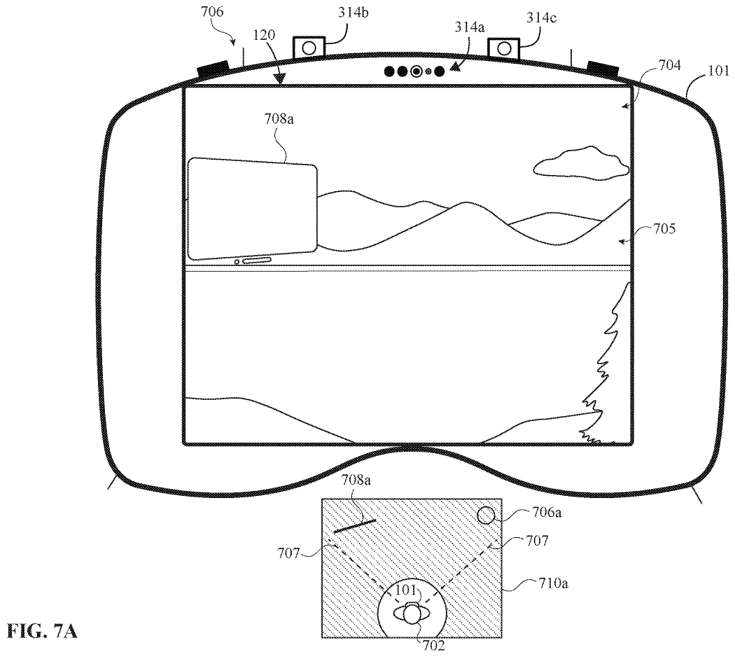

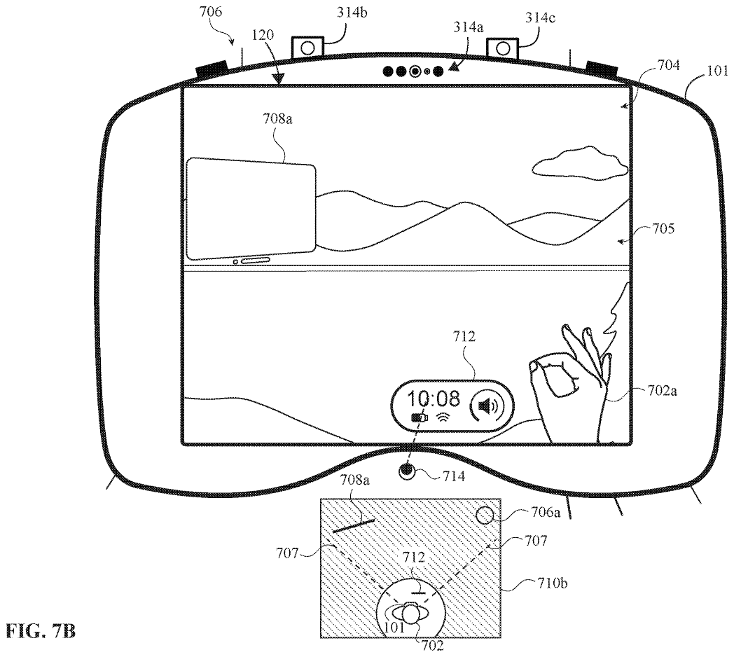

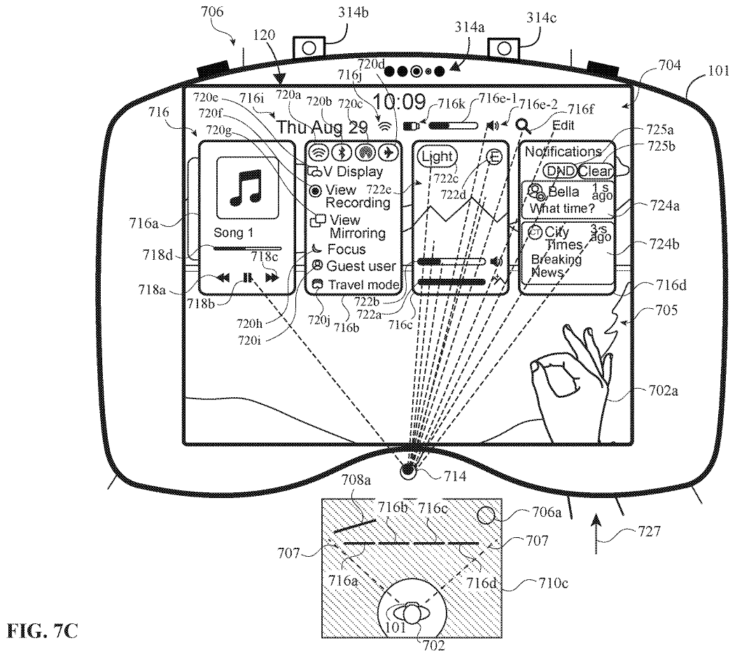

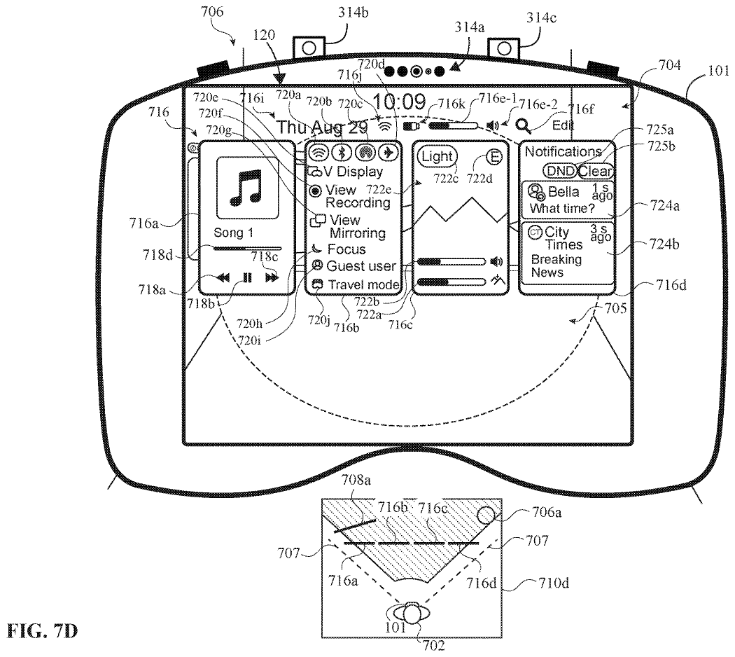

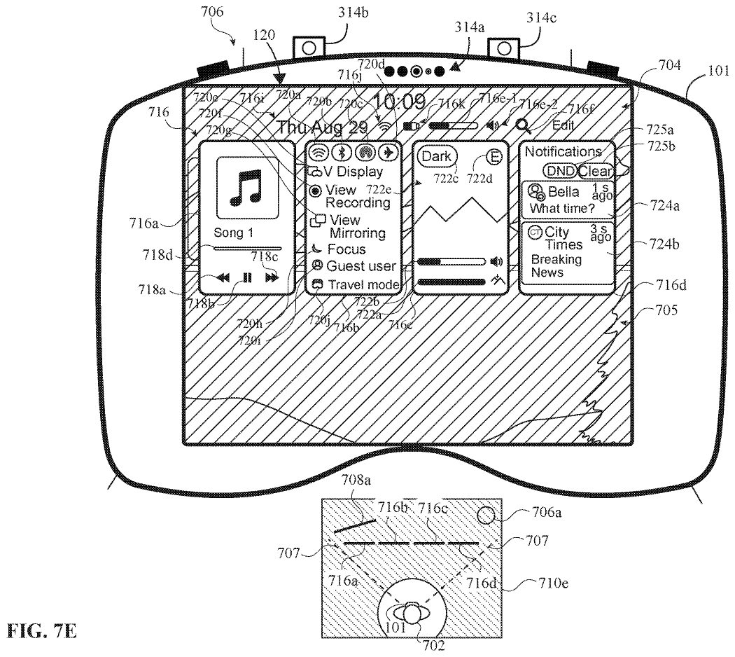

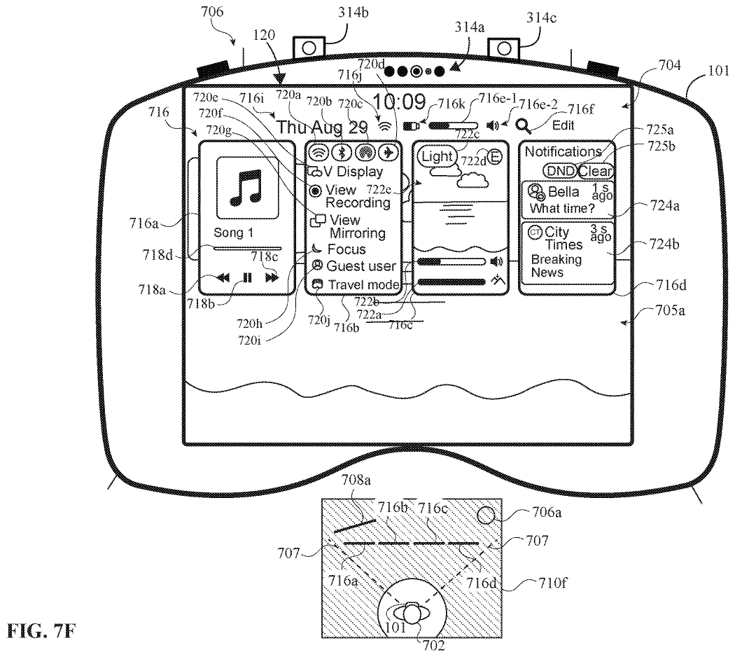

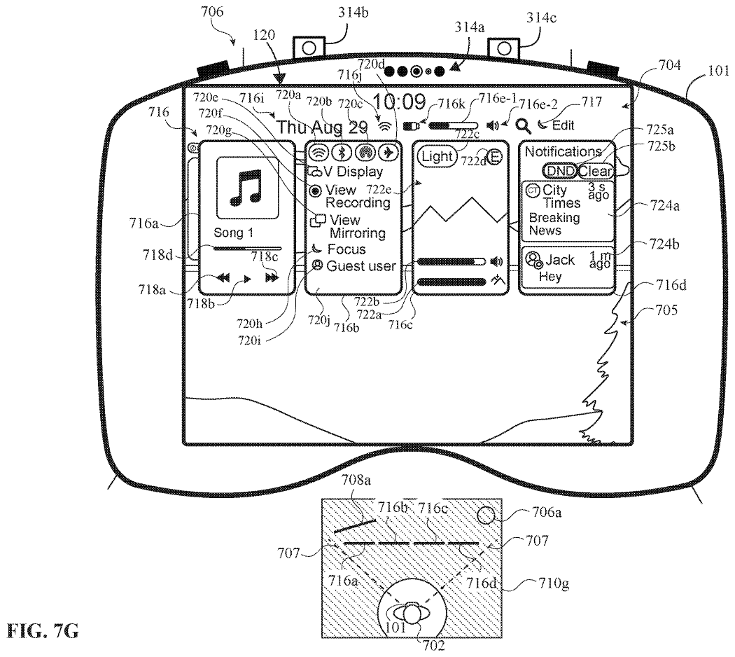

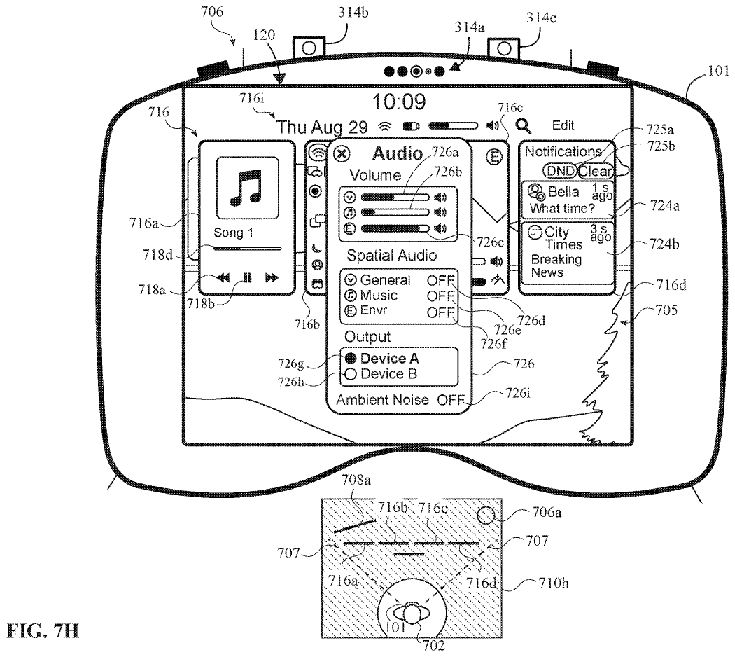

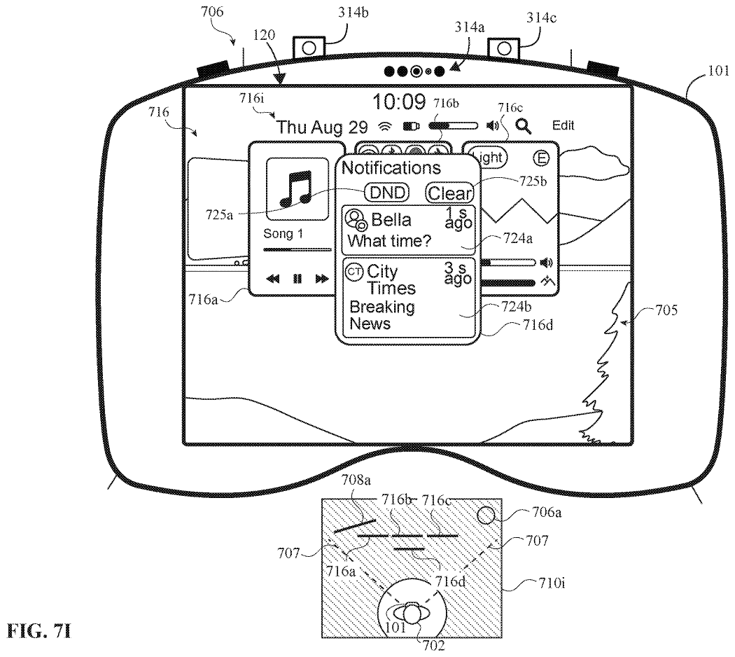

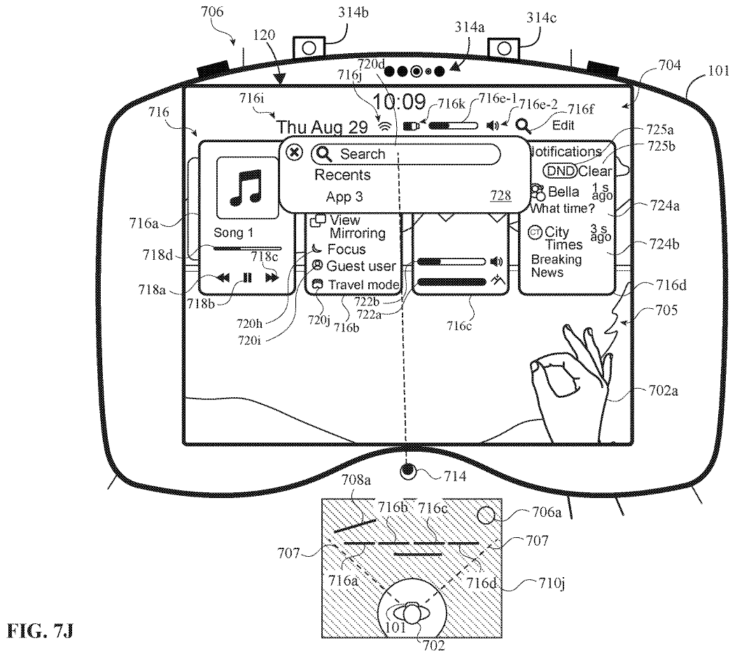

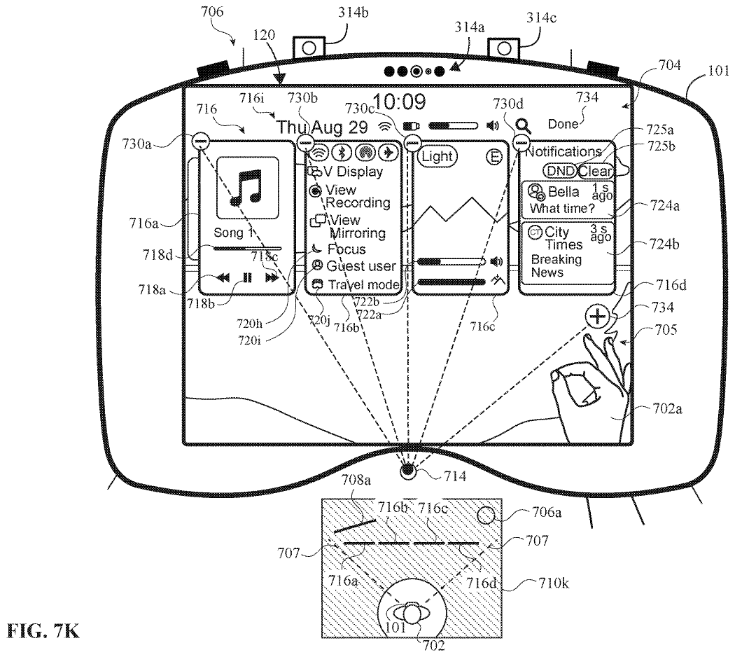

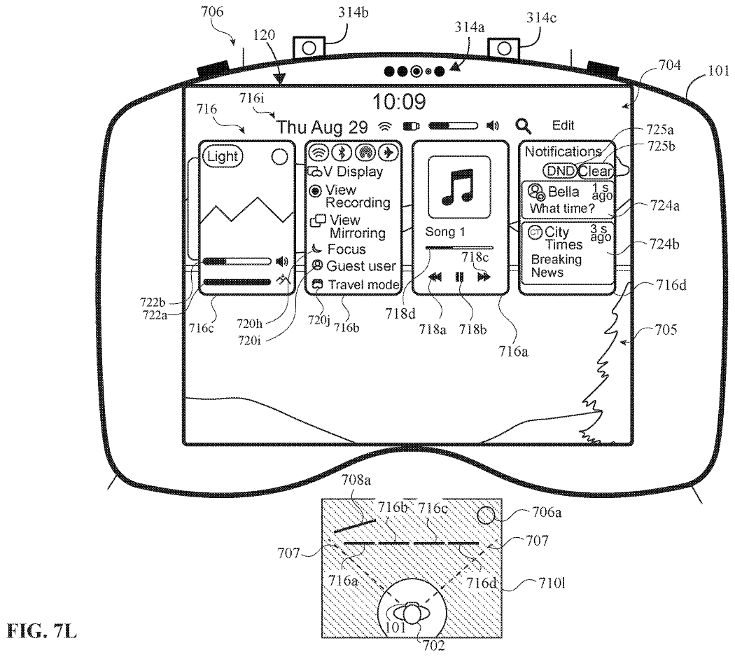

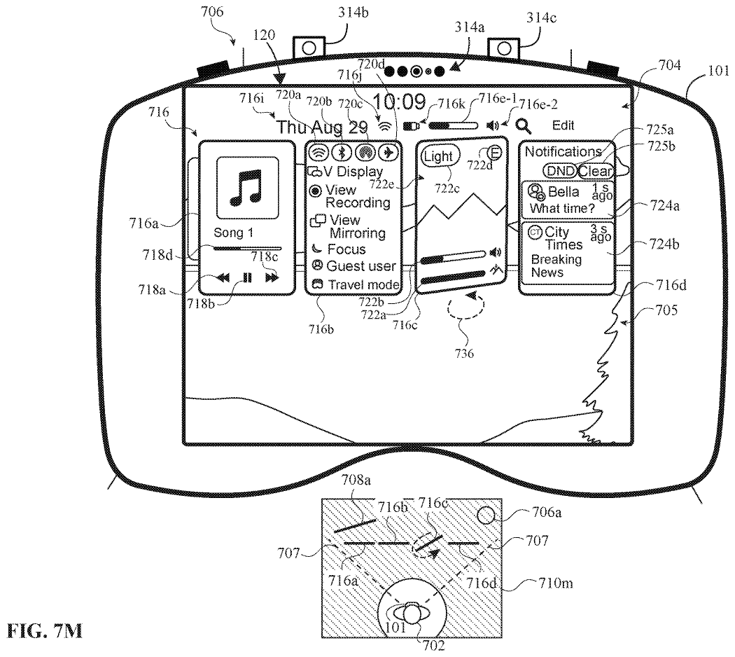

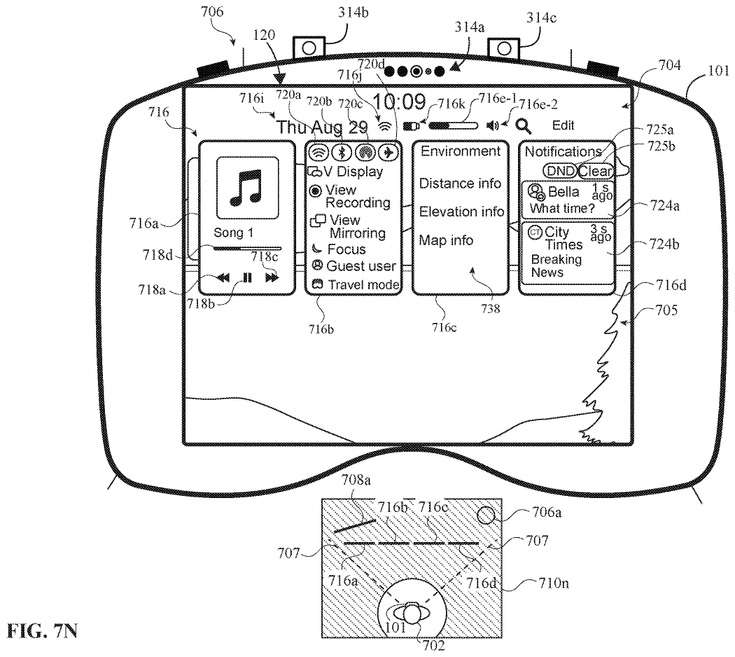

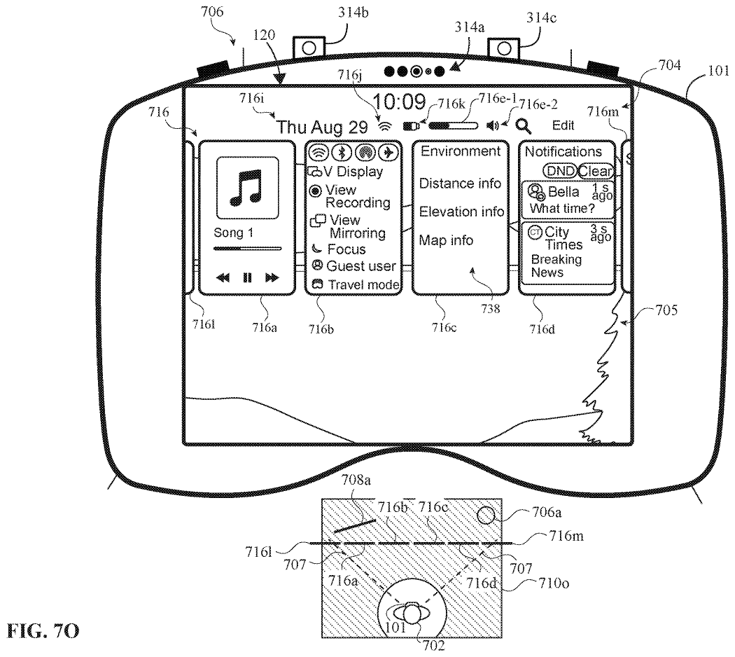

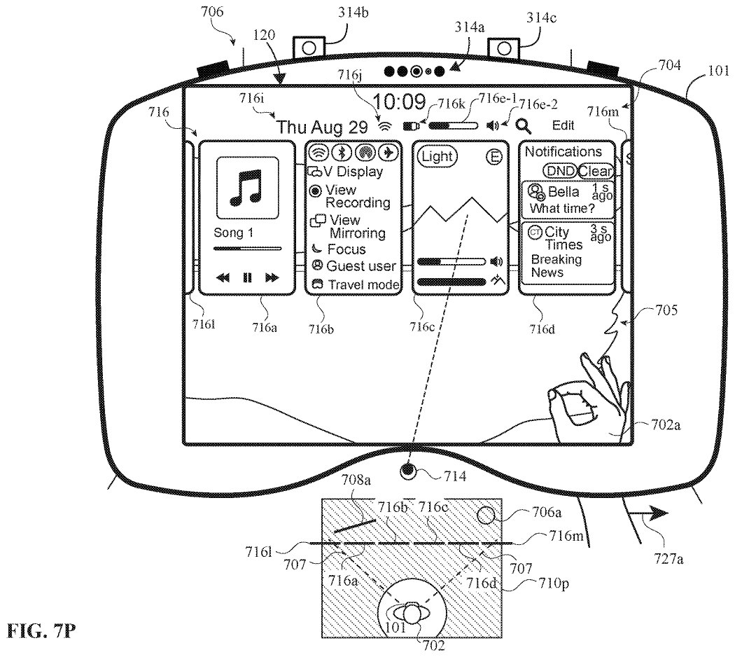

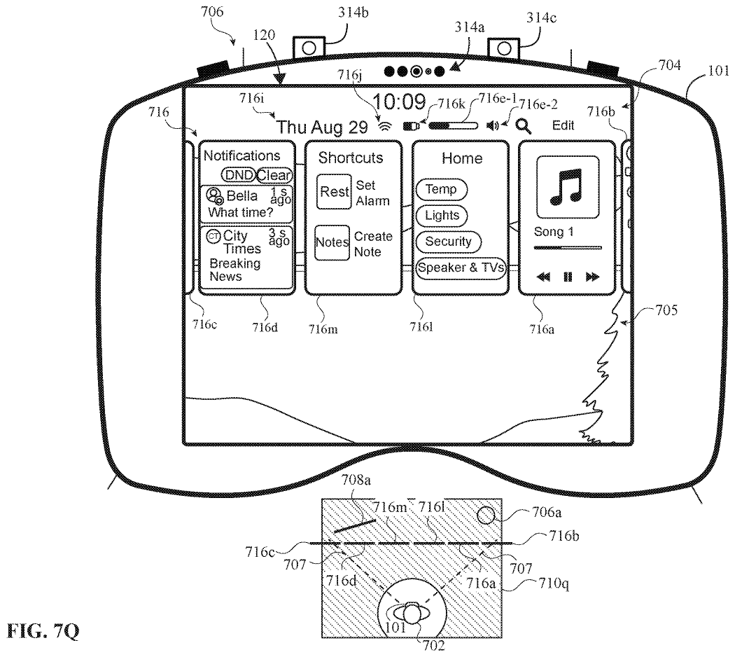

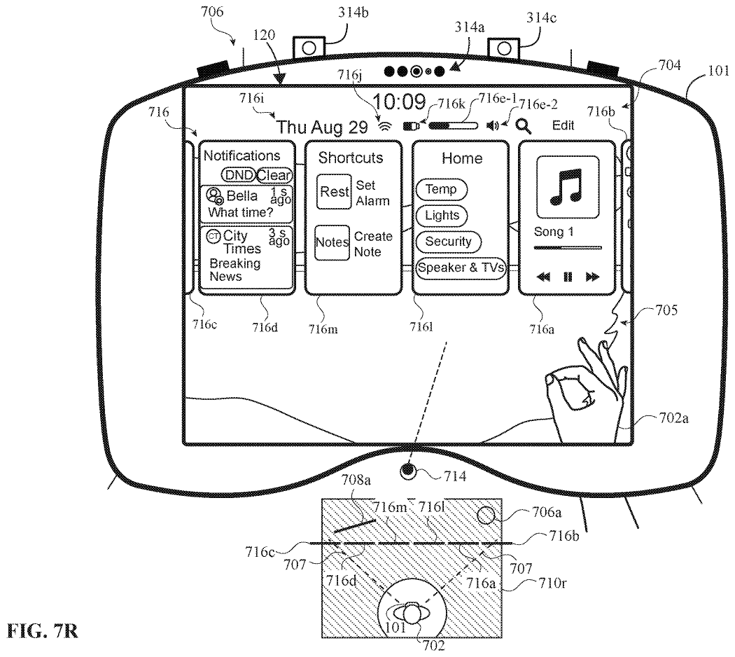

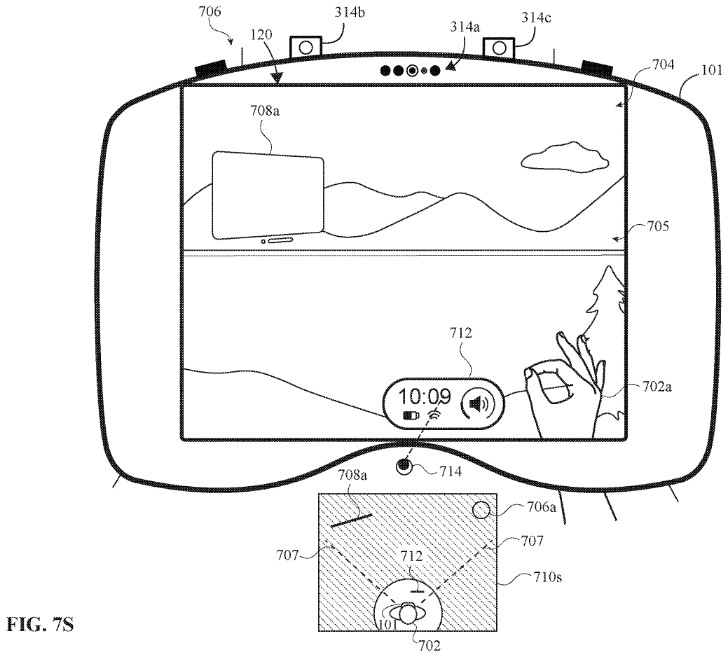

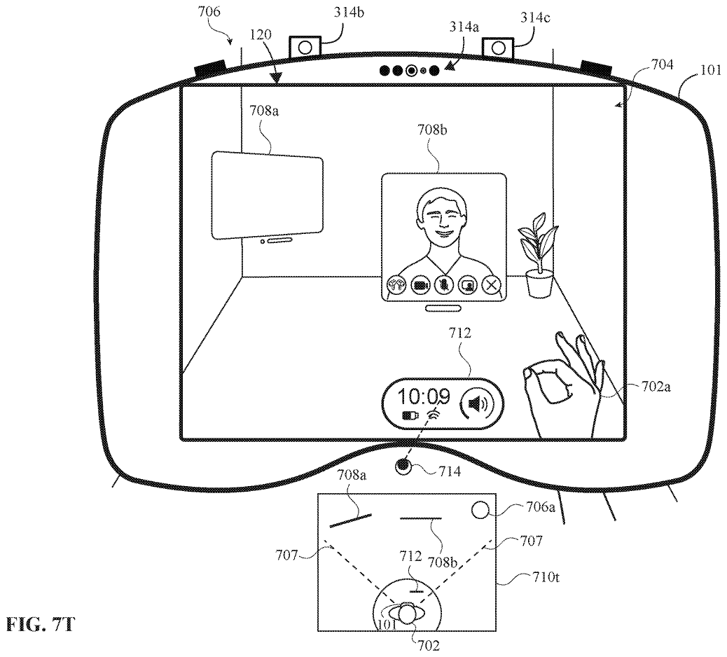

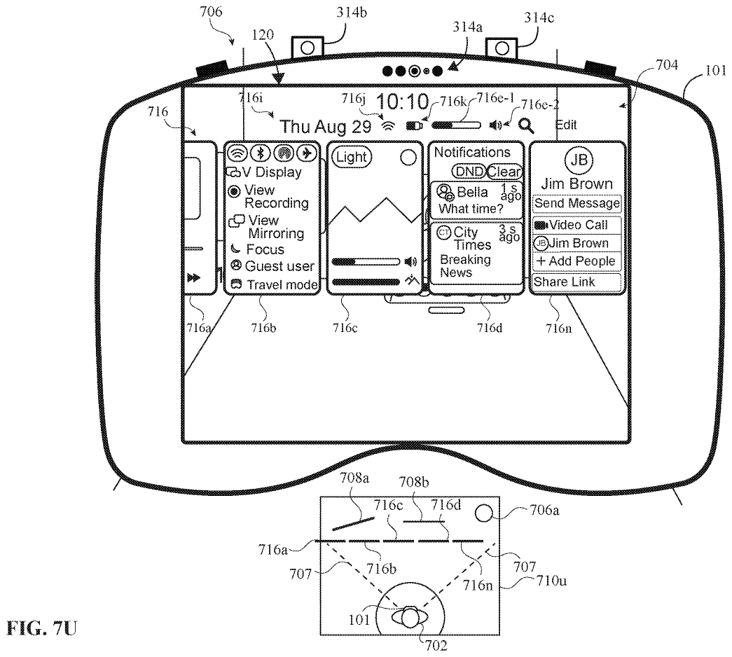

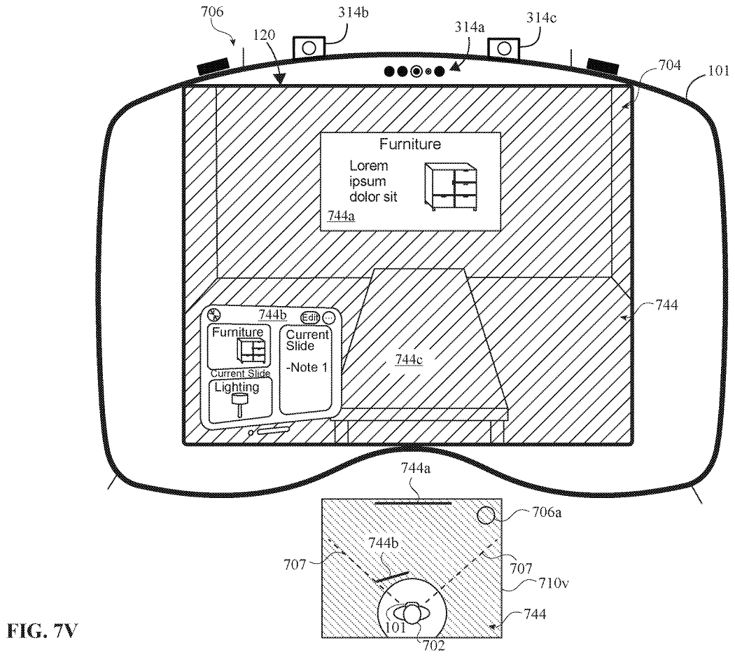

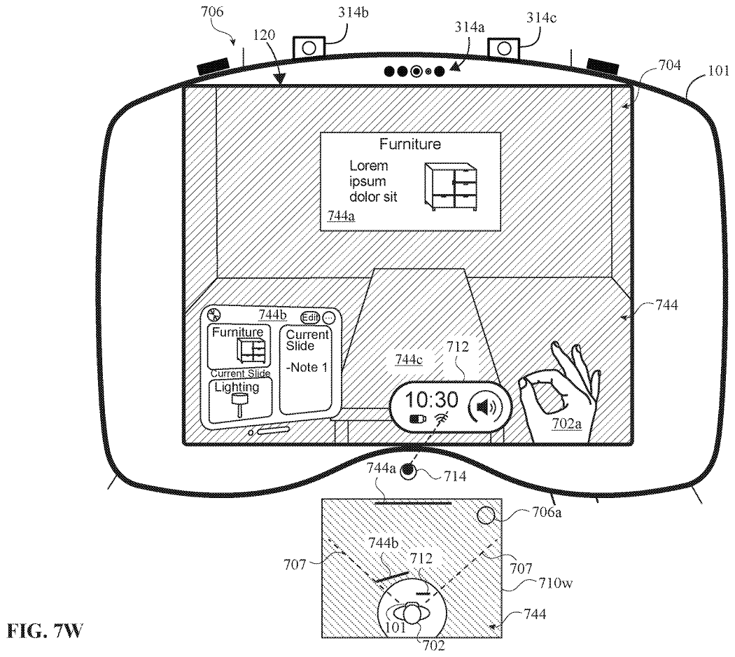

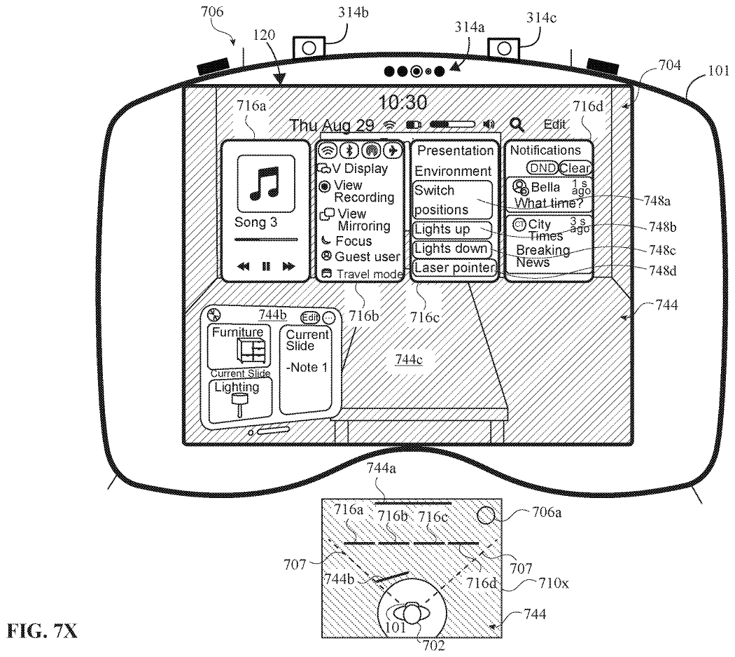

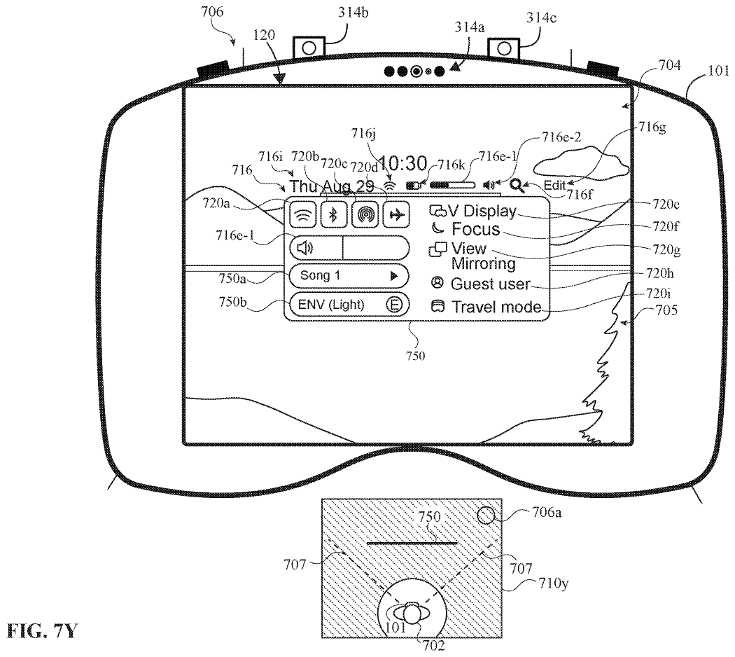

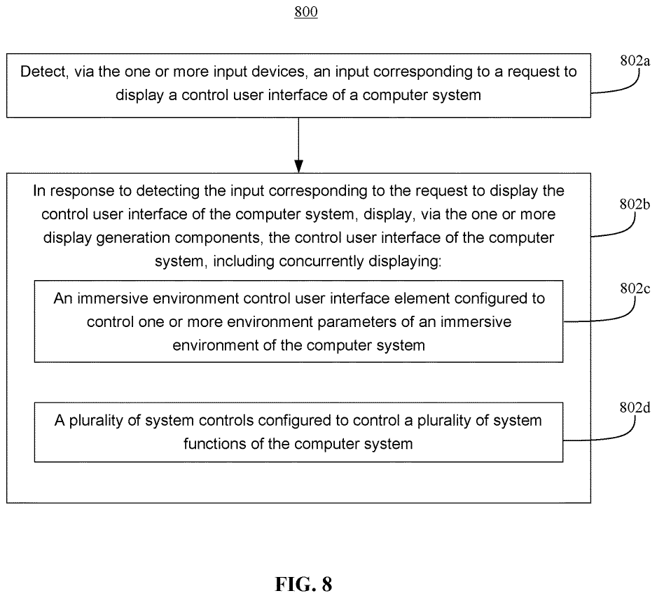

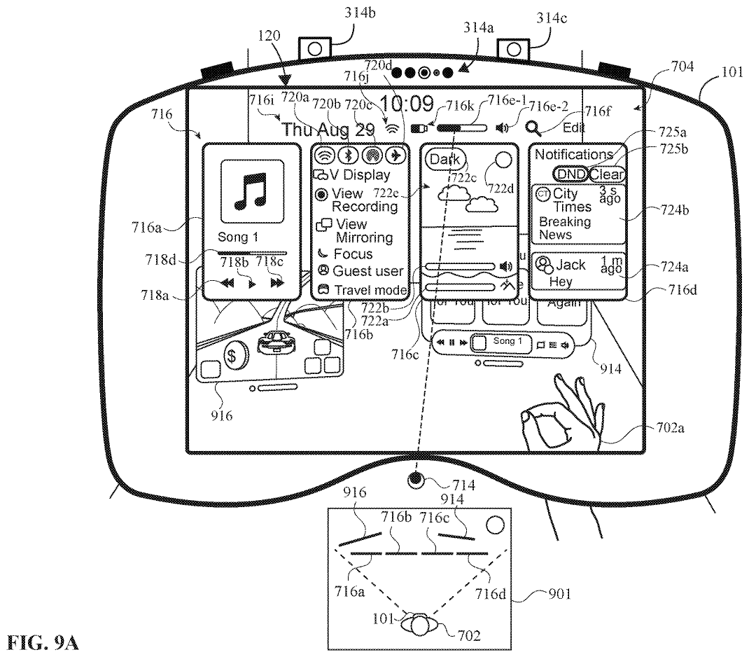

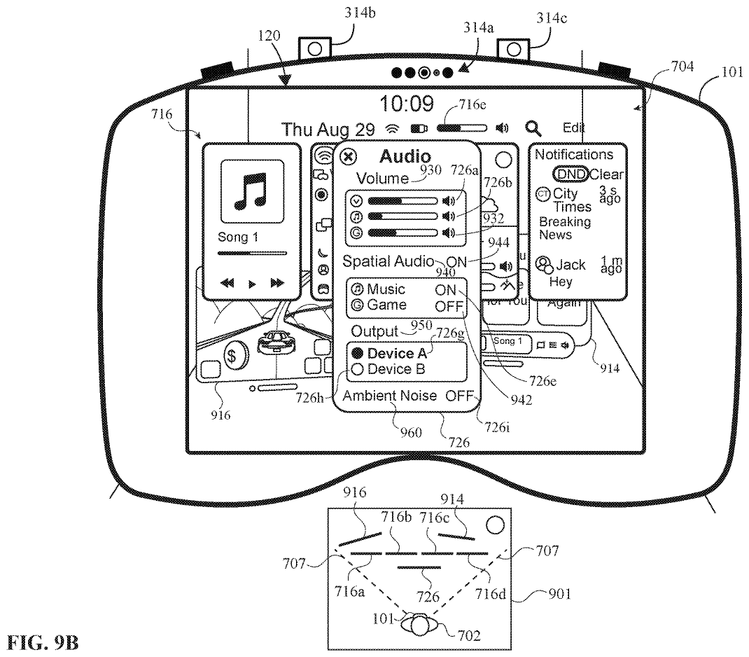

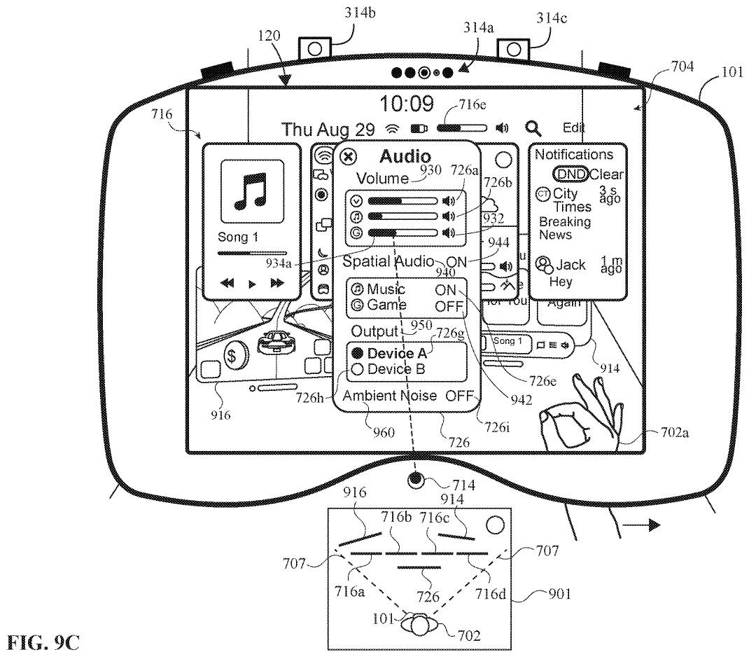

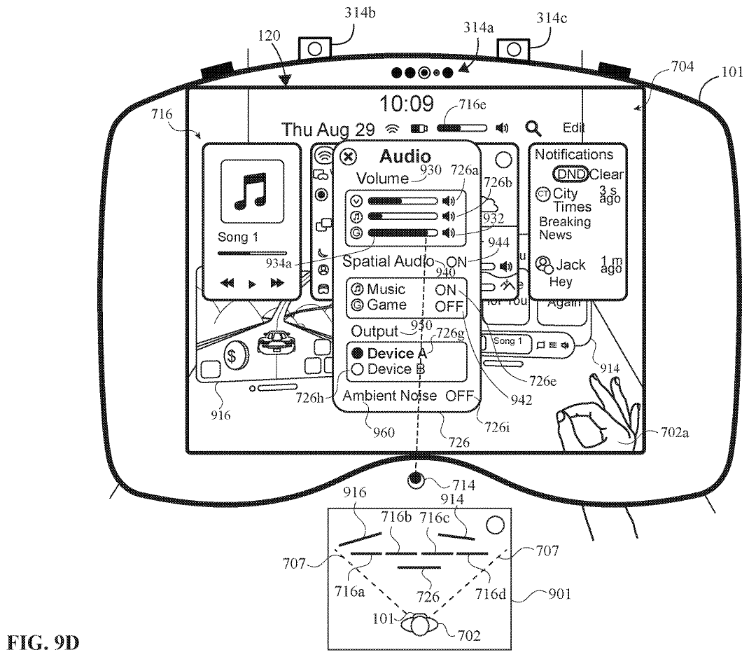

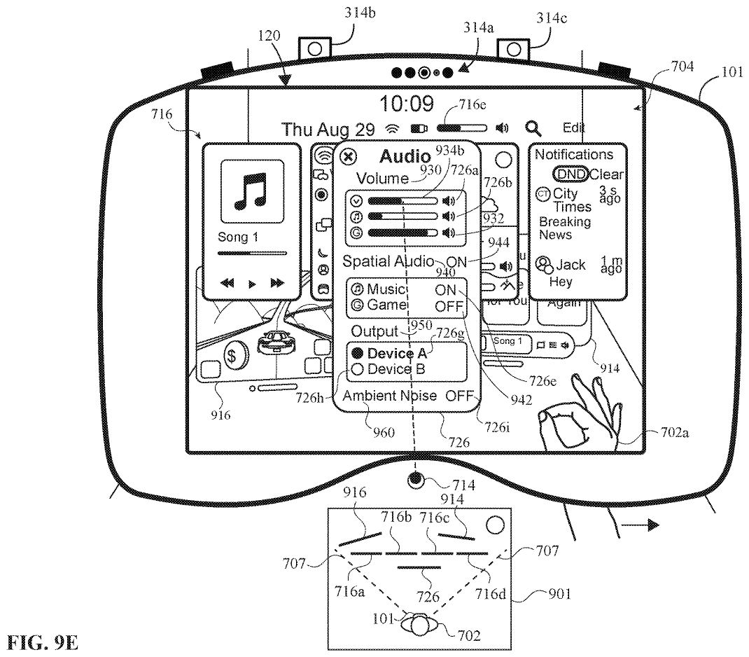

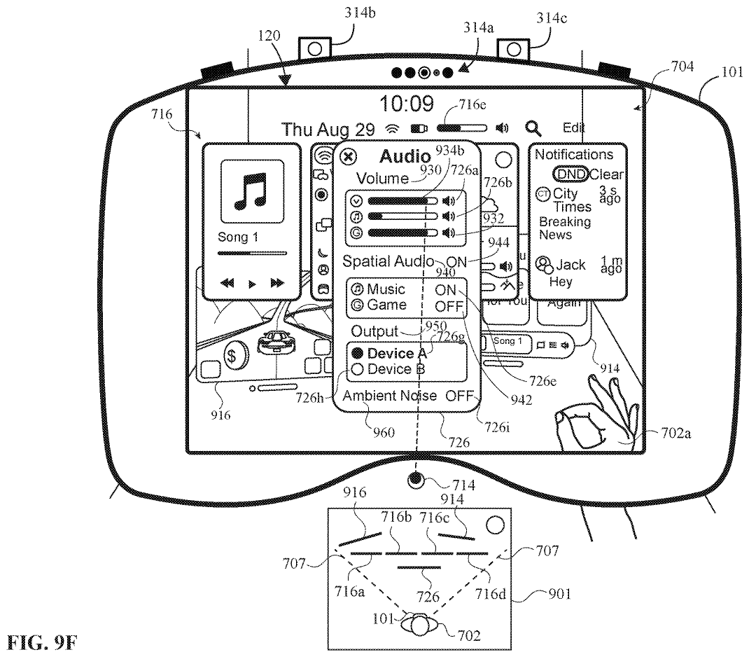

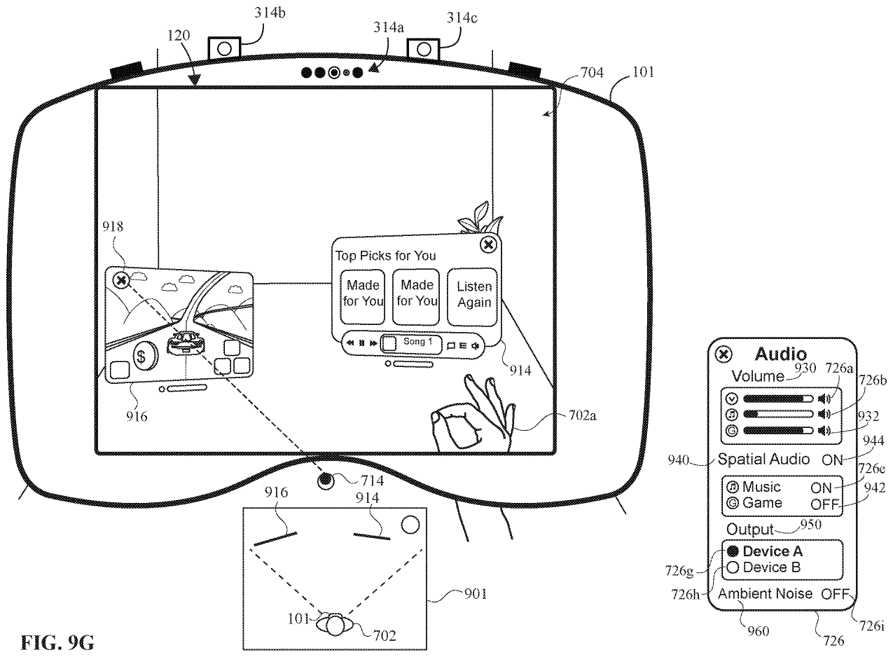

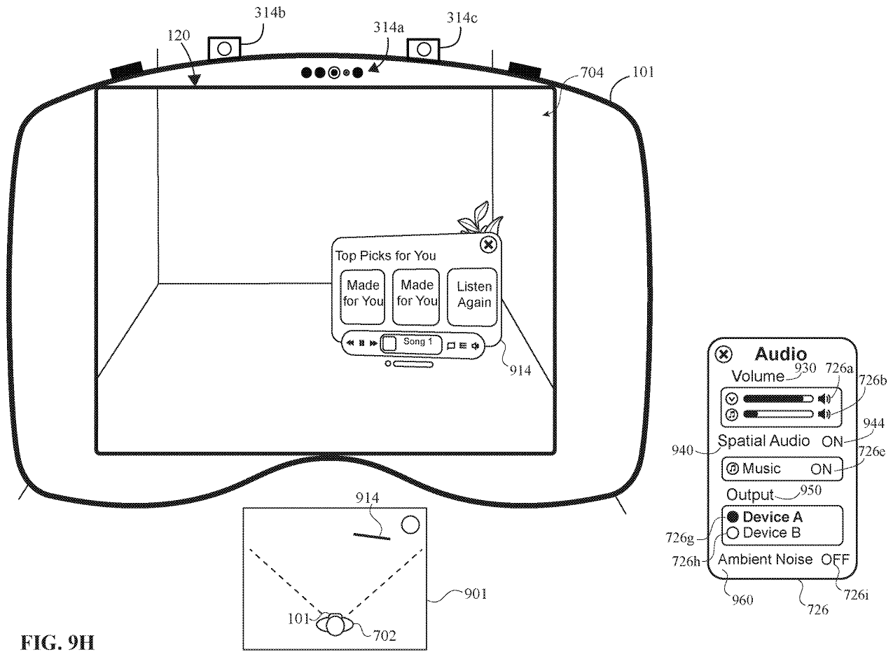

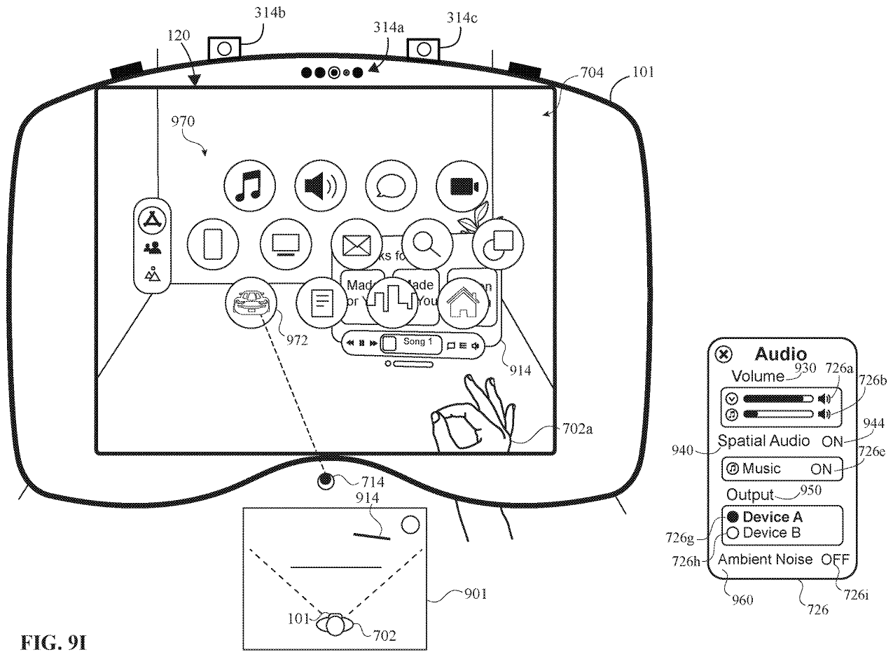

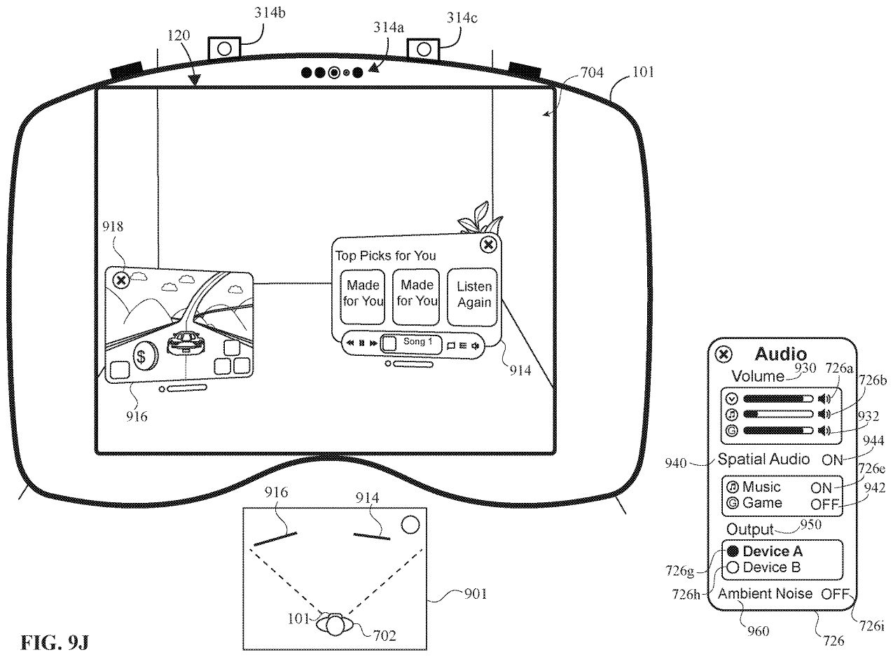

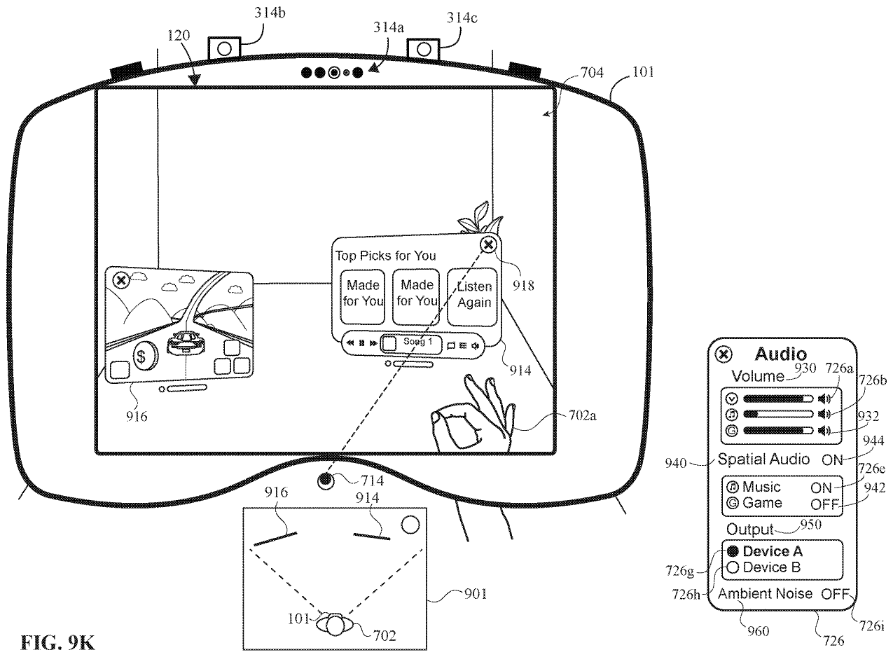

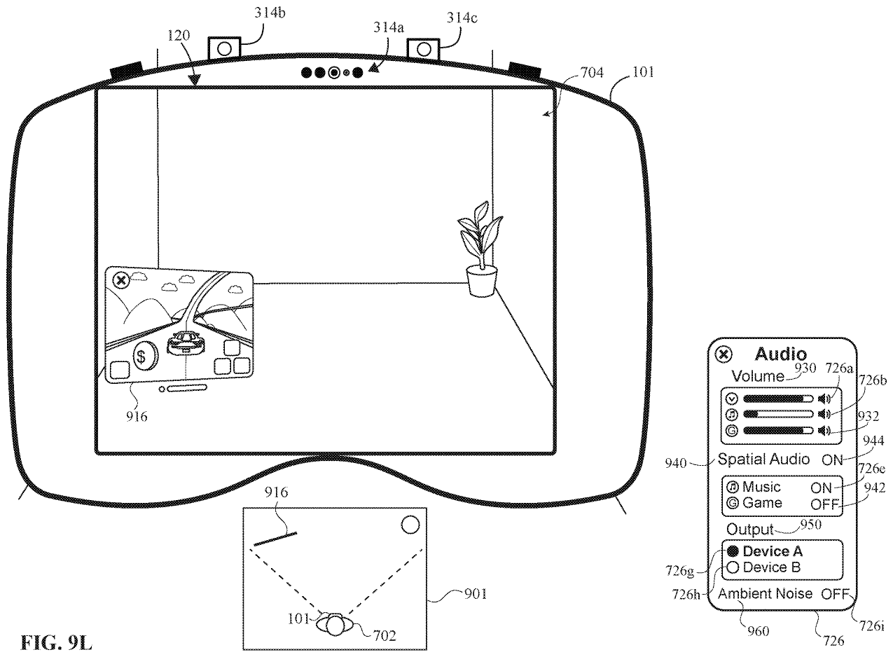

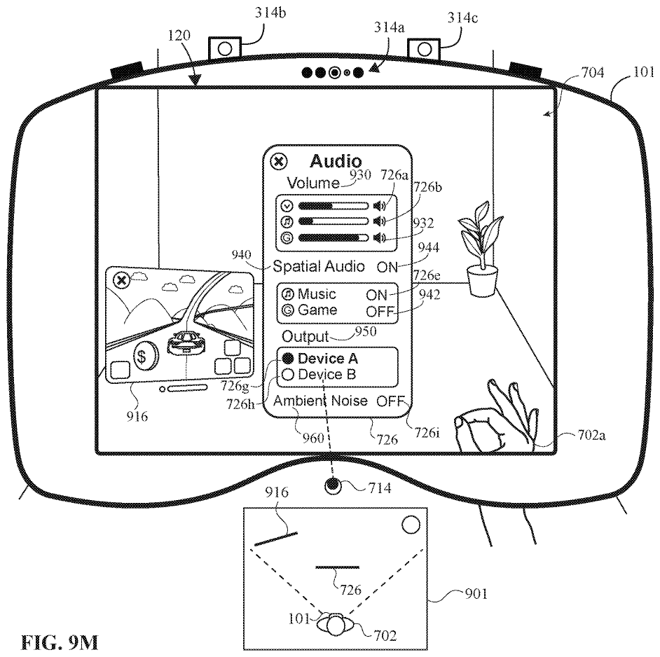

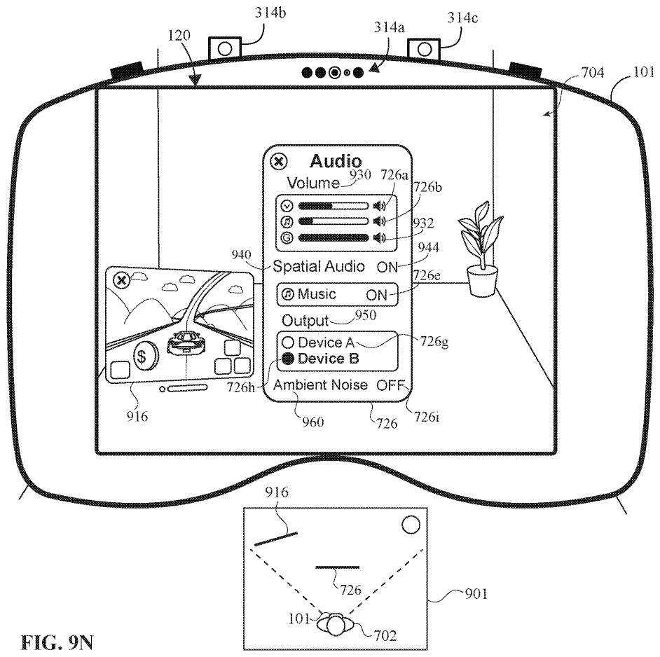

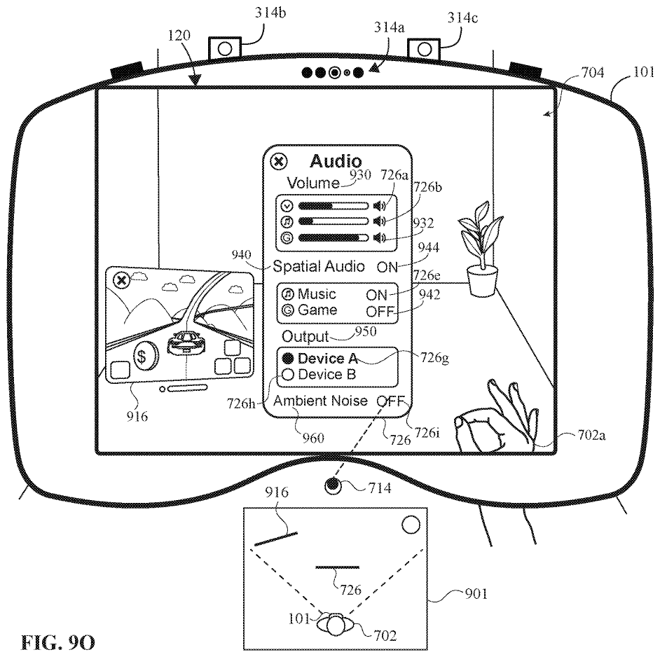

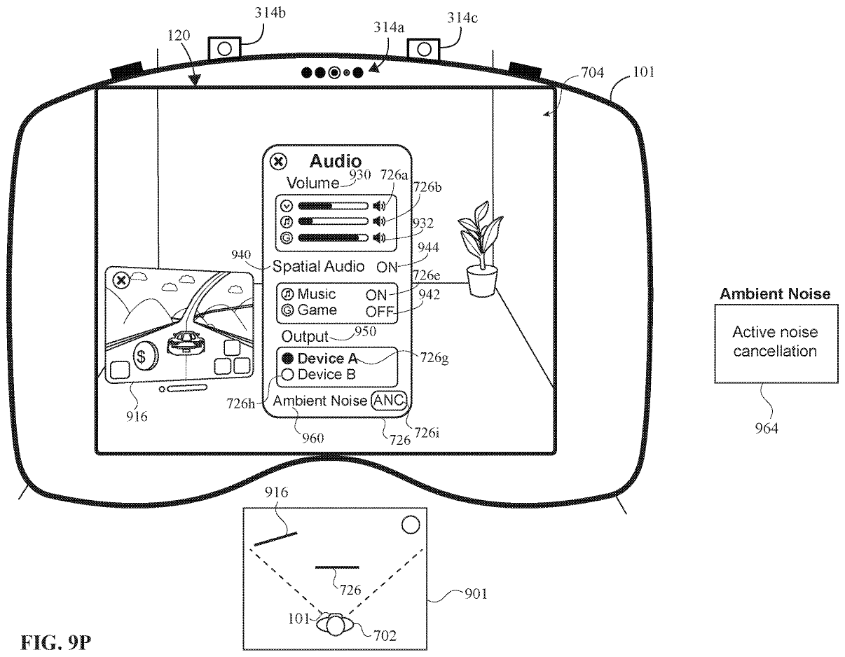

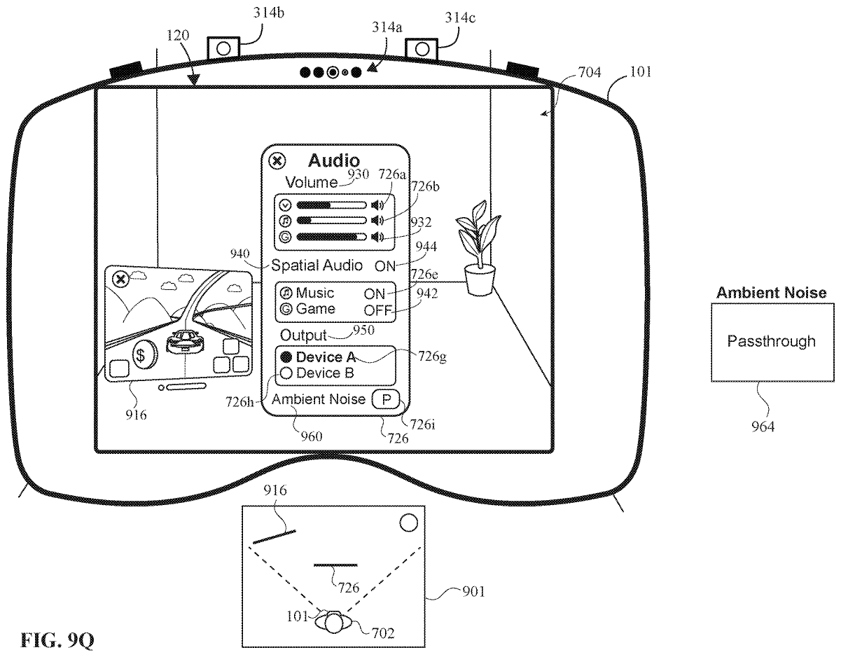

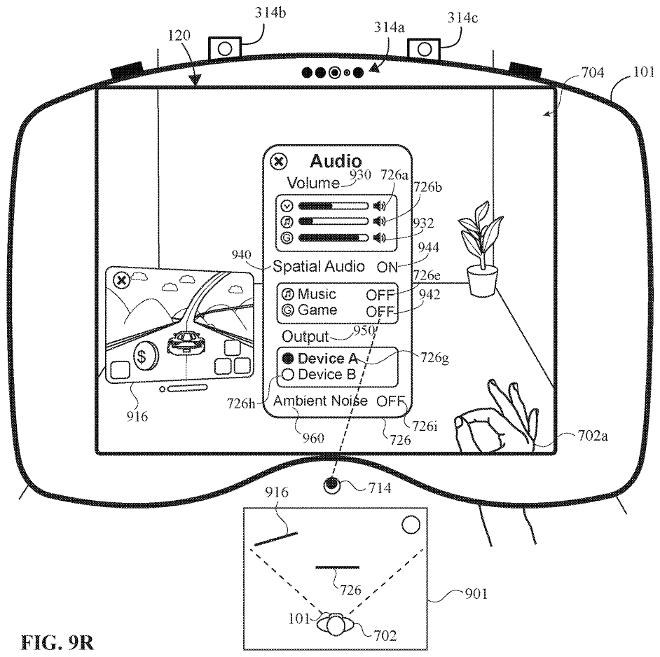

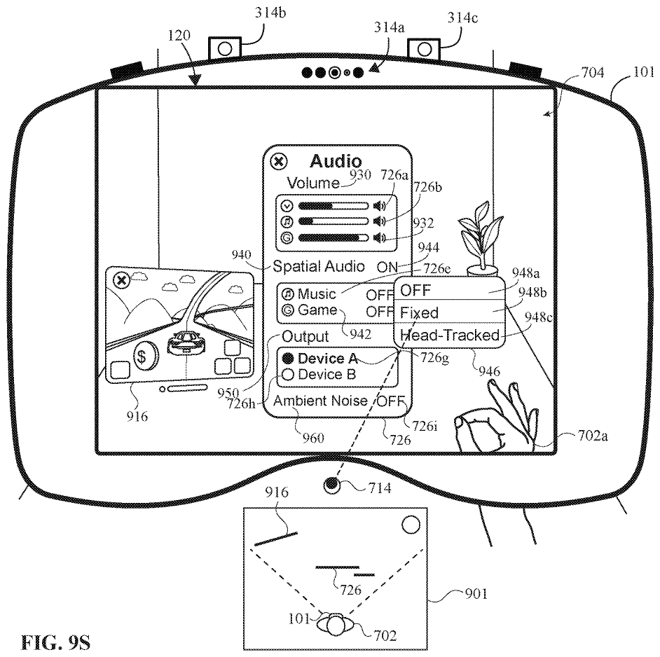

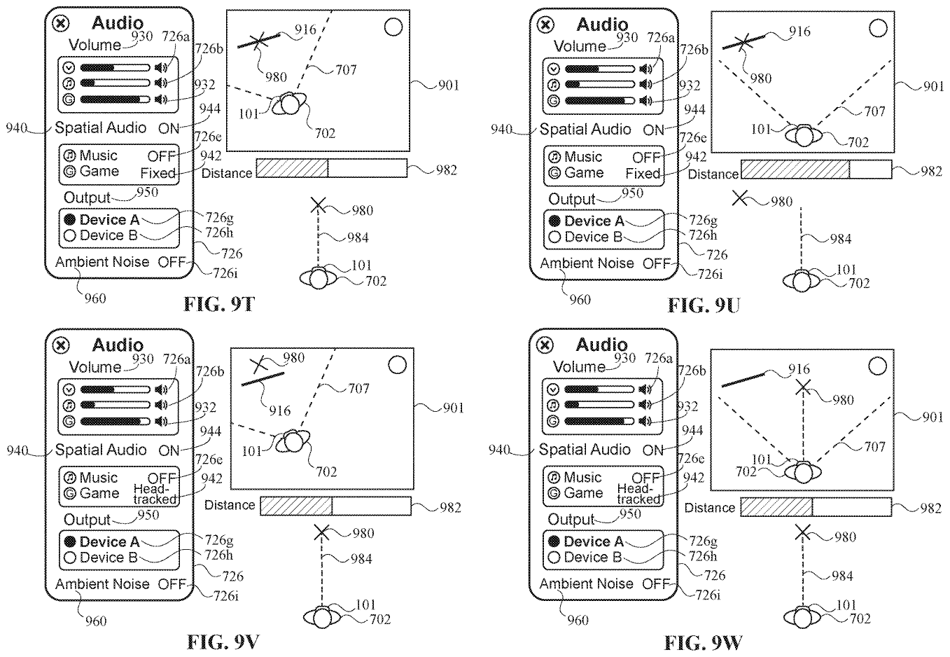

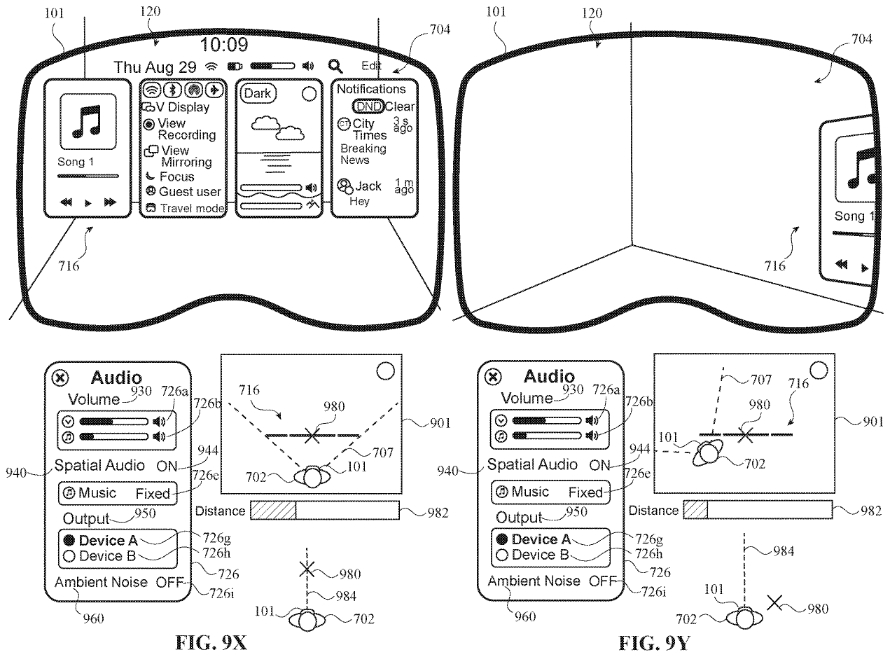

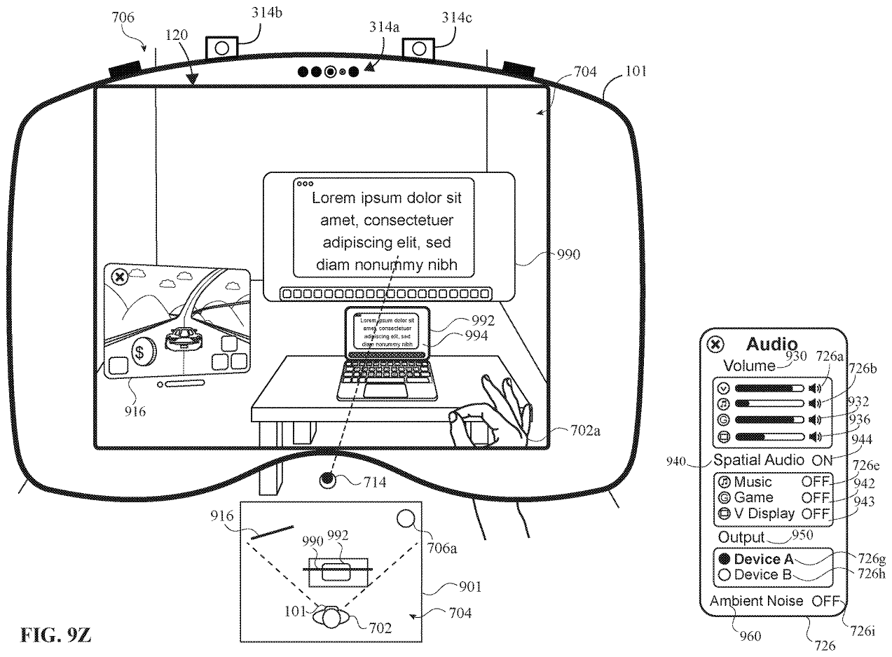

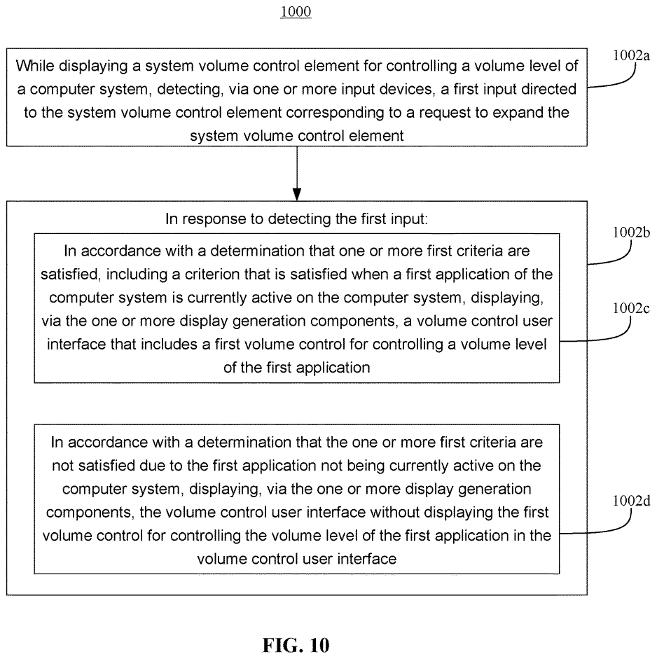

FIGS. 1A-6 provide a description of example computer systems for providing XR experiences to users (such as described below with respect to methods 800 and/or 1000). FIGS. 7A-7Y generally illustrate examples of a computer system detecting and responding to requests to display a control user interface of the computer system in accordance with some embodiments. FIG. 8 is a flowchart illustrating an exemplary method for displaying a control user interface of a computer system in response to detecting an input corresponding to a request to display the control user interface of the computer system in accordance with some embodiments. The user interfaces in FIGS. 7A-7Y are used to illustrate the processes in FIG. 8. FIGS. 9A-9Z generally illustrate examples of a computer system detecting and responding to requests to display a volume control user interface of the computer system in accordance with some embodiments. FIG. 10 is a flow diagram illustrating an example method for displaying a volume control user interface in response to detecting an input corresponding to a request to expand a system volume control element in accordance with some embodiments. The user interfaces in FIGS. 9A-9Z are used to illustrate the processes in FIG. 10.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less-precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specfies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typcially move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objets such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environement or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movment of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

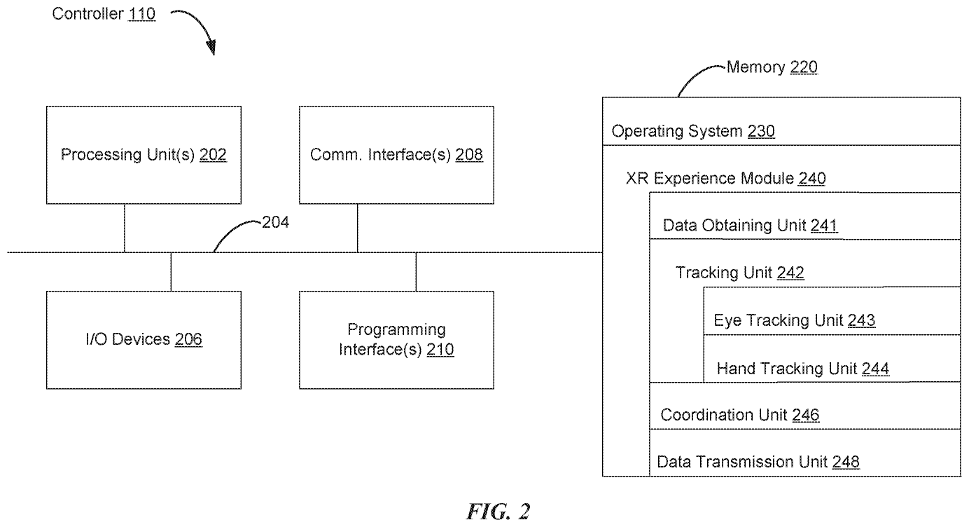

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

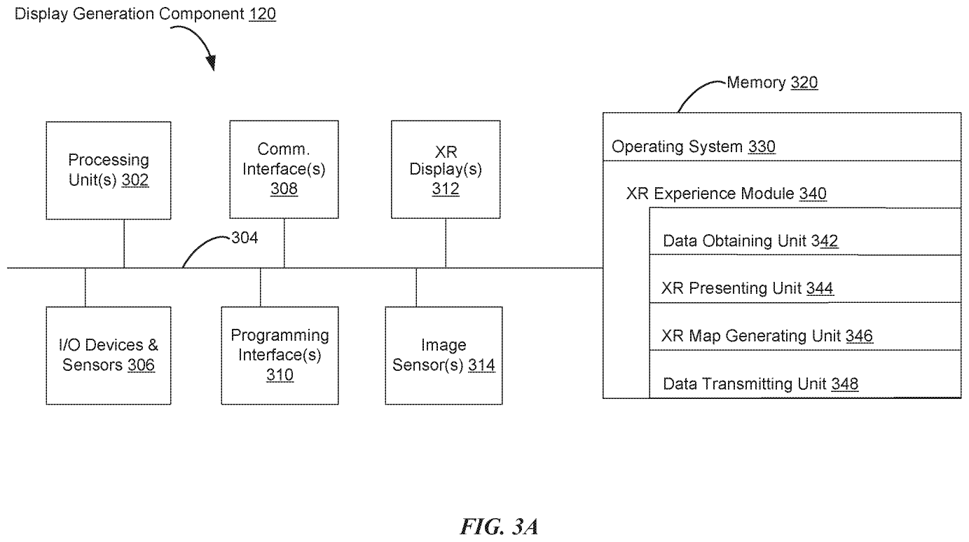

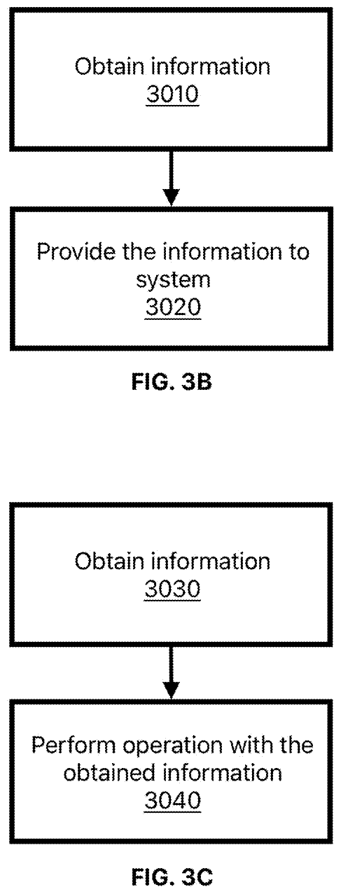

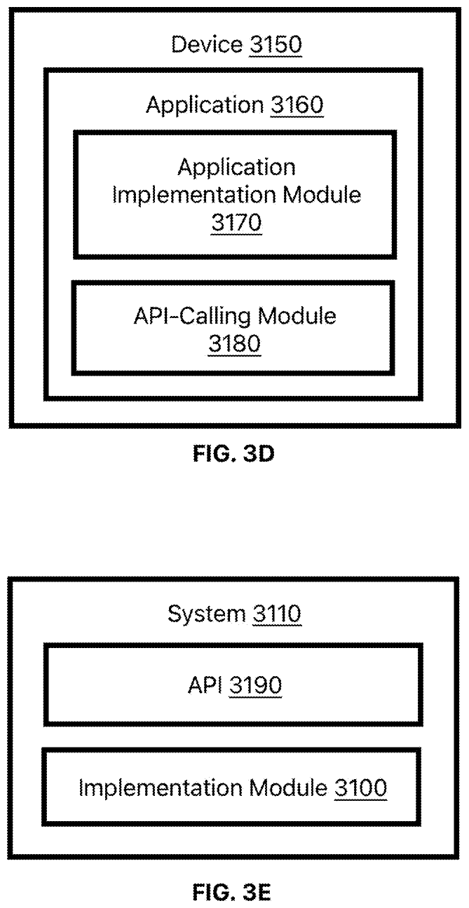

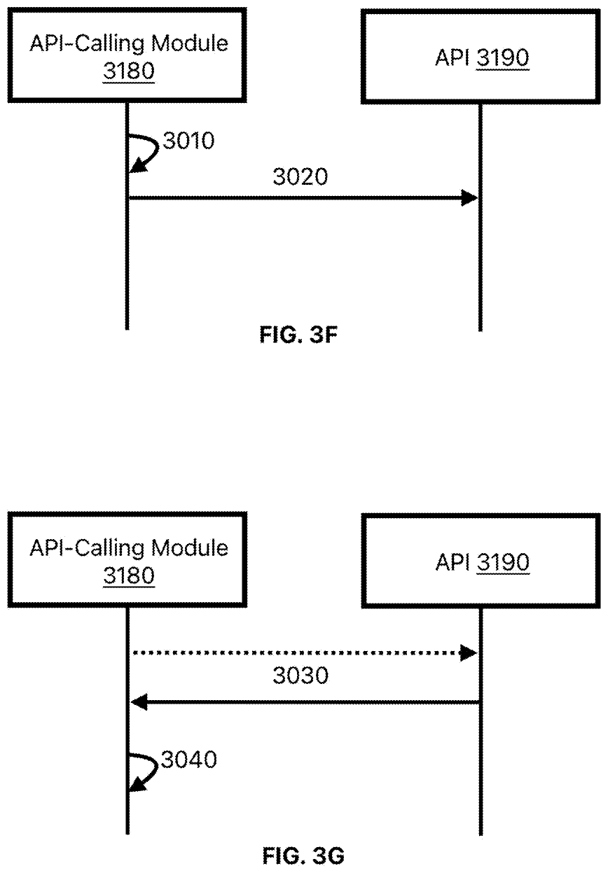

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3A. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 10) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user' head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-1F can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-1F can be included, either alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin, for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 1I and 1K-1L and described herein. Likewise, any of the features, components, and/or parts, including the arrangements and configurations thereof shown and described with reference to FIGS. 1I and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 1O illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 1O can be replicated in another (e.g., second) optical module disposed with the HMD to interact (e.g., project light and capture images) of another eye of the user.

Any of the features, components, and/or parts, including the arrangements and configurations thereof shown in FIG. 1O can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 1O.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

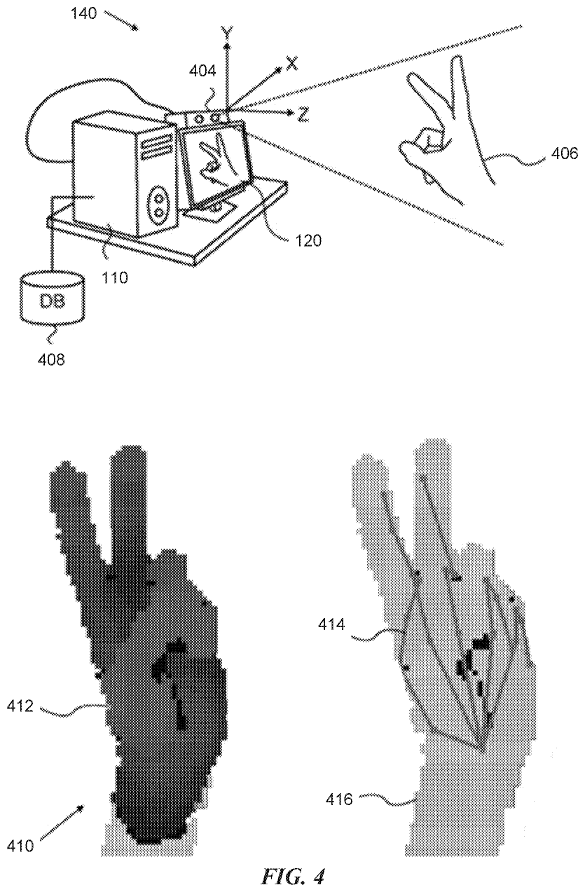

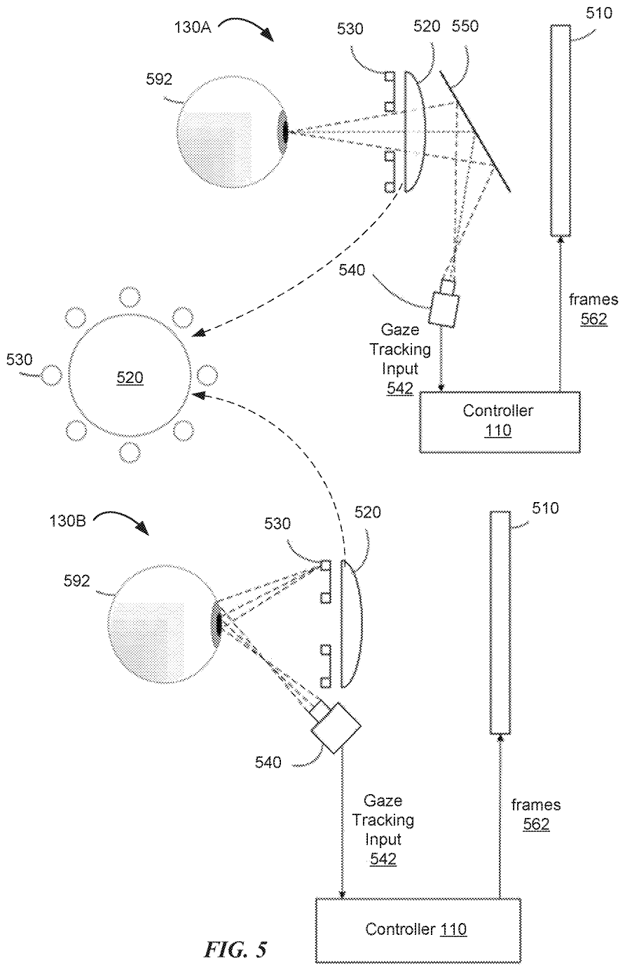

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3A is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3A is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3A could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform the method 800 (FIG. 8) and/or the method 1000 (FIG. 10) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application. FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

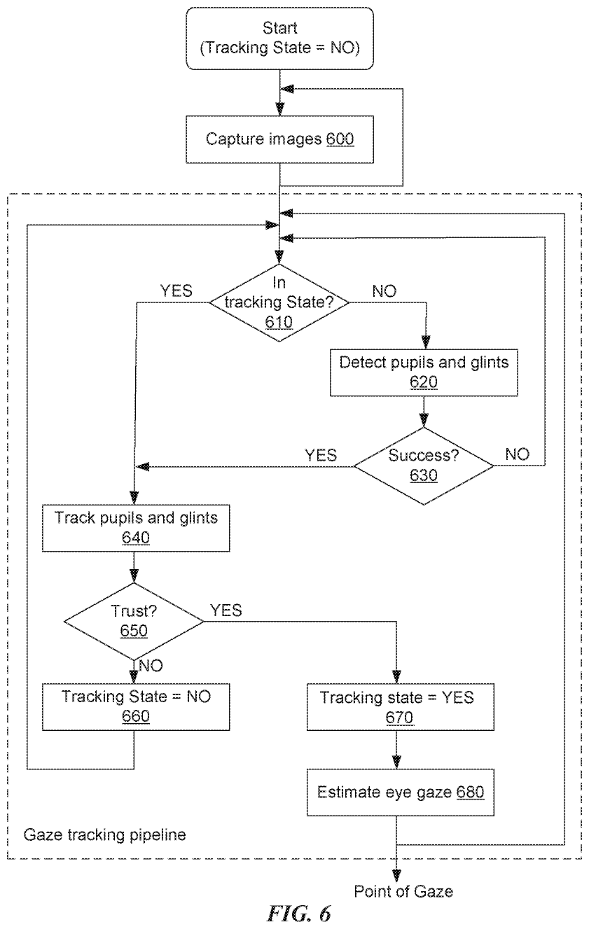

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as portable multifunction device or a head-mounted device, with a display generation component, one or more input devices, and (optionally) one or more cameras.

FIGS. 7A through 7Y generally illustrate examples of a computer system detecting and responding to requests to display a control user interface of the computer system, in accordance with some embodiments.

In some embodiments, the computer system displays the control user interface in response to detecting an input requesting to display the control user interface. In some embodiments, the control user interface includes a plurality of platters or groupings of controls. In some embodiments, the platters or groupings of controls include control elements that are related to specific aspects of the computer system. For example, the control user interface optionally includes an immersive environment control user interface element that includes controls for controlling environment parameters of an immersive environment of the computer system and includes groupings of controls for controlling aspects of the computer system that are different from the environment parameters of the immersive environment, such as a media playback control user interface element that includes one or more media playback controls, a volume control user interface element, such as the volume control user interface element described with reference to method 1000, and/or a notification control user interface element. In some embodiments, the control user interface does not include a plurality of platters or groupings of controls. These and other embodiments of the disclosure are generally shown throughout FIGS. 7A through 7Y, and the embodiments described with reference to FIGS. 7A through 7Y are further described with reference to the method 800.

FIG. 7A shows the computer system 101 (e.g., an electronic device) worn by a user 702 of the computer system 101 displaying, via the display generation component 120 (e.g., display generation components 1-122a and 1-122b of FIG. 1), a three-dimensional environment 704 from a viewpoint of the user 702 (e.g., the user 702 in overhead view 704a) of the computer system 101 (e.g., facing a back wall of the physical environment 706 in which the computer system 101 is located). In FIG. 7A, the three-dimensional environment 704 includes an immersive environment 705 of the computer system 101 (e.g., a currently selected immersive environment of the computer system 101, where the immersive environment is optionally a virtual representation of geographic location). The physical environment 706 includes a physical object 706a, that would be shown in the display generation component 120 in FIG. 7A (e.g., since the physical object 706a is within the viewing boundaries 707 of the viewpoint of the user 702 in FIG. 7A) but is not due to the current level of immersion of the immersive environment 705 in FIG. 7A. In FIG. 7A, the computer system 101 displays a first user interface 708a of an application (e.g., a user interface of a media playback application, an Internet application, a messaging application, or of another type of application) in the three-dimensional environment 704 (e.g., in the immersive environment 705). Overhead views 710a through 710z in FIGS. 7A through 7Y show relative positioning of objects in the environment in a horizontal dimension and a depth dimension in the respective figure and the view of the environment shown in the display generation component 120 in the respective figure shows the relative positioning of objects in the environment in a vertical dimension and a horizontal dimension (and, optionally in a depth dimension).

FIGS. 7B and 7C illustrate an example of the computer system 101 detecting and responding to a request to display a control user interface of the computer system 101, in accordance with some embodiments.

In some embodiments, the computer system 101 detects an input corresponding to a request to display a control user interface of the computer system 101. In some embodiments, the input includes a first part and a second part. In some embodiments, the first part includes attention 714 (e.g., based on gaze) of the user 702 being directed at a hand 702a of the user 702, such as directed to the palm of the hand 702a, and then the user 702 performing a hand flip gesture while attention 714 of the user 702 is directed at the hand 702a. In some embodiments, in response to detecting the first part of the input, the computer system 101 displays a control widget user interface 712 of FIG. 7B. For example, while displaying the three-dimensional environment 704 of FIG. 7A, the computer system 101 optionally detects the first part of the input described above, and in response, the computer system 101 displays the control widget user interface 712, such as shown in FIG. 7B. As shown in FIG. 7B, the control widget user interface 712 indicates the current time at the computer system 101, a battery level of the computer system 101, the connectivity (e.g., a Wi-Fi strength) at the computer system 101, and a current volume level of the computer system 101. In some embodiments, the control widget user interface 712 of FIG. 7B is selectable to display the control user interface. In some embodiments, the second part of the input described above includes a selection input including input from the hand 702a of the user 702 (e.g., an air pinch gesture) while attention 714 of the user 702 is directed to the control widget user interface 712, such as described below. In some embodiments, in response to detecting the second part of the input, the computer system 101 displays a control user interface of the computer system 101, such as the control user interface 716 of FIG. 7C. For example, while displaying the three-dimensional environment 704 of FIG. 7B, the computer system 101 optionally detects the second part of the input described above, and in response, the computer system 101 displays the control user interface 716, such as shown in FIG. 7C.

In FIG. 7C, the control user interface 716 is displayed in the three-dimensional environment 704. In FIG. 7C, the control user interface 716 includes a media control user interface element 716a, a connectivity control user interface element 716b, an immersive environment control user interface element 716c, and a notifications control user interface element 716d. The media control user interface element 716a includes a plurality of media controls for controlling playback of media. The connectivity control user interface element 716b includes a plurality of connectivity controls for controlling connections of the computer system 101. The immersive environment control user interface element 716c includes a plurality of controls for controlling environment parameters of the immersive environment 705. The notifications control user interface element 716d includes a plurality of notifications and notification control elements for controlling aspects of the computer system 101 related to notifications. In FIG. 7C, the control user interface 716 also includes other controls including a system volume control element 716e (e.g., the system volume control element described with reference to method 1000) including a volume slider 716e-1 for controlling a system volume of the computer system and a volume icon 716e-2, a search control user interface element 716f, and a control element 716g for modifying display of the control user interface 716, which in the illustrated embodiment, are above the user interface elements 716a through 716d in the viewpoint of the user 702. Additionally, in FIG. 7C, the control user interface 716 includes the current time 716h at the computer system 101, the current date 716i at the computer system 101, a Wi-Fi connectivity indicator 716j, and a battery level 716k of the computer system 101, which in the illustrated embodiment, are above the user interface elements 716a through 716d in the viewpoint of the user 702.

As described above, in FIG. 7C, the control user interface 716 includes the media control user interface element 716a that includes a plurality of media controls for controlling playback of media. In FIG. 7C, the plurality of media controls includes a rewind control 718a, a play/pause control 718b, a fast-forward control 718c, and a playback position indicator/control 718d; these controls are described further with reference to method 800. The media control user interface element 716a also indicates a name and pictorial representation of the media (e.g., a song or movie) that is currently in playback.

As described above, in FIG. 7C, the control user interface 716 includes the connectivity control user interface element 716b that includes a plurality of connectivity controls. In FIG. 7C, the plurality of connectivity controls includes a Wi-Fi control element 720a for controlling Wi-Fi connections of the computer system 101, a BLUETOOTH control element 720b for controlling BLUETOOTH connections of the computer system 101, a wireless communication control element 720c for controlling near field communications between the computer system 101 and another computer system that may be in proximity to the computer system 101, an airplane mode control element 720d for enabling/disabling the airplane mode of the computer system 101, a virtual display control element 720e for controlling establishment of a connection between the computer system 101 and a second computer system that is different from the computer system 101 to use display generation component 120 to display user interfaces of (e.g., content from) the second computer system, a screen recording control 720f for capturing one or more images (e.g., a still image or a video) of the viewpoint of the user 702 of the computer system 101, a viewing mirroring control element 720g for controlling establishment of a connection between the computer system 101 and a second computer system for mirroring the displays of the computer system 101 to the second computer system and/or for mirroring the displays of the second computer system to the computer system 101, a focus mode control element 720h for controlling operation of the computer system 101 in a focus mode, guest mode control element 720i for controlling operation of the computer system 101 in a guest mode, and a spatial tracking mode control 720j for controlling a spatial tracking mode of operation of the computer system 101; these controls are described further with reference to method 800.

As described above, in FIG. 7C, the control user interface 716 includes the immersive environment control user interface element 716c that includes plurality of controls for controlling environment parameters of the immersive environment 705 (e.g., the selected immersive environment). For example, in FIG. 7C, the plurality of controls in the immersive environment control user interface element 716c control the immersive environment 705. In FIG. 7C, the plurality of immersive environment controls includes an immersion control element 722a for controlling a level of immersion of the immersive environment 705, an immersive environment volume control element 722b for controlling a volume level of the immersive environment 705, a time of day control element 722c for controlling a time of day setting of the immersive environment 705, and a control element 722d for changing the immersive environment 705. The immersive environment control user interface element 716c also includes a visual representation 722e of the immersive environment 705 (e.g., the immersive environment 705 designated as being in use in the illustrated embodiment), which is selectable as described below. In some embodiments, the immersive environment control user interface element 716c is displayed without the immersive environment volume control element 722b. The controls in the immersive environment control user interface element 716c are described further with reference to method 800.

As described above, in FIG. 7C, the control user interface 716 includes the notifications control user interface element 716d that includes a plurality of notifications and notification control elements. In FIG. 7C, the plurality of notifications includes a first notification 724a from a messaging application and a second notification 724b from a news application. For example, the computer system 101 optionally detected a notification event from the messaging application, and then presented the first notification 724a in response. In FIG. 7C, the first notification 724a include a timestamp of the notification. Likewise, the computer system 101 optionally detected a notification event from the news application, and then presented the second notification 724b in response. In FIG. 7C, the second notification 724b include a timestamp of the notification. Notification events are described further with reference to method 800. In FIG. 7C, the notification control elements include a focus mode control element 725a for controlling presentation of the one or more notifications from the one or more applications on the computer system 101 and a clearing control element 725b for dismissing notifications from presentation in the notifications control user interface element 716d. For example, the clearing control element 725b is optionally selectable to clear (e.g., remove) the first notification 724a and the second notification 724b from presentation in the notifications control user interface element 716d. For example, the clearing control element 725b is optionally selectable to clear the notification queue in the notification control user interface element 716d. The notifications control user interface element 716d is described further with reference to method 800.

FIGS. 7C and 7D illustrate an example of the computer system 101 detecting and responding to input for changing an immersion level of the immersive environment 705 of the computer system 101, in accordance with some embodiments.

While displaying the view of the three-dimensional environment 704 in FIG. 7C, the computer system 101 optionally detects an input directed to the immersion control element 722a (e.g., without detecting an input other than the input directed the immersion control element 722a). In some embodiments, the input directed to the immersion control element 722a includes attention 714 (e.g., based on gaze) of the user 702 directed to the immersion control element 722a and movement of the hand 702a while the hand 702a is performing an air pinch gesture (e.g., the thumb and index finger of the hand of the user are in contact). In response to detecting the input directed to the immersion control element 722a, the computer system 101 changes the immersive level of the immersive environment of the computer system in accordance with the input (e.g., in a direction and by a magnitude that correspond to a direction and magnitude of associated with the input (e.g., the movement of the hand 702a)), such as shown from FIG. 7C to FIG. 7D. For example, the input in FIG. 7C includes a request to reduce the level of immersion of the immersive environment 705 of the computer system 101 and the level of immersion in FIG. 7D is less than the level of immersion in FIG. 7C in response to detecting the input. Features of the computer system 101 detecting and responding to input for changing an immersion level of the immersive environment 705 of the computer system 101 are described further with reference to method 800.

FIGS. 7C and 7E illustrate an example of the computer system 101 detecting and responding to input for changing a time of day setting of the immersive environment 705 of the computer system 101, in accordance with some embodiments. In some embodiments, different times of day settings of an immersive environment correspond to different simulated times of day in the immersive environment (e.g., daytime, nighttime, afternoon, sunset, dawn, hour by hour). The time of day setting of the immersive environment 705 in FIG. 7C is the light lighting setting, as indicated by the visual indication of the time of day control element 722c in FIG. 7C. While displaying the view of the three-dimensional environment 704 in FIG. 7C, the computer system 101 optionally detects an input directed to the time of day control element 722c (e.g., without detecting an input other than the input directed the time of day control element 722c). In some embodiments, the input directed to the time of day control element 722c includes attention 714 (e.g., based on gaze) of the user 702 directed to the time of day control element 722c while the hand 702a performs an air pinch gesture (e.g., the thumb and index finger of the hand of the user coming into contact with each other and then the release thereof). In some embodiments, in response to detecting the input directed to the time of day control element 722c, the computer system 101 displays a platter including user interface elements that are selectable to set the current time of day setting of the immersive environment, such as an element selectable to set the time of day setting to the light lighting setting, an element selectable to set time of day setting to the dark lighting setting, and an element selectable to set the time of day setting to the automatic lighting setting, each of which are described further with reference to the method 800. In response to detecting the input directed to the time of day control element 722c, and optionally in response to an input requesting to set the time of day setting to the dark lighting setting, such as an input directed to the element selectable to set time of day setting to the dark lighting setting, the computer system 101 changes the time of day setting of the immersive environment 705, from the light lighting setting as indicated in the immersive environment 705 (and as indicated by the visual indication (“Light”) of the time of day control element 722c) in FIG. 7C, to the dark lighting setting of the immersive environment 705, as indicated in the visual appearance of the immersive environment 705 in FIG. 7E and as indicated by the visual indication (“Dark”) of the time of day control element 722c in FIG. 7E. Features of the computer system 101 detecting and responding to input for changing the time of day of the immersive environment of the computer system 101 are described further with reference to method 800.

FIGS. 7C and 7F illustrate an example of the computer system 101 detecting and responding to input for changing immersive environments of the computer system 101, in accordance with some embodiments.

In some embodiments, an immersive environment corresponds to a virtual representation of a physical place, setting or location corresponding to a geographical location and/or an atmosphere corresponding to the place at a particular time (e.g., the hill on which the “HOLLYWOOD” sign in Hollywood, California exists during a sunny day, or a shore of Lake Houston in Houston, Texas, in the evening time corresponding to evening at the shore). For example, the immersive environment 705 in FIGS. 7A through 7C optionally corresponds to the same virtual representation of the same physical location. While displaying the view of the three-dimensional environment 704 (e.g., while displaying the view of the immersive environment 705) in FIG. 7C, the computer system 101 optionally detects an input directed to the control element 722d for changing the currently selected immersive environment of the computer system 101 (e.g., without detecting an input other than the input directed to the control element 722d). In some embodiments, the input directed to the control element 722d includes attention 714 (e.g., based on gaze) of the user 702 directed to the control element 722d while the hand 702a performs an air pinch gesture (e.g., the thumb and index finger of the hand of the user coming into contact with each other and then the release thereof). In some embodiments, in response to detecting the input directed to the control element 722d, the computer system 101 displays different selectable options corresponding to different immersive environments of the computer system 101; such features are described further with reference to the method 800. In some embodiments, in response to detecting the input directed to the control element 722d, and optionally in response to an input requesting to change the currently selected immersive environment to the immersive environment illustrated in FIG. 7F, the computer system 101 changes the currently selected immersive environment from the immersive environment 705 as indicated by the visual representation 722e of the immersive environment 705, to a second immersive environment 705a as indicated by the visual representation 722e of the second immersive environment 705a (and as indicated in the visual appearance of the immersive environment 705 in display generation component 120 in FIG. 7F). Features of the computer system 101 detecting and responding to input for changing immersive environments of the computer system 101 are described further with reference to method 800.

FIGS. 7C and 7G illustrate different examples of the computer system 101 detecting and responding to different inputs directed to the control user interface 716, in accordance with some embodiments.

For example, while displaying the view of the three-dimensional environment 704 (e.g., while displaying the view of the immersive environment 705) in FIG. 7C, the computer system 101 optionally detects an input directed to the play/pause control 718b (e.g., without detecting an input other than the input directed to the play/pause control 718b), which in the illustrated embodiment is a pause control for pausing playback of media. In some embodiments, the input directed to the play/pause control 718b includes attention 714 (e.g., based on gaze) of the user 702 directed to the play/pause control 718b while the hand 702a is performing an air pinch gesture (e.g., the thumb and index finger of the hand of the user coming into contact with each other and then the release thereof). In some embodiments, in response to detecting the input directed to the play/pause control 718b in FIG. 7C, the computer system 101 pauses playback of the media “Song 1”, and causes the play/pause control 718b to become selectable to play the media again. Features of the computer system 101 detecting and responding to input directed at the media control user interface element 716a are described further with reference to method 800.

As another example, while displaying the view of the three-dimensional environment 704 (e.g., while displaying the view of the immersive environment 705), including the control user interface 716, in FIG. 7C, the computer system 101 optionally detects an input directed to the immersive environment volume control element 722b (e.g., without detecting an input other than the input directed to the immersive environment volume control 722b). In some embodiments, the input directed to the immersive environment volume control element 722b includes attention 714 (e.g., based on gaze) of the user 702 directed to the immersive environment volume control element 722b and movement of the hand 702a while the hand 702a is performing an air pinch gesture (e.g., the thumb and index finger of the hand of the user are in contact). In response to detecting the input directed to the immersive environment volume control 722b, the computer system 101 changes the volume level of the immersive environment of the computer system in accordance with the input (e.g., in a direction and by a magnitude that correspond to a direction and magnitude of associated with the input (e.g., the movement of the hand 702a)), such as shown from FIG. 7C to FIG. 7G. For example, the input directed to the immersive environment volume control element 722b in FIG. 7C includes a request to reduce the volume level of the immersive environment 705 and the volume level of the immersive environment 705 in FIG. 7G is greater than the volume level of the immersive environment 705 in FIG. 7C in response to detecting the input. Features of the computer system 101 detecting and responding to input for changing a volume level of the immersive environment 705 of the computer system 101 are described further with reference to method(s) 800 and/or 1000.

As another example, while displaying the view of the three-dimensional environment 704 (e.g., while displaying the view of the immersive environment 705), including the control user interface 716, in FIG. 7C, the computer system 101 optionally detects an input directed to the focus mode control element 725a for controlling presentation of the one or more notifications from the one or more applications on the computer system 101 (e.g., without detecting an input other than the input directed to the focus mode control element 725a). In FIG. 7C, the focus mode control element 725a visually indicates that the computer system 101 is not in a focus mode, so notifications would optionally be presented outside of control user interface 716 in FIG. 7C. In some embodiments, the input directed to the focus mode control element 725a includes attention 714 (e.g., based on gaze) of the user 702 directed to the focus mode control element 725a and movement of the hand 702a while the hand 702a performs an air pinch gesture (e.g., the thumb and index finger of the hand of the user coming into contact with each other and then the release thereof). In response to detecting the input directed to the focus mode control element 725a, the computer system 101 enables the focus mode for notifications, optionally including forgoing presentation of notifications outside of the notifications control user interface element 716d. For example, the text in the focus mode control element 725a in FIG. 7C is not bolded, thus indicating that the focus mode for notifications is not enabled in FIG. 7C, and the text in the focus mode control element 725a in FIG. 7G is bolded, thus indicating that the focus mode for notifications is enabled in FIG. 7G, and further a focus mode enabled icon 717a is displayed in FIG. 7G, which also indicates that the focus mode for notifications is enabled in FIG. 7G. Other visual indications, such as color(s), image(s), and/or size(s), of whether or not the focus mode is enabled are possible in some embodiments. Features of the computer system 101 detecting and responding to input for controlling presentation of the one or more notifications from the one or more applications on the computer system 101 via the control user interface 716 are described further with reference to method 800.

As another example, while displaying the view of the three-dimensional environment 704 (e.g., while displaying the view of the immersive environment 705), including the control user interface 716, in FIG. 7C, the computer system 101 optionally detects a scroll input directed to the notifications control user interface element 716d for scrolling the content (e.g., the notifications) of the notifications control user interface element 716d (e.g., without detecting an input other than the scroll input directed to the notifications control user interface element 716d). In some embodiments, the scroll input directed to the notifications control user interface element 716d includes attention 714 (e.g., based on gaze) of the user 702 directed to the notifications control user interface element 716d and movement (e.g., vertical movement as indicated by the arrow 727) of the hand 702a while the hand 702a is performing an air pinch gesture (e.g., the thumb and index finger of the hand of the user are in contact). In response to detecting the scroll input directed to the notifications control user interface element 716d, the computer system 101 scrolls the content of the notifications control user interface element 716d in accordance with the input (e.g., in a direction and by a magnitude that correspond to a direction and magnitude of associated with the input (e.g., the movement of the hand 702a)), such as shown from FIG. 7C to FIG. 7G. For example, from FIG. 7C to FIG. 7G, the notifications pane of the notifications control user interface element 716d has been scrolled downward, such that the notification 724c is now shown in the notifications control user interface element 716d and the first notification 724a is no longer in shown in the notifications control user interface element 716d. In the illustrated embodiment of FIG. 7C, the scroll input directed to the notifications control user interface element 730d includes vertical movement of the user 702; in some embodiments, the scroll input in FIG. 7C directed to the notifications control user interface element 730d includes horizontal movement of the hand 702a to scroll the content of the notifications control user interface element 730d. In some embodiments, the computer system 101 scrolls the content of a user interface element without scrolling positions of user interface elements of the control user interface 716 in the three-dimensional environment 704; such features are described further with reference to method 800. Features of the computer system 101 detecting and responding to input for scrolling content of a user interface element of the control user interface 716 are described further with reference to method 800.

FIGS. 7C and 7H illustrate an example of the computer system 101 detecting and responding to input directed to the volume icon 716e-2 of the system volume control element 716e of the control user interface 716, in accordance with some embodiments. For example, in FIG. 7C, the computer system 101 optionally detects an input directed to the volume icon 716e-2 (e.g., without detecting an input other than the input directed to the volume icon 716e-2). In some embodiments, the input directed to the volume icon 716e-2 includes attention 714 (e.g., based on gaze) of the user 702 directed to the volume icon 716e-2 while the hand 702a performs an air pinch gesture (e.g., the thumb and index finger of the hand of the user coming into contact with each other and then the release thereof). In response to detecting the input directed to the volume icon 716e-2, the computer system 101 displays an audio management panel 726, as shown in FIG. 7H. In FIG. 7H, the computer system 101 displays the audio management panel 726 closer to a position corresponding to the viewpoint of the user 702 than the user interface elements 716a through 716d of the control user interface 716 while maintaining display of the user interface elements 716a through 716d of the control user interface 716. Additionally, in some embodiments, the computer system 101 does not move the user interface elements 716a through 716d of the control user interface 716 in response to detecting the input directed to the volume icon 716e-2. In FIG. 7H, the volume control user interface 726 includes volume control elements 726a through 726c. In FIG. 7H, volume slider 726a is selectable to control the system volume of the computer system 101 (e.g., just as the volume slider 716e-1 is selectable to control the system volume of the computer system 101 as described above). In FIG. 7H, the volume slider 726b is selectable to control a volume level of playback of media (e.g., the volume level of “Song 1” which is currently in playback in FIG. 7H as indicated by the media control user interface element 716a of the control user interface 716. In FIG. 7H, the volume slider 726c is selectable to control a volume level of the immersive environment 705, such as described with reference to the immersive environment volume control element 722b. Additionally or alternatively, in some embodiments, the computer system 101 detects an input directed to the system volume control element (e.g., the slider of the system volume control element) described with reference to method 1000) and in response to the input directed to the system volume control element, the computer system 101 displays the audio management panel 726, as shown in FIG. 7H. Volume level controls of the audio management panel 726 are described further with reference to methods 800 and/or 1000.

In FIG. 7H, the volume control user interface 126 includes spatial audio control elements 726d through 726f (e.g., toggles) that are selectable to control a spatial audio mode of different audio components. The control element 726d is selectable to control a spatial audio mode of system audio components. Control element 726e is selectable to control a spatial audio mode of media playback at the computer system 101. Control element 726f is selectable to control a spatial audio mode of the immersive environment 705 of the computer system 101. In some embodiments, were the computer system 101 to detect input directed to the control element 726d and corresponding to a request to enable to spatial audio mode of the system audio components of the computer system 101, the computer system 101 would optionally cause the control element 726e and 726f to be enabled as well in response to detecting the input directed to the control element 726d. Spatial mode controls of the audio management panel 726 are described further with reference to methods 800 and/or 1000.

In FIG. 7H, the audio management panel 726 also includes output device control elements 726g and 726h that correspond to different audio output devices in communication with the computer system 101. In FIG. 7H, the control element 726g is currently selected, so the computer system 101 is configured to present audio through the audio output device that corresponds to the control element 726g (“Device A”). In some embodiments, were the computer system 101 to detect input directed to the control element 726h in FIG. 7H, the computer system 101 would optionally cease presenting audio through the audio output device that corresponds to the control element 726g (“Device A”) and would optionally start presenting through the audio output device that corresponds to the control element 726h (“Device B”). Audio output device controls of the audio management panel 726 are described further with reference to methods 800 and/or 1000. In FIG. 7H, the audio management panel 726 also includes an ambient noise control element 726i for setting an ambient noise mode of the computer system 101, optionally to at least one of an active noise cancellation mode or a passthrough mode, such as described with reference to method 1000.

FIGS. 7C and 7I illustrate another example of the computer system 101 detecting and responding to input directed to the notifications control user interface element 716d of the control user interface 716, in accordance with some embodiments. In some embodiments, the computer system moves a user interface element of the control user interface in the viewpoint of the user of the computer system (e.g., in the three-dimensional environment 704) in response to detecting input directed at the user interface element. For example, the computer system optionally detects an input directed at the notification user interface element 716d (e.g., without detecting an input other than the input directed at the notification user interface element 716d). Continuing with this example, in response to detecting the input directed at the notification user interface element 716d (e.g., selection of the notifications control user interface element 716d described above), the computer system 101 optionally moves the notifications control user interface element 716d towards the viewpoint of the user 702 of the computer system 101 (e.g., toward a position corresponding to the viewpoint of the user 702) and/or moves away from the viewpoint of the user 702 of the computer system 101 (e.g., away from the position corresponding to the viewpoint of the user 702) other user interface elements of the control user interface 716 to visually emphasize the notification user interface element 716d in the viewpoint of the user 702, such as shown in FIG. 7I. That is, from FIG. 7C to FIG. 7I, the notifications control user interface element 716d of the control user interface 716 is moved toward the viewpoint of the user (e.g., toward the position corresponding to viewpoint of the user 702) and the other user interface elements 716a through 716c of the control user interface 716 are moved away further from the viewpoint of the user 702 (e.g., from the position corresponding to viewpoint of the user 702). Furthermore, as shown from FIG. 7C to FIG. 7I, in addition to moving forward the notifications user interface element 716d and moving backward the user interface elements 716a through 716c of the control user interface 716 in the viewpoint of the user 702, the computer system 101 has moved laterally the user interface elements 716a through 716c of the control user interface 716 in the viewpoint of the user 702 in response to detecting the input directed at the notifications user interface element 716d. In some embodiments, in response to detecting the input directed at the notifications user interface element 716d, the computer system 101 moves the notifications user interface element 716d forward in the viewpoint of the user 702 without moving laterally the other user interface elements of the control user interface 716 (e.g., the user interface elements 716a through 716c of the control user interface 716) in the viewpoint of the user 702.

FIGS. 7C and 7J illustrate an example of the computer system 101 detecting and responding to input directed to the search control user interface element 716f of the control user interface 716, in accordance with some embodiments. While displaying the view of the three-dimensional environment 704 in FIG. 7C, the computer system 101 optionally detects an input directed to the search control user interface element 716f (e.g., without detecting an input other than the input directed to the search control user interface element 716f). In some embodiments, the input directed to the search control user interface element 716f includes attention 714 (e.g., based on gaze) of the user 702 directed to the search control user interface element 716f while the hand 702a performs an air pinch gesture (e.g., the thumb and index finger of the hand of the user coming into contact with each other and then the release thereof). In some embodiments, in response to detecting the input directed to search control user interface element 716f, the computer system 101 displays a search user interface 728, as shown in FIG. 7J. In the illustrated embodiment of FIG. 7J, the search user interface 728 is closer to the viewpoint of the user than the user interface elements 716a through 716d of the control user interface 716, such as described with reference to the audio management panel 726 being closer to a position corresponding to the viewpoint of the user 702 than the user interface elements 716a through 716d of the control user interface 716 while maintaining display of the user interface elements 716a through 716d of the control user interface 716 in FIG. 7H.

In some embodiments, the computer system 101 detects and responds to input directed at the search user interface 728 of FIG. 7J. For example, the computer system 101 optionally detects and responds to search queries (e.g., typing inputs, voice inputs, and/or other types of input requesting to search the input) directed at the search user interface 728 by searching the query in one or more search engines and presenting (e.g., displaying) the results of the search(es). Also, in the illustrated embodiment of FIG. 7J, the search user interface 728 includes an indication a recently searched query at the computer system 101, which is optionally selectable to search the query again. Features of the search control user interface element 716f of the control user interface 716 are described further with reference to method 800.

FIGS. 7C and 7K illustrate an example of the computer system 101 detecting and responding to input directed to the control element 716g for modifying display of the control user interface 716, in accordance with some embodiments. While displaying the view of the three-dimensional environment 704 in FIG. 7C, the computer system 101 optionally detects an input directed to the control element 716g (e.g., without detecting an input other than the input directed to the control element 716g). In some embodiments, the input directed to the control element 716g includes attention 714 (e.g., based on gaze) of the user 702 directed to the control element 716g while the hand 702a performs an air pinch gesture (e.g., the thumb and index finger of the hand of the user 702 coming into contact with each other and then the release thereof). In some embodiments, in response detecting to input directed to the control element 716g, the computer system 101 causes the control user interface 716 to enter an editing mode, such as shown in FIG. 7K.

In some embodiments, in the editing mode, the computer system 101 detects and responds to input for re-arranging (e.g., re-ordering) the user interface elements 716a through 716d of the control user interface 716 relative to each other, such as shown from FIG. 7K to FIG. 7L. In FIG. 7K, the control user interface 716 is in an editing mode for editing aspects of the control user interface 716. In FIG. 7K, the user interface elements 716a through 716d of the control user interface 716 are associated with controls elements 730a through 730d, respectively. A control element of control elements 730a through 730d is optionally selectable to change the order of the user interface elements 716a through 716d relative to each other in the control user interface 716; these features are further illustrated and described with reference to FIGS. 7K and 7L. For example, the order of the user interface elements 716a through 716d in the control user interface 716 in FIG. 7L is different from the order of the user interface elements 716a through 716d in the control user interface 716 in FIG. 7K, optionally because the computer system 101 detected and responded to input directed to one or more of the control elements 730a through 730d that changed the order of the user interface elements 716a through 716d relative to each other to be the order of the user interface elements 716a through 716d relative to each other illustrated in FIG. 7L. For example, the immersive environment control user interface element 716c optionally has the first position (e.g., from left to right) of the user interface elements 716a through 716d in FIG. 7L because, while in the editing mode illustrated in FIG. 7K, the computer system 101 optionally detected an input directed at the control element 730c. The input directed at the control element 730c optionally included attention 714 (e.g., based on gaze) of the user 702 directed at the control element 730c and movement of the hand 702a while the hand 702a is performing an air pinch gesture (e.g., the thumb and index finger of the hand of the user are in contact) corresponding to a request to move the immersive environment control user interface element 716c to the first position in the order of the user interface elements 716a through 716d in the control user interface 716, and the computer system 101 optionally detected the input directed at the control element 730c without detecting an input other than the input directed at the control element 730c. Continuing with this example, the computer system 101 optionally responded to the input directed at the control element 730c by moving the immersive environment control user interface element 716c to the first position in the order of the user interface element 716a through 716d (e.g., as illustrated in FIG. 7L). Continuing with this example, after detecting and responding to the input directed the control element 730c (and optionally after detecting and responding to input directed to one or more other control elements 730a through 730d for changing the order of the user interface elements 716a through 716d relative to each other), the computer system 101 optionally detected an input directed to the control element 732 (e.g., attention 714 (e.g., based on gaze) of the user 702 directed to the control element 732 while the hand 702a performs an air pinch gesture (e.g., the thumb and index finger of the hand of the user coming into contact with each other and then the release thereof) for exiting the editing mode of the control user interface 716 (e.g., without detecting an input other than the input directed to the control element 732). For example, the order of the user interface elements 716a through 716d relative to each other in the control user interface 716 in FIG. 7L is optionally the same as the order of the user interface elements 716a through 716d relative to each other in the control user interface 716 when the input directed to the control element 732 was detected.

In some embodiments, in the editing mode, the computer system 101 detects and responds to input for additional user interface elements to the control user interface 716, such as shown from FIG. 7K to FIG. 7O. In FIG. 7K, the control user interface 716 is in an editing mode for editing aspects of the control user interface 716. In FIG. 7K, in the editing mode, the control user interface 716 includes a control element 734 for adding additional user interface elements to the control user interface 716. In some embodiments, the additional user interface elements are for controlling parameters of additional system functions for which controls are not already in the control user interface 716, such as the user interface elements 716l and 716m that are described with reference to FIG. 7Q. In some embodiments, while displaying the control user interface 716 in the editing mode, such as shown in FIG. 7K, the computer system 101 detects an input directed to the control element 734 (e.g., without detecting an input other than the input directed to the control element 732). In some embodiments, the input directed to the control element 734 includes attention 714 (e.g., based on gaze) of the user 702 directed to the control element 734 while the hand 702a performs an air pinch gesture (e.g., the thumb and index finger of the hand of the user coming into contact with each other and then the release thereof). In some embodiments, in response to detecting the input directed to the control element 734, the computer system 101 displays selectable options corresponding to additional user interface elements that are available to be added to the control user interface 716. In response to detecting the input directed to the control element 734, and optionally in response to detecting one or more inputs requesting to one or more additional user interface elements to be added to the control user interface 716, such as one or more inputs directed to the one or more selectable options that correspond to additional user interface elements that can be added to the control user interface 716, the computer system 101 adds the additional user interface elements to the control user interface 716 in accordance with the input(s). For example, from FIG. 7K to FIG. 7O, user interface element 716l and user interface element 716m are optionally added to the control user interface 716 in FIG. 7O in response to detecting the inputs described above (e.g., the input directed to the control element 734 and the one or more inputs that specifically request that the user interface element 716l and the user interface element 716m are added to the control user interface 716). The content of user interface element 716l and user interface element 716m is further illustrated and described with reference to FIG. 7Q. Additionally, adding user interface elements to the control user interface 716 is further described with reference to method 800.

In some embodiments, in the editing mode, the computer system 101 detects and responds to input for removing user interface elements from the control user interface 716, such as for removing any of the user interface elements 716a through 716d from the control user interface 716. In some embodiments, in the editing mode, the computer system 101 detects and responds to input for adding or removing controls within a specific user interface element of the control user interface 716, such as for adding or removing controls within any of the user interface elements 716a through 716d of the control user interface 716. Features of modifying display of the control user interface 716 are described further with reference to method 800.

FIGS. 7C, 7M, and 7N illustrate an example of the computer system 101 detecting and responding to input for viewing additional information about the geographic location that corresponds to the immersive environment 705, in accordance with some embodiments.

As described above, the immersive environment control user interface element 716c includes a visual representation 722e (e.g., a preview) of the immersive environment 705 (e.g., the immersive environment 705 designated as being in use in the illustrated embodiment). In some embodiments, the visual representation 722e of the immersive environment 705 is displayed with a stereo visual effect, such as described with reference to method 800. In some embodiments, the visual representation 722e is selectable to display information about the geographic location that corresponds to the immersive environment 705. For example, while displaying the view of the three-dimensional environment 704 in FIG. 7C, the computer system 101 optionally detects an input directed to the visual representation 722e of the immersive environment 705 in the immersive environment control user interface element 716c (e.g., without detecting an input other than the input directed to the visual representation 722e of the immersive environment 705). In some embodiments, the input directed to the visual representation 722e includes attention 714 (e.g., based on gaze) of the user 702 directed to the visual representation 722e while the hand 702a performs an air pinch gesture (e.g., the thumb and index finger of the hand of the user coming into contact with each other and then the release thereof). In some embodiments, in response to detecting the input directed to the visual representation 722e of the immersive environment 705, the computer system 101 initiates a process to display information about the geographic location that corresponds to the immersive environment 705, as shown from FIG. 7M to 7N. In some embodiments, the process includes visually rotating the immersive environment control user interface element 716c about a central axis of the immersive environment control user interface element 716c, such as shown with the arrow 736 in FIG. 7M until the immersive environment control user interface element 716c is in the orientation illustrated in FIG. 7N. The animation of rotation of the immersive environment control user interface element 716c illustrated from FIG. 7C to FIG. 7M to FIG. 7N (e.g., in response to detecting the input directed to the visual representation 722e) is a 180-degree rotation of the immersive environment control user interface element 716c about a vertical central axis of the immersive environment control user interface element 716c. In some embodiments, were the computer system 101 to detect an input selecting the immersive environment control user interface element 716c, the computer system 101 would initiates a process to display the immersive environment control user interface element 716c illustrated in FIG. 7C. For example, the computer system 101 would optionally visually rotate the immersive environment control user interface element 716c about the central axis of the immersive environment control user interface element 716c, until the immersive environment control user interface element 716c is in the orientation illustrated in FIG. 7C.

In FIG. 7N, the immersive environment control user interface element 716c includes information 738 about the geographic location (e.g., physical location) that corresponds to the immersive environment 705. In FIG. 7N, the information 738 includes distance information (e.g., how far the geographic location is from one or more landmarks of the geographic location), elevation information (e.g., how high the geographic location that corresponds to the immersive environment 705 is above sea level), and map information (e.g., a map-view, such as a top-down view of the geographic location).

As discussed above, in FIG. 7O, the computer system 101 includes user interface elements 716a through 716d, 716l, and 716m, where the user interface element 716l and the user interface element 716m were optionally added to the control user interface 716 in response to input for adding the user interface element 716l and the user interface element 716m detected while the control user interface 716 was in the editing mode illustrated in FIG. 7K and/or described with reference to method 800. FIGS. 7O through 7Q illustrate an example of the computer system 101 detecting and responding to a scroll input for scrolling user interface elements of the control user interface 716.

While displaying the view of the three-dimensional environment 704 in FIG. 7O, the computer system 101 optionally detects a scroll input directed to the control user interface 716, as shown in FIG. 7P. In some embodiments, the scroll input directed to the control user interface 716 includes attention 714 (e.g., based on gaze) of the user 702 directed to the control user interface 716 and movement (e.g., horizontal movement as indicated by the arrow 727a) of the hand 702a while the hand 702a is performing an air pinch gesture (e.g., the thumb and index finger of the hand of the user are in contact). In response to detecting the input directed to the control user interface 716, the computer system 101 scrolls the user interface elements 716a through 716d, 716l, and 716m of the control user interface 716 in accordance with the input (e.g., in a direction and by a magnitude that correspond to a direction and magnitude of associated with the input (e.g., the movement of the hand 702a)), such as shown from FIG. 7P to FIG. 7Q. For example, the user interface elements 716a through 716d, 716l, and 716m are optionally configured to be scrolled as a carousel (e.g., about a vertical axis) and the input in FIG. 7P includes a request to scroll the user interface elements 716a through 716d, 716l, and 716m rightward in the viewpoint of the user 702 and the order of the user interface elements 716a through 716d, 716l, and 716m in FIG. 7Q is a result of the scroll input detected in FIG. 7P. In the illustrated embodiment of FIG. 7P, the input includes horizontal movement of the hand 702a of the user 702; in some embodiments, the input in FIG. 7P includes vertical movement of the hand 702a of the user 702 to scroll the user interface elements 716a through 716d, 716l, and 716m of the control user interface 716. In some embodiments, the computer system 101 scrolls the user interface elements of the control user interface 716 (e.g., scrolls positions of the user interface elements of the control user interface 716 without scrolling respective content of the user interface elements of the control user interface 716 (e.g., without changing the content that a respective user interface element of the control user interface 716 is configured to display); such features are described further with reference to method 800. Features of the computer system 101 detecting and responding to input for scrolling user interface elements of the control user interface 716 are described further with reference to method 800.

The user interface element 716l of the control user interface 716 includes selectable options corresponding to shortcuts to applications of the computer system 101. In FIG. 7Q, the user interface element 716l includes option 716l-1 for setting an alarm in a time/alarm application and an option 716l-2 for creating a note entry in a note application. The user interface element 716m of the control user interface 716 includes selectable options for controlling a IoT system, such as a home IoT system. The user interface element 716m includes an option 716m-1 for viewing and/or setting a temperature of the home of the user 702, an option 716m-2 for viewing and/or controlling a status of lights in the home of the user 702, an option 16m-3 for viewing and/or controlling a status of a home alarm system of the home of the user 702, and an option 716m-4 for viewing and/or controlling connections of visual and/or audio output devices in the home of the user 702.

In some embodiments, the computer system 101 detects and responds to an input corresponding to a request to cease displaying the control user interface 716. For example, in FIG. 7R, the computer system 101 optionally detects an input corresponding to a request to cease displaying the control user interface 716. For example, the computer system 101 optionally detects attention 714 (e.g., based on gaze) of the user 702 directed to outside the control user interface 716 while the hand 702a performs an air pinch gesture (e.g., the thumb and index finger of the hand of the user coming into contact with each other and then the release thereof), and the computer system 101 corresponds said input to the request to cease displaying the control user interface 716. In some embodiments, in response to detecting the input in FIG. 7R, the computer system 101 ceases display of the control user interface 716, such as shown from FIG. 7R to FIG. 7A. For example, in response to detecting the input in FIG. 7R, the computer system 101 displays the view of the three-dimensional environment 704 illustrated in FIG. 7A.

In some embodiments, the computer system 101 displays user interface elements of the control user interface 716 based on a previously displayed order of the user interface elements of the control user interface 716. For example, after ceasing display of the control user interface 716 in response to detecting the input described with reference to FIG. 7R, the computer system 101 optionally detects an input corresponding to a request to display the control user interface 716, such as the input in FIG. 7S, which is optionally as described with reference to the input described with reference to FIG. 7B. For example, the input of FIG. 7S optionally includes a selection input including input from the hand 702a of the user 702 (e.g., an air pinch gesture) while attention 714 of the user 702 is directed to the control widget user interface 712, such as described with reference to FIG. 7B. Continuing with this example, in response to detecting the input corresponding to the request to display the control user interface 716, the computer system 101 optionally displays the user interface elements 716a through 716d, 716l, and 716m, of the control user interface 716 in their relative order illustrated in FIG. 7Q, which is the relative order resulting from the scroll input in FIG. 7P, or displays the user interface elements 716a through 716d, 716l, and 716m of the control user interface 716 in their relative order illustrated in FIG. 7O, which is the relative order before the scroll input is detected, based on an amount of time since the ceasing of display of the control user interface 716. Displaying user interface elements of the control user interface 716 in a relative order that is based on an amount of time since the ceasing of display of the control user interface 716 is further described with reference to method 800.

FIGS. 7T and 7U illustrate an example of the computer system 101 detecting and responding to an input corresponding to a request to display the control user interface 716 while a respective application having an associated user interface element of the control center user interface 716 is in use, in accordance with some embodiments. In FIG. 7T, the computer system 101 displays a user interface 708b of a video conferencing application. In FIG. 7T, the user 702 is in a video conference call with a second user, and the user interface 708b shows video feed of the second user captured by a second computer system of the second user. The user interface 708b includes selectable options 740 for controlling aspects of the video conference call. For example, the control 740a is optionally selectable to select an audio output device for presented audio of the video conference call at the computer system 101; the control 740b is optionally selectable to enable/disable video feed captured at the computer system 101; the control 740c is optionally selectable to enable/disable audio detection (e.g., a mute function); the control 740d is optionally selectable to share content in the video conference call; the control 740e is optionally selectable to end the video conference call. While displaying the view of the three-dimensional environment 704 illustrated in FIG. 7T, the computer system 101 optionally detects an input corresponding to a request to display the control user interface 716 such as the input in FIG. 7T, which is optionally as described with reference to the input described with reference to FIG. 7B and FIG. 7S. For example, the input of FIG. 7T optionally includes a selection input including input from the hand 702a of the user 702 (e.g., an air pinch gesture) while attention 714 of the user 702 is directed to the control widget user interface 712. In response to detecting the input of FIG. 7T, the computer system 101 displays the control user interface 716, such as shown in FIG. 7U, while maintaining the activity of the video conference as well.

In FIG. 7U, the control user interface 716 includes a user interface element 716n (e.g., a video conferencing user interface element) because the videoconferencing application is currently in use with an active videoconference call. The user interface element 716n includes an indication of the second user (e.g., a caller ID of the second user, a photo, and/or name of the second user) since the user 702 is currently in a video conference call with the second user. controls for controlling aspects of the video conference application. In FIG. 7U, the user interface element 716n also includes a first option 742a for sending a text message to the second user in the video conference; a second option 742b for ending the video conference with the second user; a third option 742c that optionally indicates a phone number, email, or name, or other identifier of or associated with the second user, a fourth option 742d for adding users to the video conference, a fifth option 742 for generating a link (e.g., a URL) for inviting users to the video conference. Additionally or alternatively, in some embodiments, the user interface element 716n includes a sixth option for enabling/disabling live captions of the video conference and a six option for silencing notifications indicative of requests that other users want to join the video conference, and/or other options that control other aspects of the video conference. In some embodiments, were the video conferencing application in use when the input to display the control user interface 716 is detected, the computer system 101 would optionally display the control user interface 716 including the user interface element 716n, as illustrated in FIG. 7U. In some embodiments, were the video conferencing application not in use when the input to display the control user interface 716 is detected, the computer system 101 would optionally display the control user interface 716 excluding the user interface element 716n, such as shown in FIGS. 7C, 7O, and 7Q. Displaying, in the control user interface 716, a user interface element for controlling aspects of an application that is currently in use at the computer system 101 when the application is currently in use at the computer system 101 is described further with reference to method 800.

FIGS. 7V through 7X illustrate an example of the computer system 101 detecting and responding to input for displaying the control user interface 716, where content of an application is in immersion mode when the input is detected, in accordance with some embodiments. In FIG. 7V, a presentation application running on the computer system 101 is in an immersion mode. For example, the presentation application is in a full screen mode and/or a mode in which the respective content of the presentation application surrounds a position corresponding to the viewpoint of the user 702 of the computer system 101), such as shown in the display generation component 120 and top-down view in FIG. 7V. In FIG. 7V, the presentation application includes presentation environment 744 (e.g., a three-dimensional presentation environment) including a simulated slide user interface 744a of a presentation, a simulated presenter view user interface 744b, and a simulated table 744c. Also, in FIG. 7V, the physical object 706a in the physical environment, which is in the top down view in FIG. 7V, is not being shown in the display generation component 120 because the presentation application is in the immersion mode.

While displaying the view of the three-dimensional environment 704 illustrated in FIG. 7V, the computer system 101 optionally detects an input corresponding to a request to display the control user interface 716 such as the input in FIG. 7W, which is optionally as described with reference to the input described with reference to FIGS. 7B, 7S, and 7T. For example, the input of FIG. 7V optionally includes a selection input including input from the hand 702a of the user 702 (e.g., an air pinch gesture) while attention 714 of the user 702 is directed to the control widget user interface 712. In response to detecting the input of FIG. 7W, the computer system 101 displays the control user interface 716, such as shown in FIG. 7X.

In FIG. 7X, the immersive environment control user interface element 716c includes controls for controlling environmental parameters of the immersive environment of the presentation application (e.g., instead of the controls for environment parameters of the immersive environment 705 of the computer system 101 in FIG. 7C while the computer system 101 displays an immersive system environment (e.g., immersive environment 705) and does not display an immersive application). In FIG. 7X, the immersive environment control user interface element 716c includes a first control 748a for switching a position corresponding to the viewpoint of the user 702 in the presentation environment (e.g., for moving a position of corresponding to the viewpoint of the user 702 relative to the simulated table 744c); a second control 748b for increasing an amount of simulated lighting in the presentation environment; a third control 748c for decreasing an amount of simulated lighting in the presentation environment; a fourth control for enabling/disabling a laser pointer feature in the presentation environment. Additionally or alternatively, the immersive environment control user interface element 716c in FIG. 7X includes a control for changing the presentation environment to a different presentation environment and a control for controlling a level of immersion at which the presentation environment is displayed. In some embodiments, were a different immersive application displayed, one or more options/controls in the immersive environment control user interface element 716c would be different (e.g., to correspond that application instead to the presentation application). Features of the immersive environment control user interface element 716c including controls for controlling environmental parameters of the immersive environment of the presentation application are described further with reference to method 800.

FIG. 7Y illustrates an example of the computer system 101 displaying an alternative control user interface in response to input corresponding to a request to display a control user interface, in accordance with some embodiments. For example, while displaying the view of the three-dimensional environment 704 illustrated in FIG. 7A, the computer system 101 optionally detects an input corresponding to a request to display the control user interface 716 such as the input in FIG. 7B. For example, the input of FIG. 7B optionally includes a selection input including input from the hand 702a of the user 702 (e.g., an air pinch gesture) while attention 714 of the user 702 is directed to the control widget user interface 712. In response to detecting the input of FIG. 7B, the computer system 101 displays the control user interface 750, such as shown in FIG. 7Y. As shown in FIG. 7T, the control user interface 750, includes a media playback control 750a, which optionally includes one or more features described with reference to the media control user interface element 716a and/or the plurality of media controls 718 of FIG. 7C, and includes a control 750b for controlling aspects of the immersive environment 705 (e.g., level of immersion, time of day, currently selected environment, and/or another aspect of the immersive environment 705, such as described with reference to FIG. 7C), among other controls described with reference to FIG. 7C.

The computer system 101 can detect and respond to input directed at a respective control element of the control user interface 750 just as described with reference to the computer system 101 detecting and responding to input directed at the respective control element of the control user interface 716 of FIGS. 7C and/or 7K. For example, were the computer system 101 to detect one or more inputs including an input directed at the control 750b for controlling an aspect of the immersive environment 705, the computer system 101 would optionally respond by performing the operation requested by the one or more inputs. Continuing with this example, were the one or more inputs to correspond to a request to change a level of immersion of the immersive environment 705, the computer system 101 would optionally change the level of immersion in accordance with the one or more inputs, such as described with reference to FIGS. 7C and 7D; were the one or more inputs to correspond to a request to change the time of day setting of the immersive environment from the illustrated light lighting setting to a dark lighting setting, the computer system would optionally change the time of day setting of the immersive environment 705 from the illustrated light lighting setting to the dark lighting setting, such as described with reference to FIGS. 7C and 7E; were the one or more inputs to correspond to a request to change immersive environments of the computer system 101, the computer system 101 would optionally change the currently selected immersive environment from the illustrated currently selected immersive environment 705 to a different immersive environment, such as described with reference to FIGS. 7C and 7F.

FIG. 8 is a flowchart illustrating an exemplary method 800 for displaying a control user interface of a computer system in response to detecting an input corresponding to a request to display the control user interface of the computer system in accordance with some embodiments. In some embodiments, the method 800 is performed at a computer system (e.g., computer system 101 in FIG. 1A such as a tablet, smartphone, wearable computer, or head mounted device) including a display generation component (e.g., display generation component 120 in FIGS. 1A, 3A, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 800 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 800 are, optionally, combined and/or the order of some operations is, optionally, changed.

The devices, methods, and/or computer-readable storage mediums described with reference to method 800 enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. Detecting and responding to input for displaying a control user interface by displaying a control user interface that includes an immersive environment control user interface element and system controls for controlling different aspects of the computer system makes the computer system responsive to input for displaying the control user interface, allows a user of the computer system to access controls of the computer system to configure an immersive environment experience of the computer system and to configure other aspects of the computer system, and reduces errors associated with interacting with the computer system. Displaying controls in a control user interface, such as controls for user interfaces of applications, connectivity controls related to connecting with other computer systems, and/or other controls, reduces a number of inputs and opportunities for user errors involved with viewing current settings of the computer system and modifying setting of the computer system, thus making interacting with the computer system more efficient.

In some embodiments, a method 800 (e.g., the method 800 of FIG. 8) is performed at a computer system (e.g., the computer system 101 of FIG. 7A) that is in communication with one or more display generation components and one or more input devices. In some embodiments, the computer system is or includes an electronic device, such as a mobile device (e.g., a tablet, a smartphone, a media player, or a wearable device), or a computer. In some embodiments, the one or more display generation components includes one or more displays integrated with the computer system (optionally touch screen displays), external displays such as monitors, projectors, televisions, or hardware components (optionally integrated or external) for projecting a user interface or causing a user interface to be visible to one or more users. In some embodiments, the one or more input devices include one or more electronic devices or components capable of receiving a user input (e.g., capturing a user input or detecting a user input) and transmitting information associated with the user input to the one or more electronic devices. Examples of input devices optionally include an image sensor (e.g., a camera), location sensor, hand tracking sensor, eye-tracking sensor, motion sensor (e.g., hand motion sensor) orientation sensor, microphone (and/or other audio sensors), touch screen (optionally integrated or external), remote control device (e.g., external), another mobile device (e.g., separate from the electronic device), a handheld device (e.g., external), and/or a controller.

In some embodiments, the computer system detects (802a), via the one or more input devices, an input corresponding to a request to display a control user interface (e.g., a system user interface or system control user interface) of the computer system, such as attention 714 of the user 702 of the computer system 101 directed to the control widget user interface 712 in FIG. 7B. For example, the computer system optionally detects an input from a user of the computer system that corresponds to the request to display the control user interface of the computer system. In some embodiments, the input includes a hand of the user of the computer system performing an air gesture while attention of the user is directed to their hand. For example, the input optionally includes attention (e.g., based on gaze) of the user being directed at a hand of the user, such as directed to the palm of the hand, and then the user performing a hand flip gesture (e.g., such as the palm of the hand turning to face away from the user) while attention of the user is directed at the hand. In some embodiments, the input includes an air pinch gesture performed by the hand of the user. In some embodiments, the input includes a first part and a second part. In some embodiments, the first part includes attention (e.g., based on gaze) of the user being directed at a hand of the user, such as directed to the palm of the hand, and then the user performing a hand flip gesture while attention of the user is directed at the hand. In some embodiments, the second part includes a selection input including input from the hand of the user (e.g., an air gesture) while attention (e.g., based on gaze) of the user is directed to a widget user interface, such as described below. In some embodiments, in response to detecting the first part of the input, the computer system displays a widget user interface that is selectable to display the control user interface. In some embodiments, in response to detecting the second part of the input, the computer system displays the control user interface. In some embodiments, the input includes input from a hand of the user of the computer system directed to a mechanical component of the computer system (e.g., a rotatable dial, or a push selectable button or component of the computer system), a touch input on a touch screen, an input on a mouse or trackpad, and/or an air gesture (e.g., an air pinch or hand raise detected by a camera and/or hand-tracking sensors). In some embodiments, the input includes a voice input from the user of the computer system. In some embodiments, the input includes attention (e.g., including gaze) of the user of the computer system directed to a selectable option (e.g., a physical or virtual element) that is selectable to display the control user interface. The control user interface is described in more detail below.

In some embodiments, in response to detecting the input corresponding to the request to display the control user interface of the computer system, the computer system displays (802b), via the one or more display generation components, the control user interface of the computer system, such as the control center user interface 716 in FIG. 7C, including concurrently displaying an immersive environment control user interface element configured to control one or more environment parameters of an immersive environment of the computer system (802c), such as the immersive environment control user interface element 716c in FIG. 7C, and a plurality of system controls (e.g., one or more system controls) configured to control a plurality of system functions (e.g., one or more system functions) of the computer system (802d), such as the virtual display control element 720e and the volume slider 716e-1 in FIG. 7C. In some embodiments, the control user interface controls parameters of the immersive environment without controlling parameters of other virtual content displayed by the computer system. In some embodiments, the immersive environment control user interface element is a first user interface element of a set of user interface elements that include controls (e.g., various types of user interface elements, such as dials, sliders, and/or other selectable elements) for controlling various aspects of the computer system, and the immersive environment control user interface element includes controls for controlling an immersive environment of the computer system. In some embodiments, an immersive environment of the computer system is a virtual transformation of at least a portion of the physical surroundings of the user of the computer system, providing the user ability to interact with elements of the user interface in different visual contexts. For example, the user can launch applications, participate in real-time communication sessions, watch media, and have other experiences in different virtual environments via the computer system. In some embodiments, the immersive environment of the computer system is a virtual environment, such as a virtual three-dimensional environment described herein. In some embodiments, the immersive environment corresponds to a virtual representation of a physical place, setting or location corresponding to a geographical location and/or an atmosphere corresponding to the place at a particular time (e.g., the hill on which the “HOLLYWOOD” sign in Hollywood, California exists during a sunny day, or a shore of Lake Houston in Houston, Texas, in the evening time corresponding to evening at the shore). In some embodiments, the computer system displays the immersive environment at different levels of immersion such as described below. In some embodiments, the environment parameters of the immersive environment include immersion settings, environment volume settings, lighting settings of the immersive environment, and/or other immersive environment settings. The immersive environment control user interface element and the environment parameters of the immersive environment of the computer system are described in more detail below. The plurality of system controls optionally control aspects of the computer system that are different from environment parameters of the immersive environment of the computer system (e.g., system functions other than environment parameters of the immersive environment of the computer system, sometimes referred to as non-environment system functions). The plurality of system controls and the plurality of system functions of the computer system are described in more detail below. In some embodiments, the computer system displays a first set of system controls of the plurality of system controls (e.g., various types of user interface elements, such as dials, sliders, and/or other selectable elements) in one or more user interface elements that are different from the immersive environment control user interface element, and a second set of system controls of the plurality of system controls outside of user interface elements of the control user interface elements, such as above, to the right, below, to the left, or at another location that is outside of a user interface element of the control user interface elements, such as outside of the immersive environment control user interface element and/or outside of another user interface element of the control user interface that includes one or more controls for another aspect of the computer system. As such, the computer system optionally detects and responds to input requesting display of the control user interface by displaying the control user interface elements.

In some embodiments, the computer system displays the immersive environment control user interface element at a first display location (e.g., of the control user interface), such as the illustrated location of the immersive environment control user interface element 705 in FIG. 7C, and displays the plurality of system controls distributed among a set of display locations (e.g., of the control user interface) that are different from the first display location, such as the illustrated locations of the volume slider 716e-1 and the focus mode control element 720h in FIG. 7C. In some embodiments, the computer system displays different user interfaces of the control user interface including different sets of system controls for controlling respective aspects of the computer system. For example, the different user interfaces are different windows, platters, and/or containers including user interface elements for controlling respective aspects of the computer system. In some embodiments, the computer system displays the immersive environment control user interface element and the plurality of system controls in a three-dimensional environment, such as described below, and the display locations (e.g., the first display location and the set of display locations described above) are different display locations and/or orientations in the three-dimensional environment and thus are different locations and/or orientations relative to the viewpoint of the user of the computer system.

The control user interface is optionally a virtual interface that includes control elements (e.g., a volume control element, network connection control element, focus control element, display control element, and/or other control elements) for controlling different aspects or functionalities of the computer system, such as the volume slider 716e-1 and the focus mode control element 720h in FIG. 7C. As used herein, the term “or” optionally corresponds to the inclusive “or”. In some embodiments, the control user interface, though being virtual, is separate and/or distinct from other virtual content (e.g., other user interfaces of applications) that could be displayed by the computer system. In some embodiments, were the computer system to detect the request to display the control user interface while the computer system is displaying other virtual content, the computer system would optionally concurrently display the control user interface and the other virtual content in response to detecting the input. In some embodiments, the computer system displays the control user interface and/or one or more elements of the control user interface with a predetermined, respective display characteristic, independent of a change in a display characteristic of other virtual elements displayed via the displays of the computer system. For example, in some embodiments, when the control user interface is displayed, the control user interface is optionally displayed in a predetermined, respective state of immersion regardless of the level of immersion at which the virtual content was displayed prior to the computer system displaying the control user interface. Levels of immersions are described further below. As another example, in some embodiments, when the control user interface is displayed, the control user interface is optionally displayed in the predetermined, respective state of immersion independent of whether or not the level of immersion of the other virtual content changes while the control user interface is being displayed. For example, while displaying the control user interface, were the computer system to detect a first input corresponding to a request to change the level of immersion of virtual content, the first computer system would optionally change the level of immersion at which virtual content other than the control user interface is being displayed, without changing the level of immersion at which the control user interface is being displayed. In some embodiments, were the computer system to detect the request to display the control user interface while the computer system is not displaying other virtual content, the computer system would optionally display the control user interface without displaying other virtual content in response to detecting the input.

In some embodiments, while displaying the control user interface, the computer system detects and responds to input directed to the control user interface, such as described below. For example, while displaying the control user interface, were the computer system to detect an input directed a first control of the immersive environment control user interface element, such as the immersion control element 722a in FIG. 7C, the computer system would optionally modify the aspect of the computer system that corresponds to that first control of the immersive environment control user interface element, such as the change in the level of immersion of the immersive environment 705 illustrated from FIG. 7C to FIG. 7D based on input directed to the immersion control element 722a in FIG. 7C. Continuing with this example, while displaying the control user interface, were the computer system to detect an input directed a first system control of the plurality of system controls, such as the play/pause control 718b in FIG. 7C, the computer system would optionally modify the aspect of the computer system that corresponds to that first system control, such as the pausing of the media “Song 1” indicated by the play/pause control 718b from FIG. 7C to FIG. 7G.

In some embodiments, the immersive environment control user interface element includes an immersion control element (e.g., a dial, slider, button, or another type of selectable element) for controlling a level of immersion of the immersive environment of the computer system, such as the immersion control element 722a in FIG. 7C. For example, the immersion control is optionally selectable to modify the current level of immersion of the immersive environment of the computer system. In some embodiments, the immersive environment is a three-dimensional environment, such as a three-dimensional environment described herein. In some embodiments, the computer system displays the immersive environment as part of a three-dimensional environment. In some embodiments, the immersive environment is displayed at a level of immersion (e.g., in accordance with a level of immersion for the immersive environment), such as described herein with reference to a level of immersion of virtual content and/or a virtual environment. In some embodiments, while displaying a first immersive environment of the computer system at a first level of immersion, such as the illustrated immersive environment 705 at the illustrated level of immersion in FIG. 7C, and while displaying the control user interface of the computer system, including the immersive environment control user interface element, including the immersion control element, the computer system detects, via the one or more input devices, an input directed to the immersion control element, such as the attention 714 (e.g., based on gaze) of the user 702 directed to the immersion control element 722a and movement of the hand 702a while the hand 702a is performing an air pinch gesture (e.g., the thumb and index finger of the hand of the user are in contact) in FIG. 7C, where the input corresponds to a request to change a level of immersion of the first immersive environment from the first level of immersion to a second level of immersion that is different from the first level of immersion. In some embodiments, the input directed to the immersion control element includes attention (e.g., based on gaze) of the user directed to the immersion control element and movement of a hand of the user while the hand of the user is performing an air pinch gesture (e.g., the thumb and index finger of the hand of the user are in contact). In some embodiments, the input directed to the immersion control element includes touch inputs detected on a touch-sensitive surface (e.g., a touch screen), a user pressing down on a control element on a mouse (e.g., a left-click), and/or is a gaze input without including other inputs such as an air gesture.

In some embodiments, in response to detecting the input directed to the immersion control element, the computer system changes the level of immersion of the first immersive environment from the first level of immersion to the second level of immersion in accordance with the input directed to the immersion control element, such as the change in the level of immersion of the immersive environment 705 illustrated from FIG. 7C to FIG. 7D. In some embodiments, a magnitude and/or direction of the change of immersion level is based on a magnitude and/or direction associated with the input directed to the immersion control element (e.g., of the hand movement of the user). For example, were a first amount of movement in a first direction associated with the input, the computer system would optionally change the level of immersion by a first amount in a first direction of change of immersion level. Continuing with this example, were a second amount of movement, different from the first amount of movement, in the first direction associated with the input, the computer system would optionally change the level of immersion by a second amount in the first direction of change of immersion level. In some embodiments, were the movement associated with the input to be movement in a first direction, the computer system would optionally change the level of immersion in the first direction of change of immersion level. In some embodiments, were the movement associated with the input to be movement in a second direction, different from the first direction, the computer system would optionally change the level of immersion in a second direction of change of immersion level that is different from the first direction of change of immersion level. In some embodiments, the second level of immersion is greater than the first level of immersion, so the computer system increases the level of immersion in response to the input. In some embodiments, the second level of immersion is less than the first level of immersion, so the computer system decreases the level of immersion in response to the input.

In some embodiments, the immersive environment control user interface element includes an immersive environment volume control element (e.g., a slider, a dial, a toggle, a segmented control, or another type of control element) for controlling a volume level of the immersive environment of the computer system, such as the immersive environment volume control element 722b in FIG. 7C. In some embodiments, the immersive environment volume control element indicates a current volume level of audio associated with the immersive environment. In some embodiments, the computer system presents the one or more audio components of the immersive environment (e.g., via an audio output device such as speakers, headphones, and/or earbuds). In some embodiments, the audio of the immersive environment is a looping, randomly (or pseudo-randomly) presented, and/or intermittently presented audio track. In some embodiments, the audio of the immersive environment is based on the physical location to which the immersive environment corresponds. For example, the physical location corresponding to the immersive environment may include sounds of a river flowing, waves crashing, animals crying out, vehicles moving, wind blowing, a fireplace crackling, and/or the like. In some embodiments, the computer system plays the sounds as though the sounds were emanating from one or more specific positions/locations and/or regions within the immersive environment (e.g., presents the sounds as spatial audio). In some embodiments, the computer system presents (e.g., generates) audio associated with the immersive environment as spatial audio or as non-spatialized audio (e.g., the audio presented at a specific level of immersion of the immersive environment is constant independent of a viewpoint of the user while the immersive environment is at the specific level of immersion). In some embodiments, the spatial audio is presented at a particular volume level (e.g., is presented at 0% volume relative to the three-dimensional environment (e.g., is not presented)), is presented at 100% volume relative to the three-dimensional environment (e.g., a maximum volume of audio) and/or is presented at a volume level intermediate to 0% or 100%. In some embodiments, the computer system changes the one or more characteristics (e.g., time delay and/or amplitude) of one or more channels of audio included in the spatial audio of the immersive environment in response to detecting a change in viewpoint of the user (e.g., along a three-dimensional coordinate system mapping the three-dimensional environment of the user). In some embodiments, the changes to the one or more characteristics simulate the sensation of the user's viewpoint changing relative to a physical equivalent of the first sound source. In some embodiments, while displaying a first immersive environment of the computer system, while presenting audio associated with the first immersive environment at a first volume level, and while displaying the control user interface of the computer system including the immersive environment volume control element displayed in the immersive environment control user interface element, the computer system detects, via the one or more input devices, an input directed to the immersive environment volume control element, wherein the input corresponds to a request to change a volume level of the first immersive environment from the first volume level to a second volume level that is different from the first volume level, such as the attention 714 (e.g., based on gaze) of the user 702 directed to the immersive environment volume control element 722b and movement of the hand 702a while the hand 702a is performing an air pinch gesture (e.g., the thumb and index finger of the hand of the user are in contact) in FIG. 7C. In some embodiments, the input directed to the volume control element includes a first part including attention (e.g., based on gaze) of the user directed to the volume control element while a hand of the user is performing an air pinch gesture (e.g., the thumb and index finger of the hand of the user coming into contact), and a second part including movement of the hand of the user while it is in the air pinch gesture (e.g., while the thumb and index finger are in contact). In some embodiments, the input directed to the volume control element includes attention (e.g., based on gaze) of the user directed to the volume control element optionally while a hand of the user is performing an air pinch gesture (e.g., the thumb and index finger of the hand of the user coming into contact and then the release thereof). In some embodiments, the input directed to the volume control element includes attention (e.g., based on gaze) of the user directed to the volume control element without including the hand of the user performing an air pinch gesture. In some embodiments, the input directed to the immersion control element includes touch inputs detected on a touch-sensitive surface (e.g., a touch screen), a user pressing down on a control element on a mouse (e.g., a left-click), and/or is a gaze input without including other inputs such as an air gesture.

In some embodiments, in response to detecting the input directed to the immersive environment volume control element, the computer system changes the volume level of the first immersive environment from the first volume level to the second volume level in accordance with the input directed to the immersive environment volume control element, such as the change in the volume level of the immersive environment 705 illustrated from FIG. 7C to FIG. 7G. In some embodiments, changing the immersive environment level does not change an overall system volume level or the volume level(s) of other application(s) running or content playing at the computer system. In some embodiments, when the input includes an air pinch gesture that includes movement of a hand of the user, a direction of the volume change is based on a direction of the movement of the hand of the user while it is in the air pinch gesture. For example, if the direction of the movement is a first direction, the direction of the volume change is optionally a first respective direction of volume change (e.g., an increase or decrease in volume). Continuing with this example, if the direction of the movement is a second direction that is different from the first direction, the direction of the volume change is optionally a second respective direction of volume change (e.g., an increase or decrease in volume) that is different from the first respective direction of volume change. In some embodiments, a magnitude of the volume change is based on a magnitude of the movement of the hand of the user while it is in the air pinch position. For example, if the amount of the movement is a first amount of movement, the magnitude of the volume change is optionally a first respective magnitude of volume change. Continuing with this example, if the amount of the movement is a second amount of movement that is different from the first amount of movement, the magnitude of the volume change is optionally a second respective magnitude of volume change that is different from the first respective magnitude of volume change. In some embodiments, the second volume level is greater than the first volume level, so the computer system increases the volume level in response to the input. In some embodiments, the second volume level is less than the first volume level, so the computer system decreases the volume level in response to the input. In some embodiments, changing the volume level of the immersive environment includes adding or removing audio components from the presented audio of the immersive environment. For example, when the volume level of the immersive environment is reduced, the computer system optionally additionally or alternatively reduces a number of audio components from the presented audio of the immersive environment (e.g., the computer system presents less audio components of the immersive environment at the second volume level than a number of audio components that were presented when the audio of the immersive environment was being presented at the first volume level). Continuing with this example, when the volume level of the immersive environment is increased, the computer system optionally additionally or alternatively increases a number of audio components in the presented audio of the immersive environment (e.g., the computer system adds to the presented audio of the immersive environment audio components that were not previously presented when the audio of the immersive environment was being presented at the first volume level).

In some embodiments, the immersive environment control user interface element includes a time of day control element (e.g., a slider, a dial, a toggle, a segmented control, or another type of control element) for changing a time of day setting of the immersive environment of the computer system, such as the time of day control element 722c in FIG. 7C. In some embodiments, the time of day control element indicates a currently selected time of day setting of the immersive environment.

In some embodiments, while displaying a first immersive environment of the computer system with the time of day setting of the first immersive environment having a first value, and while displaying the control user interface of the computer system, including the immersive environment control user interface element, including the time of day control element, the computer system detects, via the one or more input devices, one or more inputs including an input directed to the time of day control element, such as the attention 714 (e.g., based on gaze) of the user 702 directed to the time of day control element 722c while the hand 702a performs an air pinch gesture (e.g., the thumb and index finger of the hand of the user coming into contact with each other and then the release thereof), where the one or more inputs correspond to a request to change the time of day setting of the first immersive environment from having the first value to having a second value that is different from the first value. in some embodiments, immersive environments of the computer system are displayed with time of day settings having different values. For example, different times of day settings of an immersive environment optionally correspond to different simulated times of day in the immersive environment (e.g., daytime, nighttime, afternoon, sunset, dawn, hour by hour). For example, when the time of day setting has a first value, the immersive environment is optionally displayed with features including a first brightness, a first color, and/or a first amount of virtual objects (e.g., dew or no dew on a ground of the first immersive environment or sunshine or no sunshine displayed by the displays), and when the time of day setting has a second value that is different from the first value, the computer system optionally displays the immersive environment with features including a second brightness, a second color, and/or a second amount of virtual objects that is different from the first brightness, first color, and/or first amount of virtual objects. In some embodiments, the input directed to the time of day setting includes attention (e.g., based on gaze) of the user directed to the time of day control element while a hand of the user is performing an air pinch gesture. In some embodiments, in response to selecting the time of day control element, the computer system displays a platter including user interface elements that are selectable to set the current time of day setting of the immersive environment. In some embodiments, the user interface elements include a first user interface element that is selectable to set the environment time of day setting to the first value (e.g., a light, dark, or automatic lighting setting that is based on a least a current time of day at the location of the computer system), a second user interface element that is selectable to set the environment time of day setting to a second value (e.g., light, dark, or automatic lighting setting that is based on a least a current time of day at the location of the computer system), different from the first value, and a third user interface element that is selectable to set the environment time of day setting to a third value (e.g., light, dark, or automatic lighting setting that is based on a least a current time of day at the location of the computer system). In some embodiments, the first user interface element visually indicates a preview of the immersive environment with the time of day setting set to the first value, the second user interface element visually indicates a preview of the immersive environment with the time of day setting set to the second value, and the third user interface element visually indicates a preview of the immersive environment with the time of day setting set to the third value.

In some embodiments, in response to detecting the one or more inputs, the computer system changes the time of day setting of the first virtual environment from having the first value to having the second value, including displaying, via the one or more display generation components, the first immersive environment with the time of day setting of the first immersive environment having the second value, such as the time of day setting of the immersive environment 705 changing from the light lighting setting illustrated in FIG. 7C to the dark lighting setting illustrated in FIG. 7E. Were the one or more inputs to correspond to a request to change the time of day setting of the first immersive environment from having the first value to having a value that is different from the second value, the computer system would optionally change the time of day setting of the first virtual environment from having the first value to having the value that is different from the second value, including displaying, via the one or more display generation components, the first immersive environment with the time of day setting of the first immersive environment having the value that is different from the second value. As such, the computer system optionally detects and responds to input directed to the control user interface for changing the time of day setting of the immersive environment. For example, the time of day setting of the immersive environment having the first value (e.g., a light lighting setting) is optionally the immersive environment at 10:00 AM and the time of day setting of the immersive environment having the second value (e.g., a dark lighting setting) is optionally the immersive environment at 9:00 PM, and in response to detecting the input for changing the time of day setting of the immersive environment from the first value to the second value, the computer system optionally updates display of the immersive environment to have the time of day setting set to the dark lighting setting.

In some embodiments, the immersive environment control user interface element includes a first control element (e.g., a virtual button, a slider, a dial, a toggle, a segmented control, or another type of control element) for changing the immersive environment of the computer system, such as the control element 722d in FIG. 7C. In some embodiments, while displaying a first immersive environment of the computer system, and while displaying the control user interface of the computer system, including the immersive environment control user interface element, including the first control element, the computer system detects, via the one or more input devices, one or more inputs including an input directed to the first control element, wherein the one or more inputs correspond to a request to change the immersive environment of the computer system from the first immersive environment to a second immersive environment that is different from the first immersive environment, such as the attention 714 (e.g., based on gaze) of the user 702 directed to the control element 722d while the hand 702a performs an air pinch gesture (e.g., the thumb and index finger of the hand of the user coming into contact with each other and then the release thereof) in FIG. 7C. In some embodiments, the input directed to the first control element includes attention (e.g., based on gaze) of the user directed to the first control element while a hand of the user is performing an air pinch gesture (e.g., the thumb and index finger of the hand of the user coming into contact and then the release thereof). In some embodiments, in response to the input directed to the first control element, the first computer system displays one or more selectable options for changing the currently selected immersive environment of the computer system (or for viewing different immersive environments of the computer system). In some embodiments, the one or more selectable options are displayed in a user interface element that includes a plurality of selectable options corresponding to respective immersive environments of the computer system. In some embodiments, the selectable options include a first selectable option and a second selectable option, optionally in addition to other selectable options. In some embodiments, the first selectable option is selectable to set the currently selected immersive environment to the first immersive environment and includes a visual representation (e.g., a preview) of the first immersive environment. For example, were the first selectable option to correspond to an immersive environment corresponding to a California beach, the preview would optionally include a pictorial or iconic preview of the California beach. Likewise, in some embodiments, the second selectable option is selectable to set the currently selected immersive environment to the second immersive environment and includes a visual representation (e.g., a preview) of the second immersive environment. For example, were the second selectable option to correspond to an immersive environment corresponding to a creek in Texas, the preview would optionally include a pictorial or iconic preview of the creek in Texas. In some embodiments, the computer system detects an input directed to a selectable option, such as directed to the first selectable option or to the second selectable option, and in response to detecting the input, the computer system optionally performs an operation corresponding to selection of the selectable option. For example, in response to detecting an input directed to the first selectable option, the computer system optionally changes the currently selected immersive environment be the first immersive environment. Likewise, in response to detecting an input directed to the second selectable option, the computer system optionally changes the currently selected immersive environment to be second immersive environment. In some embodiments, in response to detecting the one or more inputs, the computer system displays, via the one or more display generation components, the second immersive environment of the computer system (e.g., such as described above with reference to changing the currently selected immersive environment to be the second immersive environment), such as the second immersive environment 705a in FIG. 7F. In some embodiments, in response to detecting the one or more inputs, the computer system ceases displaying the first immersive environment of the computer system. Additionally or alternatively, were the one or more input to correspond to a request to change the immersive environment of the computer system from the first immersive environment to a third immersive environment that is different from the second immersive environment, the computer system would optionally display the third immersive environment of the computer system in response. In some embodiments, provided that the volume level of the selected immersive environment is set to a volume level that is greater than no volume, the computer system presents the audio that corresponds to the second immersive environment in response to detecting the one or more inputs as well.

In some embodiments, the immersive environment control user interface element includes a visual representation of the immersive environment of the computer system designated as being in use, such as the visual representation 722e of the immersive environment 705 in FIG. 7C. In some embodiments, the visual representation of the currently selected immersive environment is an iconic or pictorial representation of the currently selected immersive environment. In some embodiments, in accordance with a determination that the immersive environment of the computer system is a first immersive environment, such as the immersive environment 705 in FIG. 7C, the immersive environment control user interface element includes a visual representation of the first immersive environment designated as being in use, such as the visual representation 722e of the immersive environment 705 in FIG. 7C. In some embodiments, in accordance with a determination that the immersive environment of the computer system is a second immersive environment that is different from the first immersive environment, such as the second immersive environment 705a in FIG. 7F, the immersive environment control user interface element includes a visual representation of the second immersive environment designated as being in use, such as the visual representation 722e of the second immersive environment 705a in FIG. 7F, without including the visual representation of the first immersive environment, wherein the visual representation of the second immersive environment is different from the visual representation of the first immersive environment. For example, were the currently selected immersive environment an immersive environment corresponding to a California beach, the preview would optionally include a pictorial or iconic preview of the California beach. Continuing with this example, were the currently selected immersive environment an immersive environment corresponding to a creek in Texas, the preview would optionally include a pictorial or iconic preview of the creek in Texas. Thus, the computer system would display a different visual representation provided that selected the immersive environment is different so that the currently selected immersive environment is clearly indicated even if the currently selected immersive environment is not currently visible in the viewpoint of the user (optionally because the level of immersion of the currently selected immersive environment is set to a minimum). Additionally, in some embodiments, the visual representation corresponds to the time of day setting of the immersive environment described above. For example, were the time of day setting of the immersive environment set to the light lighting setting (e.g., daytime), the visual representation would optionally show the selected immersive environment at daytime (at the location that corresponds to the selected immersive environment); were the time of day setting set to the dark lighting setting, the visual representation would optionally show the selected virtual environment at night (at the location that corresponds to the selected immersive environment); were the time of day setting of the immersive environment set to the automatic setting (where the time of day setting is set to the current time at the computer system), the visual representation would optionally show the selected immersive environment at night, day, or another time that corresponds to the current time of day at the computer system. As such, the computer system optionally displays a visual representation of the selected immersive environment in the immersive environment control user interface element of the control user interface.

In some embodiments, the visual representation of the immersive environment of the computer system designated as being in use is displayed with a first amount of depth visual effect (e.g., a first amount of parallax, stereo, a three-dimensional mesh, or another type of depth visual effect), and the first amount of depth visual effect is a nonzero depth visual effect. For example, the computer system displays the visual representation 722e of the immersive environment 705 in FIG. 7C with a stereo visual effect. In some embodiments, the visual representation of the currently selected immersive environment is a two-dimensional or three-dimensional representation of the currently selected immersive environment. In some embodiments, the computer system displays the visual representation of the currently selected immersive environment with the first amount of depth visual effect optionally to causes the visual elements of the visual representation to appear at different depths relative to the viewpoint of the user).

In some embodiments, while displaying the immersive environment of the computer system, and while displaying the control user interface of the computer system, including the immersive environment control user interface element and the visual representation of the immersive environment designated as being in use, the computer system detects, via the one or more input devices, an input directed to the visual representation of the immersive environment designated as being in use, such as the attention 714 (e.g., based on gaze) of the user 702 directed to the visual representation 722e while the hand 702a performs an air pinch gesture (e.g., the thumb and index finger of the hand of the user coming into contact with each other and then the release thereof) in FIG. 7C. In some embodiments, the input includes attention (e.g., based on gaze) of the user directed to the visual representation while a hand of the user is performing an air pinch gesture (e.g., the thumb and index finger of the hand of the user coming into contact and then the release thereof). In some embodiments, in response to detecting the input directed to the visual representation of the immersive environment designated as being in use, the computer system updates display of the immersive environment control user interface element to include first information (e.g., geographic information) about a physical location corresponding to the immersive environment, such as the immersive environment control user interface element 716c in FIG. 7N. In some embodiments, the first information includes elevation information (e.g., how high the physical location that corresponds to the immersive environment is above sea level), distance information (e.g., how far the physical location is from one or more landmarks of the physical location), map information (e.g., a map-view, such as a top-down view of the physical location), and/or other information of the physical location that corresponds to the currently selected immersive environment. As such, the computer system optionally detects and responds to input directed to the visual representation by displaying additional information about the physical location that corresponds to the currently selected immersive environment. In some embodiments, if the input is detected while the currently selected immersive environment of the computer system is a first immersive environment, the first information is information about the first immersive environment. In some embodiments, if the input is detected while the currently selected immersive environment of the computer system is a second immersive environment, different from the first immersive environment, the first information is information about the second immersive environment.

In some embodiments, the immersive environment control user interface element is configured to control the one or more environment parameters of the immersive environment of the computer system in accordance with a determination that the request to display the control user interface of the computer system is detected while not displaying respective content of a respective application (e.g., a movie application, a game application, a presentation application or another type of application) in an immersive mode (e.g., a full screen mode and/or a mode in which the respective content of the respective application surrounds (e.g., at least partially surrounds) a position corresponding to the viewpoint of the user of the computer system) of the respective application at the first level of immersion. For example, the computer system 101 displays the immersive environment control user interface element 716c including controls for controlling environment parameters of the immersive environment 705 in FIG. 7C because the input of FIG. 7X is detected while the computer system 101 is not displaying content of an application in an immersive mode of the application. In some embodiments, the content of the application can be displayed in a non-immersive mode or in an immersive mode, such as described below. In some embodiments, in accordance with a determination that the input corresponding to the request to display the control user interface of the computer system is detected while displaying the respective content of the respective application in the immersion mode of the respective application, the immersive environment control user interface element is configured to control one or more environment parameters of the application, without being configured to control the one or more environment parameters of the immersive environment of the computer system. For example, the computer system 101 displays the immersive environment control user interface element 716c including controls for controlling environmental parameters of the presentation environment 744 and not for controlling environmental parameters of the immersive environment 705 because the input of FIG. 7W is detected while the computer system is displaying content of an application in an immersive mode of the application (e.g., the presentation application is being displayed in the immersive mode in FIG. 7X). In some embodiments, the computer system displays content of applications. In some embodiments, an application may be displayed in an immersive mode. In some embodiments, when the application is displayed in the immersive mode, the content of the application is displayed at a level of immersion, such as described with reference to the immersive environment of the computer system being displayed at a level of immersion, but the content of the application being the immersive environment (e.g., the user of the computer system is immersed in an immersive environment of the application (e.g., rather than in an immersive environment of the computer system)), and provided that the input for displaying the control user interface of the computer system is detected while the computer system is displaying the application in the immersive mode, the controls of the immersive environment control user interface element are controls that correspond to the application (e.g., and are optionally analogous to or the same as the environment parameters of the immersive environment described above). For example, the controls optionally includes an immersion level control element for controlling a level of immersion of the immersive environment of the application, a minimize control element for changing the mode of the application from the immersive mode to another mode that is not immersive (e.g., a two-dimensional display of the content of the application rather than a three-dimensional display of the content of the application, and/or other controls that are specific to the application). Thus, in some embodiments, the features of the immersive environment control user interface element of the control user interface of the computer system are dynamic based on whether the user is currently immersed in an immersive environment of an application or immersed in an immersive environment of the computer system.

In some embodiments, the plurality of system controls displayed concurrently with the immersive environment control user interface element include one or more media playback controls (e.g., a rewind control, pause control, play control, fast-forward control, a content playback position control, a volume control, and/or other media playback controls), such as the rewind control 718a, play/pause control 718b, a fast-forward control 718c, and a playback position indicator/control 718d, in the media control user interface element 716a in FIG. 7C. In some embodiments, the computer system displays the one or more media playback controls in a media playback control user interface element (e.g., a movie or music playback control user interface element). In some embodiments, the computer system detects and responds to input(s) directed to the playback controls (e.g., the hand of the user performing an air pinch gesture while attention (e.g., based on gaze) of the user is directed to the playback controls (e.g., directed to a specific playback control)). For example, were the computer system to detect an input (e.g., the hand of the user performing an air pinch gesture while attention (e.g., based on gaze) of the user is directed to the playback controls (e.g., directed to a specific playback control) and then the hand of the user moving while it is still in the pinch pose) directed to a content playback position control, the computer system would optionally scrub the content in accordance with the input (e.g., by a magnitude and in a direction that corresponds to the input). As such, a user may easily access media playback controls via the control user interface to modify an aspect of playback of media.

In some embodiments, the plurality of system controls displayed concurrently with the immersive environment control user interface element include a system volume control element (e.g., a virtual button, a slider, a dial, a toggle, a segmented control, and/or another type of control element), such as the volume icon 716e-2 of the system volume control element 716e of the control user interface 716 in FIG. 7C. In some embodiments, the system volume control element is as described with reference to method 1000. In some embodiments, the system volume control element is a system volume control element for controlling a volume level of the computer system (e.g., a total or overall volume level of the computer system (e.g., including immersive environment volume, volume(s) of application(s), operating system volume, and/or other systems that have corresponding audio components). In some embodiments, the system volume control element indicates a current system volume level of the computer system. In some embodiments, the computer system detects and responds to input directed to the system volume control element by changing the current system volume level in accordance with the input (e.g., by a magnitude and in a direction that corresponds to the input). In some embodiments, in response to the input for displaying the control user interface, the computer system displays the system volume control element and/or other volume control element(s) for controlling volume level(s) of different application(s) running on and/or displayed via the computer system. The other volume control element(s) are described below with reference to the volume control user interface. In some embodiments, in response to the input for displaying the control user interface, the computer system displays a volume slider for controlling a volume level of the computer system and a volume icon. In some embodiments, the volume slider and/or the volume icon comprises the system volume control element. In some embodiments, the system volume control element is selectable as described below.

In some embodiments, while displaying the control user interface of the computer system including the system volume control element, the computer system detects, via the one or more input devices, an input directed to the system volume control element, such as the attention 714 (e.g., based on gaze) of the user 702 directed to the volume icon 716e-2 while the hand 702a performs an air pinch gesture (e.g., the thumb and index finger of the hand of the user coming into contact with each other and then the release thereof) in FIG. 7C, where the input directed to the system volume control element corresponds to a request to expand the system volume control element. In some embodiments, the input directed to the system volume control element is as described with reference to first input directed to the system volume control element corresponding to a request to expand the system volume control element in method 1000. For example, the input directed to the system volume control element includes a hand of the user performing an air pinch gesture while attention (e.g., based on gaze) of the user directed is to the system volume control element. In some embodiments, the computer system detects a different input directed to the volume element for changing a volume level of the computer system, and such features are described in more detail with reference to method 1000.

In some embodiments, in response to detecting the input directed to the system volume control element, the computer system displays, via the one or more display generation components, a volume control user interface (e.g., an expanded system volume control element such as described with reference to method 1000), such as the audio management panel 726 in FIG. 7H, that includes a first volume control (e.g., a virtual button, a slider, a dial, a toggle, a segmented control, or another type of control element) for controlling a volume level of a first application (e.g., a music application, game application, maps application, social media application, or another application). In some embodiments, the first volume control indicates a current volume level of the first application. For example, were a first application in use on the computer system, the audio management panel 726 in FIG. 7H would optionally include a first volume slider, such as the volume slider 726b in FIG. 7H, for controlling a volume level of the first application. In some embodiments, the volume control user interface also includes a second volume control (e.g., a virtual button, a slider, a dial, a toggle, a segmented control, or another type of control element) for controlling a volume level of a second application (e.g., a music application, game application, maps application, social media application, or another application) different from the first application. For example, were a second application in use on the computer system, the audio management panel 726 in FIG. 7H would include a second volume slider, such as the volume slider 726b in FIG. 7H, for controlling a volume level of the second application. In some embodiments, the second volume control indicates a current volume level of the second application. In some embodiments, the volume control user interface is as described with reference to the volume control user interface described with reference to method 1000. In some embodiments, the volume control user interface includes another volume control (e.g., a third volume control) for controlling a volume level of the computer system (e.g., a total or overall volume level of the computer system). In some embodiments, the number of volume controls that the computer system displays in the volume control user interface is based on a number of applications that are currently running on and/or displayed via the computer system and that are associated with audio components. For example, if a first number of applications are currently running on the computer system, then the computer system optionally displays a first respective number of volume controls for controlling the respective audio levels the applications in the first number of applications. Continuing with this example, if a second number of applications, different from the first number of applications, are currently running on the computer system and are associated with audio components, then the computer system optionally displays a second respective number of volume controls, different from the first number of volume controls, for controlling the respective audio levels of the applications in the second number of applications. In some embodiments, while displaying the volume control user interface, and while a volume level of a first application is at a first volume level, the computer system detects, via the one or more input devices, an input directed to the first volume control, wherein the input directed to the first volume control corresponds to a request to change the volume level of the first application from the first volume level to a second volume level that is different from the first volume level. For example, when a first application in use on the computer system 101, the audio management panel 726 in FIG. 7H would include a first volume slider, such as the volume slider 726b in FIG. 7H, for controlling a volume level of the first application. Continuing with this example, the computer system 101 detects attention 714 (e.g., based on gaze) of the user 702 directed to the first volume slider and movement of the hand 702a while the hand 702a is performing an air pinch gesture (e.g., the thumb and index finger of the hand of the user are in contact). In some embodiments, the input directed to the first volume control is as described with reference to second input directed to the first volume control corresponding to a request to modify the volume level of the first application to a respective volume level described with reference to method 1000. In some embodiments, the input directed to the first volume control includes a hand of the user of the computer system performing an air pinch gesture while attention of the user is directed to the first volume control. In some embodiments, when the input includes an air pinch gesture that includes movement of a hand of the user, a magnitude and direction of audio change is based on a magnitude and direction of the movement of the hand while it is in the pinch pose. For example, if the amount of movement of the hand in a first direction is a first amount, the computer system optionally changes the volume by a first amount. Continuing with this example, if the amount of movement of the hand in the first direction is a second amount, different from the first amount, the computer system optionally changes the volume by a second amount. Further, were the movement of the hand of the user to be in a first direction, the computer system would optionally change the volume in first direction of volume change (e.g., increase or decrease in volume). Continuing with this example, were the movement of the hand of the user to be in a second direction, different from the first direction, the computer system would optionally change the volume in a second direction of volume change (e.g., increase or decrease in volume) that is different from the first direction of volume change. In some embodiments, in response to detecting the input directed to the first volume control, the computer system changes the volume level of the first application from the first volume level to the second volume level (e.g., such as described above). For example, the computer system 101 changes the volume level of the first application described above in accordance with the input directed to the first volume slider described above. In some embodiments, were the input associated with a different magnitude and/or direction of requested volume change, the computer system would change the volume level of the first application to a third volume level that is different from the second volume level. In some embodiments, in response to detecting the input directed to the first volume control, the computer system changes the volume level of the first application without changing a volume level of the second application and/or without changing a volume level of audio associated with an immersive environment of the system. As such, the computer system optionally changes the volume level of the first application in accordance with the input directed to the first volume control as described above. In some embodiments, were the computer system to detect input directed to the second volume control, the computer system would optionally change the volume level of the second application in accordance with the input directed to the second volume control.

In some embodiments, the plurality of system controls includes a first system control element (e.g., a virtual button, a slider, a dial, a toggle, a segmented control, or another type of control element) for controlling a first system function of the computer system, such as the viewing mirroring control element 720g in FIG. 7C, and a second system control element (e.g., a virtual button, a slider, a dial, a toggle, a segmented control, or another type of control element), different from the first system control element, for controlling a second system function the computer system that is different from the first system function of the computer system, such as the virtual display control element 720e in FIG. 7C. In some embodiments, the computer system displays the first system control element and the second system control element in a system control user interface element (e.g., a system level control user interface element or a connectivity control user interface element) that is configured to control one or more system controls of the computer system. In some embodiments, the computer system concurrently displays the immersive environment control user interface element and the system control user interface element.

In some embodiments, the plurality of system controls includes a viewing mirroring control element for controlling establishment of a connection between the computer system and a second computer system for mirroring the displays of the computer system to a second computer system (e.g., a phone, a tablet, computer, laptop, television, or another computer system) and/or for mirroring the displays of the second computer system to the computer system, such as the virtual display control element 720e in FIG. 7C. In some embodiments, in response to selection of the view mirroring control element, the computer system displays an option for establishing the connection between the computer system and the second computer system. In some embodiments, in response to selection of the option, the computer system establishes the connection between the computer system and the second computer system and initiates the mirroring operation.

In some embodiments, the plurality of system controls includes a guest mode control element for controlling operation of the computer system in a guest mode, such as the guest mode control element 720i in FIG. 7C. In some embodiments, the guest feature enables a user or owner of the computer system to configure permissions (e.g., access and restriction) to applications on the computer system that a guest user of the computer system can use. In some embodiments, in response to selection of the guest mode control element, the computer system displays options for granting or denying access to particular applications on the computer system in the guest mode and an option to begin operating the computer system in the guest mode.

In some embodiments, the plurality of system controls includes a focus mode control element for controlling operation of the computer system in a focus mode, such as the focus mode control element 720h in FIG. 7C. In some embodiments, when the computer system is not in a focus mode, the computer system presents one or more notifications from one or more applications. In some embodiments, when the computer system is in a focus mode, the computer system forgoes presenting (e.g., forgoes displaying and/or generating audio corresponding to) one or more notifications from one or more applications. In some embodiments, when the computer system is in the focus mode, the computer system forgoes presenting one or more notification from one or more applications in a first manner while presenting one or more notification from one or more other applications in the first manner. In some embodiments, when the computer system is in the focus mode, the computer system forgoes presenting all notifications or forgoes presenting some notification with some exceptions (e.g., notifications from certain contacts and/or certain applications, such as emergency notifications may be presented while the computer system is in the focus mode). In some embodiments, in response to selection of the focus mode control element, the computer system displays options for operating the computer system in different focus modes. In some embodiments, in response to detecting selection of an option for operating the computer system in a first focus mode, the computer system enters the first focus mode and operates accordingly.

In some embodiments, the plurality of system controls includes a screen recording control for capturing one or more images (e.g., a still image or a video) of the viewpoint of the user of the computer system, such as the screen recording control 720f in FIG. 7C. In some embodiments, the computer system detects one or more inputs, including an input directed to the screen recording control, and in response, the computer system initiates recording of the viewpoint of the user of the computer system.

In some embodiments, the plurality of system controls includes accessibility controls for controlling aspects of the computer system related to accessibility features, such as the control user interface 716 in FIG. 7C including one or more accessibility controls, such as one or more of the plurality of accessibility controls described below. In some embodiments, the computer system detects one or more inputs, including an input directed to the accessibility control, and in response, the computer system displays a plurality of accessibility controls. In some embodiments, the plurality of accessibility controls includes vision-related controls, physical and motor related controls, hearing controls, and learning controls, and/or other accessibility controls.

In some embodiments, the plurality of system controls includes wireless connectivity controls, such as the Wi-Fi control element 720a in FIG. 7C. For example, the computer system optionally displays a first control element for controlling BLUETOOTH connectivity and a second control element for controlling Wi-Fi connectivity. Other wireless connectivity controls are contemplated and are within the scope of the present disclosure.

In some embodiments, the computer system is a first computer system, such as the computer system 101 in FIG. 7C, and the plurality of system controls includes a first control element (e.g., a virtual button, a slider, a dial, a toggle, a segmented control, or another type of control element) for controlling establishment of a connection between the first computer system and a second computer system that is different from the first computer system to use the one or more display generation components to display user interfaces of (e.g., content from) the second computer system, such as the virtual display control element 720e in FIG. 7C. In some embodiments, the first control element indicates whether a connection by the first computer system and another computer system is currently established. For example, when a connection between the first computer system and another computer system is currently established, the computer system optionally displays the first control element with a first set of visual characteristics having a first value (e.g., a first color, first brightness, and/or another visual characteristic having a first value). Continuing with this example, when a connection between the first computer system and another computer system is not established, the computer system optionally displays the first control element with the first set of visual characteristics having a second value that is different from the first value (e.g., a second color, second brightness, and/or another visual characteristic having a second value that is different from the first value). Further, when a connection between the first computer system and the second computer system is currently established, the first computer system optionally displays user interfaces of the second computer system via the one or more display generation components of the first computer system, and optionally can interact and/or control those user interfaces just as if the second computer system were displaying those user interfaces. In some embodiments, when the connection between the first computer system and the second computer system is currently established, the one or more display generation components of the first computer system display a virtual monitor for the second computer system in the three-dimensional environment of the first computer system. In some embodiments, the computer system detects, via the one or more input devices, one or more inputs including an input directed to the first control element. For example, the computer system 101 detects attention (e.g., based on gaze) of the user 702 directed to the virtual display control element 720e in FIG. 7C while the hand 702a performs an air pinch gesture (e.g., the thumb and index finger of the hand of the user coming into contact with each other and then the release thereof) in FIG. 7C. In some embodiments, the input directed to the first control element includes attention (e.g., based on gaze) of the user directed to the first control element while a hand of the user is performing an air pinch gesture (e.g., the thumb and index finger of the hand of the user coming into contact and then the release thereof). In some embodiments, in response to detecting the input, the computer system displays one or more options corresponding to one or more computer systems to which a connection can be established. In some embodiments, the one or more inputs includes an input directed to an option that corresponds to the second computer system. In some embodiments, in response to detecting the one or more inputs, the computer system modifies establishment of the connection between the first computer system and the second computer system in accordance with the one or more inputs. For example, the computer system 101 modifies the establishment of the connection between the computer system 101 and a second computer system in accordance with the one or more inputs described above. For example, the one or more inputs optionally correspond to a request to establish the connection between the first computer system and the second computer system, and in response to detecting the one or more inputs, the computer system optionally establishes the connection. As another example, the one or more inputs optionally correspond to a request to cease the connection between the first computer system and the second computer system, and in response to detecting the one of our inputs the computer system optionally cease the connection.

In some embodiments, the plurality of system controls includes a first control element (e.g., a virtual button, a slider, a dial, a toggle, a segmented control, or another type of control element) for controlling a spatial tracking mode of operation of the computer system, such as the spatial tracking mode control 720j in FIG. 7C. In some embodiments, the first control element indicates whether the computer system is currently operating in the spatial tracking mode. For example, when the computer system is operating in the spatial tracking mode, the computer system optionally displays the first control element with a first set of visual characteristics having a first value (e.g., a first color, first brightness, and/or another visual characteristic having a first value). Continuing with this example, when the computer system is not operating in the spatial tracking mode, the computer system optionally displays the first control element with the first set of visual characteristics having a second value that is different from the first value (e.g., a second color, second brightness, and/or another visual characteristic having a second value that is different from the first value). In some embodiments, the spatial tracking mode of operation of the computer system is for use when the user of the computer system is traveling (e.g., on an airplane, a train, a bus, or another type of vehicle). In some embodiments, the computer system maintains stability of content displayed by the computer system when operating the computer system in the spatial tracking mode of operation. For example, the computer system optionally utilizes sensors (e.g., motion tracking sensors, gyro sensors, and/or other types of sensors described herein) of the computer system to adapt presentation of the content to the motion and/or environment of the travel. In some embodiments, the computer system detects, via the one or more input devices, one or more inputs including an input directed to the first control element. For example, the computer system 101 optionally detects attention (e.g., based on gaze) of the user 702 directed to the spatial tracking mode control 720j in FIG. 7C while the hand 702a performs an air pinch gesture (e.g., the thumb and index finger of the hand of the user coming into contact with each other and then the release thereof) in FIG. 7C. In some embodiments, the input directed to the first control element includes attention (e.g., based on gaze) of the user directed to the first control element while a hand of the user is performing an air pinch gesture (e.g., the thumb and index finger of the hand of the user coming into contact and then the release thereof). In some embodiments, the input directed to the first control element includes attention (e.g., based on gaze) of the user directed to the first control element without including the hand of the user performing an air pinch gesture. In some embodiments, the input directed to the first control element includes touch inputs detected on a touch-sensitive surface (e.g., a touch screen), a user pressing down on a control element on a mouse (e.g., a left-click), and/or is a gaze input without including other inputs such as an air gesture. In some embodiments, in response to detecting the input, the computer system displays one or more options corresponding to different spatial tracking modes of operation of the computer system. In some embodiments, the one or more inputs includes an input directed to an option that corresponds to a spatial tracking mode of operation of the computer system. In some embodiments, in response to detecting the one or more inputs, the computer system updates a current spatial tracking mode of operation of the computer system in accordance with the one or more inputs. For example, the computer system 101 updates the current spatial tracking mode of operation of the computer system 101 in accordance with the one or more inputs described above. In some embodiments, when the input directed to the first control element is detected, the current mode of operation of the computer system is not the spatial tracking mode of operation (e.g., is not in a first spatial tracking mode), and in response to detecting the one or more inputs, the computer system enters the spatial tracking mode (e.g., enters the first spatial tracking mode). In some embodiments, when the input directed to the first control element is detected, the current mode of operation of the computer system is the spatial tracking mode of operation (e.g., is the first spatial tracking mode), and in response to detecting the one or more inputs, the computer system exits the spatial tracking mode (e.g., exits the first spatial tracking mode and enters a second spatial tracking mode that is different from the first spatial tracking mode).

In some embodiments, the plurality of system controls displayed concurrently with the immersive environment control user interface element include one or more application-specific controls configured to control one or more application functions of one or more applications on the computer system, such as the user interface element 716l of the control user interface 716 including the option 716l-1 for setting an alarm in a time/alarm application and an option 716l-2 for creating a note entry in a note application on the computer system 101 in FIG. 7Q. In some embodiments, the application-specific controls include a set of one or more controls for controlling gaming features of a gaming application on the computer system. In some embodiments, the first set of controls are configured by a developer of the gaming application. In some embodiments, the application-specific controls include a set of one or more controls for controlling functions related to a building or home (e.g., the second set of one or more controls are connected to an Internet-of-Things (IoT) system of the building or home (e.g., to smart devices of the building or home). In some embodiments, the computer system detects user inputs directed to the set of one or more controls, which causes operations of the smart devices to be initiated in response to the user inputs. In some embodiments, the application-specific controls include a set of one or more controls for accessing applications of the computer system via the control user interface (e.g., application shortcuts). For example, the set of controls for accessing applications of the computer system via the control user interface are optionally user-configurable. For example, the computer system can detect and respond to user input for setting controls for accessing applications of the computer system via the control user interface.

In some embodiments, displaying the control user interface of the computer system includes displaying in a first arrangement (e.g., a first position and/or orientation) relative to each other (e.g., displaying the user interface elements of the control user interface in a first relative order or a first relative positioning in the control user interface) a plurality of user interface elements including the immersive environment control user interface element, such as described herein, and a second control user interface element configured to control one or more parameters of a first system function of the plurality of system functions of the computer system, wherein the one or more parameters of the first system function are different from the one or more environment parameters of the computer system, such the order of the user interface elements 716a through 176d, which includes the media control user interface element 716a having a first position (e.g., a left most position of the order of the user interface elements 716a through 176d in the viewpoint of the user) and the immersive environment control user interface element 716c being two positions away from the first position (e.g., two positions rightward of the left most position) in FIG. 7K. In some embodiments, the second control user interface element is the media playback control user interface element described above, a control user interface element that includes the plurality of system controls described above (e.g., the connectivity user interface element), the notifications user interface element described below, or is another control user interface element. For example, when the immersive environment control user interface element and the second control user interface element are in the first arrangement, the immersive environment control user interface element and the second control user interface element are in a first relative order or a first relative positioning in the control user interface. For example, in the first arrangement, the immersive environment control user interface element and the second control user interface element are optionally adjacent to each other, or are separated by one or more other control user interface element (e.g., control user interface element platters) of the control user interface. In some embodiments, while displaying the control user interface of the computer system with the plurality of user interface elements in the first arrangement relative to each other in the viewpoint of the user of the computer system, the computer system detects, via the one or more input devices, one or more inputs, the one or more inputs corresponding to a request to change an arrangement of the plurality of the user interface elements from the first arrangement to a second arrangement (e.g., a second position and/or orientation) relative to each other that is different from the first arrangement. For example, the computer system 101 detects input directed to the control element 730c in FIG. 7K for moving the immersive environment control user interface element 716c to the first position described above. For example, the input directed to the control element 730c in FIG. 7K included attention 714 (e.g., based on gaze) of the user 702 directed at the control element 730c and movement of the hand 702a while the hand 702a is performing an air pinch gesture (e.g., the thumb and index finger of the hand of the user are in contact) corresponding to a request to move the immersive environment control user interface element 716c to the first position (described above) in the order of the user interface elements 716a through 716d in the control user interface 716 (e.g., to have the left most position of the order of the user interface elements 716a through 176d in the viewpoint of the user). In some embodiments, the control user interface includes a user interface element that is selectable to enter an editing mode for editing aspects of the control user interface, such as for re-arranging (e.g., re-ordering) the plurality of user interface elements of the control user interface. In some embodiments, the computer system detects and responds to an input directed to the user interface element. For example, the computer system optionally detects attention (e.g., based on gaze) of the user directed to the user interface element while a hand of the user is performing an air pinch gesture (e.g., the thumb and index finger of the hand of the user coming into contact and then the release thereof). Continuing with this example, in response to detecting the input, the computer system optionally displays the control user interface in the editing mode. In some embodiments, in the editing mode, the computer system can detect and respond to user input for re-arranging control user interface elements of the control user interface. For example, while in the editing mode, the computer system optionally detects inputs (e.g., drag and drop inputs, selections of displayed options, voice inputs, inputs detected via hardware components (e.g., buttons) of the computer system or of a remote that is in communication with the computer system) corresponding to a request to change the relative positioning of the immersive environment control user interface element and the second control user interface element in the control user interface. In some embodiments, in response to detecting the one or more inputs, the computer system displays, via the one or more input devices, the plurality of user interface elements in the second arrangement relative to each other (e.g., in a second relative order or a second relative positioning in the control user interface). For example, in response to detecting the input directed to the control element 730c in FIG. 7L (e.g., described above), the computer system 101 moves the immersive environment control user interface element 716c to the first position, as shown in FIG. 7L, in the order of the user interface elements 716a through 716d. For example, in the first arrangement, the immersive environment control user interface element and the second control user interface element are optionally adjacent to each other, and in the second arrangement, the immersive environment control user interface element and the second control user interface element are separated in order by one or more other control user interface element (e.g., control user interface element platters) of the control user interface. As such, the computer system optionally re-arranges (e.g., changes an order of) the control user interface elements of the control user interface in response to input for doing so, as described above. In some embodiments, in response to input for exiting the editing mode, the computer system exits the editing mode and displays the control user interface with the user interface elements of the control user interface in the second arrangement while not in the editing mode.

In some embodiments, displaying the control user interface of the computer system includes displaying a plurality of user interface elements including the immersive environment control user interface element, such as described herein, and one or more additional user interface elements configured to control one or more parameters of one or more system functions of the plurality of system functions of the computer system, wherein the one or more system functions are different from the one or more environment parameters of the computer system, such as the immersive environment control user interface element 716c and the media control user interface element 716a in FIG. 7K. In some embodiments, the one or more additional user interface elements is the media playback control user interface element described above, the notifications user interface element described below, and/or is another control user interface element, such as a control user interface element that includes the plurality of system controls (e.g., the connectivity user interface element described above). In some embodiments, while displaying the control user interface of the computer system including the plurality of user interface elements, the computer system detects, via the one or more input devices, one or more inputs, the one or more inputs corresponding to a request to update the plurality of user interface elements with respect to a first user interface element (e.g., a user interface element that includes one or more controls of one or more functions of the computer system or of another system or application or any other user interface element described with reference to method 800), such as the attention 714 (e.g., based on gaze) of the user 702 directed to the control element 734 in FIG. 7K while the hand 702a performs an air pinch gesture (e.g., the thumb and index finger of the hand of the user coming into contact with each other and then the release thereof). In some embodiments, the first user interface element is included in the control user interface when the one or more inputs are detected; in such embodiments, updating the plurality of user interface elements with respect to the first user interface element may correspond to a request to remove the first user interface element from the control user interface. In some embodiments, the first user interface element is not included in the control user interface when the one or more inputs are detected; in such embodiments, updating the plurality of user interface elements with respect to the first user interface element may correspond to a request to add the first user interface element to the control user interface. In some embodiments, the control user interface includes the user interface element that is selectable to enter the editing mode for editing aspects of the control user interface that is described above. In some embodiments, in the editing mode, the control user interface element can be added to or removed from the control user interface. That is, in some embodiments, in the editing mode, the computer system detects and responds to inputs requesting to add one or more additional control user interface elements to the control user interface or to remove one or more control user interface elements from the control user interface. As such, in some embodiments, while in the editing mode, the computer system detects inputs corresponding to requests to add or remove control user interface elements to or from the control user interface, respectively. In some embodiments, in response to detecting the one or more inputs, the computer system displays, via the one or more input devices, the plurality of user interface elements in accordance with the request to update the plurality of user interface elements with respect to the first user interface element. For example, from FIG. 7K to FIG. 7O, the user interface element 716l is added to the control user interface 716 in FIG. 7O in response to detecting the inputs described above (e.g., the input directed to the control element 734 in FIG. 7K and one or more inputs that specifically request that the user interface element 716l be added to the control user interface 716). For example, were the request to update the plurality of user interface elements with respect to the first user interface element to correspond to a request to add the first user interface element to the control user interface, the computer system would optionally display the control user interface including the first user interface element in response to detecting the one or more inputs. As another example, were the request to update the plurality of user interface elements with respect to the first user interface element to correspond to a request to remove the first user interface element from the control user interface, the computer system would optionally display the control user interface excluding the first user interface element from the control user interface in response to detecting the one or more inputs.

In some embodiments, the plurality of system controls displayed concurrently with the immersive environment control user interface element include a search user interface element (e.g., a virtual button, text entry field, a slider, a dial, a toggle, a segmented control, or another type of control element) that is selectable to display a search user interface, such as the search control user interface element 716f in FIG. 7C. In some embodiments, the search user interface includes a search entry field (e.g., a text box or another type of search entry field) for the user to input a query for searching in one or more search engines and, in response to detecting an input requesting to conduct a search based on the query, optionally includes visual indications of the search results. In some embodiments, while displaying the control user interface of the computer system including the search user interface element, detecting, via the one or more input devices, one or more inputs including an input directed to the search user interface element, such as the attention 714 (e.g., based on gaze) of the user 702 directed to the search control user interface element 716f while the hand 702a performs an air pinch gesture (e.g., the thumb and index finger of the hand of the user coming into contact with each other and then the release thereof) in FIG. 7C. In some embodiments, the input directed to the first user interface element includes attention (e.g., based on gaze) of the user directed to the first user interface element while a hand of the user is performing an air pinch gesture (e.g., the thumb and index finger of the hand of the user coming into contact and then the release thereof). In some embodiments, in response to detecting the one or more inputs, the computer system updates display, via one or more display generation components, of the control user interface of the computer system to include the search user interface, such as the search user interface 728 in FIG. 7J. In some embodiments, the computer system displays the search user interface in front of one or more elements of control user interface from the viewpoint of the user. In some embodiments, the computer system detects and responds to search queries (e.g., typing inputs, voice inputs, and/or other types of input requesting to search the input) directed at the search user interface by searching the query in one or more search engines and presenting (e.g., displaying) the results of the search(es).

In some embodiments, the plurality of system controls displayed concurrently with the immersive environment control user interface element include a notifications user interface element (e.g., a notifications user interface platter element, a virtual button, a slider, a dial, a toggle, a segmented control, or another type of control element), such as the notifications control user interface element 716d in FIG. 7C, including one or more representations of notifications from one or more applications (e.g., news applications, stock applications, photos application, financial applications, a settings application of the computer system, and/or another application) on the computer system, such as the first notification 724a from the messaging application and the second notification 724b from the news application in FIG. 7C. In some embodiments, the notifications user interface element includes notifications from applications and includes controls for modifying presentation of notifications at the computer system, such as the focus mode control element described below. In some embodiments, the notifications user interface element includes indications of notifications from the applications and a timestamp of the notifications. In some embodiments, the notifications in the notification user interface element are generated in response to detecting a notification event (e.g., an event for which the computer system is configured to notify the user, such as a newly received email, a call, a text message, or another notification event). In some embodiments, a respective notification in the notification user interface element is selectable to open the application that corresponds to the notification and/or is selectable to cause the application to perform one or more operations relative to the notification. For example, should the notification indicate a missed call, the notification is optionally selectable to open a calling application and/or is selectable to initiate a call to the caller of the missed call.

In some embodiments, displaying the notifications user interface element includes displaying a focus mode control element (e.g., a virtual button, a slider, a dial, a toggle, a segmented control, or another type of control element) for controlling presentation of the one or more notifications from the one or more applications on the computer system, such as the focus mode control element 725a in FIG. 7C. In some embodiments, the focus mode control element is associated with a respective value. In some embodiments, the focus mode control element visually indicates the value to which the focus mode is set (e.g., indicates whether or not the computer system in currently operating in the focus mode). For example, were the respective value a first value, in which the computer system is operating in the focus mode, the focus mode control element optionally visually indicates that the computer system is currently operating in the focus mode, and were the respective value a second value, in which the computer system is not operating in the focus mode, the focus mode control element optionally visually indicates that the computer system is not currently operating in the focus mode. In some embodiments, the focus mode control element that is in the notifications user interface element is or includes one or more characteristics of the focus mode control element described above with reference to the plurality of system controls. In some embodiments, in response to detecting a notification event (e.g., such as the notification event described above), in accordance with a determination that the respective value is a first value, the computer system forgoes presentation of a first notification in a first manner corresponding to the notification event (e.g., forgoing presentation of a system notification that is indicative of the first notification, such as forgoing presenting audio indicating the first notification and/or displaying display of the first notification outside of the notifications user interface element). For example, were the focus mode control element 725a in FIG. 7C set to the first value when the notification event that corresponded to the first notification 724a in FIG. 7C was detected, the computer system 101 would forgo presenting the first notification 724a in the first manner. In some embodiments, when the respective value is the first value described above, the focus mode is enabled and the computer system forgoes visually and/or audibly presenting notifications. For example, when the focus mode is enabled, and the computer system detects a call from a known or unknown number, the computer system optionally does not notify the user of the first notification in the first manner (e.g., the computer system forgoes presenting audio and/or a user interface that is different from the control user interface and that indicates that the user is being called). In some embodiments, when the focus mode is enabled (e.g., when the respective value is the first value described above), the notifications are silenced (e.g., from presentation). In some embodiments, when the focus mode is disabled (e.g., when the respective value is the second value described herein), notifications are presented (e.g., the computer system notifies the user of detected notification events by generating the notifications (e.g., outside of the control user interface)). In some embodiments, when the respective value is the first value, the computer system forgoes notifying the user of detected notification events (e.g., the computer system does not generate the notifications (e.g., outside of the control user interface)). In some embodiments, the user can view the notifications that were silenced from being presented by interacting with the notifications user interface element of the control user interface. In some embodiments, in accordance with a determination that the respective value is a second value that is different from the first value, the computer system presents the first notification in the first manner corresponding to the notification event. For example, were the focus mode control element 725a in FIG. 7C set to the second value when the notification event that corresponded to the first notification 724a in FIG. 7C was detected, the computer system 101 would present the first notification 724a in the first manner. In some embodiments, when the respective value is the second value, the focus mode is enabled and the computer system generates the notifications (e.g., outside of the control user interface), as described above. For example, when the focus mode is enabled, and the computer system detects a call from a known or unknown number, the computer system optionally notifies the user of the call in the first manner (e.g., the computer system presents audio and/or a user interface that is different from the control user interface and that indicates that the user is being called).

In some embodiments, the computer system presents, via the one or more display generation components, a three-dimensional environment, and the control user interface of the computer system is displayed in the three-dimensional environment, such as the control user interface 716 in the three-dimensional environment 704 in FIG. 7C. In some embodiments, the three-dimensional environment includes the immersive environment, three-dimensional virtual content, two-dimensional virtual content, and/or user interfaces, and/or includes real or virtual passthrough of a physical environment of the user. In some embodiments, the computer system displays the control user interface in the three-dimensional environment, such that the control user interface is displayed at a certain depth from the viewpoint of the user in the three-dimensional environment. In some embodiments, control user interface has a depth component, width component, and height component in the three-dimensional environment. In some embodiments, the computer system moves a user interface element of the control user interface in the viewpoint of the user of the computer system (e.g., in the three-dimensional environment) in response to input directed at the user interface element. For example, in response to detecting selection of the notifications user interface element described above, the computer system optionally moves the notifications user interface element towards the viewpoint of the user of the computer system and/or moves away from the viewpoint of the user of the computer system other user interface elements of the control user interface, such as the immersive environment control user interface element.

In some embodiments, displaying the control user interface of the computer system includes displaying in a first arrangement (e.g., a first position and/or orientation) relative to each other in a viewpoint of a user of the computer system a plurality of user interface elements including the immersive environment control user interface element, such as described herein, and a second control user interface element configured to control one or more parameters of a first system function of the plurality of system functions of the computer system, where the one or more parameters of the first system function are different from the one or more environment parameters of the computer system, such the order of the user interface elements 716a through 176d, which includes the media control user interface element 716a having a first position (e.g., a left most position of the order of the user interface elements 716a through 176d in the viewpoint of the user) and the immersive environment control user interface element 716c being two positions away from the first position (e.g., two positions rightward of the left most position) in FIG. 7C. For example, the computer system displays the user interface elements of the control user interface (e.g., the immersive environment control user interface element and the second control user interface element) in a first relative order or a first relative positioning in the control user interface. In some embodiments, while displaying the control user interface of the computer system in the first arrangement relative to each other in the viewpoint of the user of the computer system, the computer system detects, via the one or more input devices, an input directed to a first control element (e.g., a virtual button, a slider, a dial, a toggle, a segmented control, or another type of control element) of the control user interface of the computer system, such as the attention 714 (e.g., based on gaze) of the user 702 directed to the immersion control element 722a and movement of the hand 702a while the hand 702a is performing an air pinch gesture (e.g., the thumb and index finger of the hand of the user are in contact) in FIG. 7C. For example, the first control element is optionally the immersion control element described above and the input directed to it is optionally as described above as well. For example, the input directed to the immersion control element optionally includes attention (e.g., based on gaze) of the user directed to the immersion control element and movement of a hand of the user while the hand of the user is performing an air pinch gesture (e.g., the thumb and index finger of the hand of the user are in contact). As another example, the input directed to the immersion control element optionally includes touch input(s) detected on a touch-sensitive surface (e.g., a touch screen), a user pressing down on a control element on a mouse (e.g., a left-click), and/or is a gaze input without including other inputs such as an air gesture. In some embodiments, while displaying the control user interface of the computer system in the first arrangement relative to each other in the viewpoint of the user of the computer system, in response to detecting the input directed to the first control element of the control user interface of the computer system, the computer system performs an action with respect to the first control element while maintaining display of the control user interface of the computer system with the plurality of user interface elements in the first arrangement (e.g., the first position and/or orientation) relative to each other in the viewpoint of the user of the computer system. For example, the order of the user interface elements 716a through 176d, which includes the media control user interface element 716a having a first position (e.g., a left most position of the order of the user interface elements 716a through 176d in the viewpoint of the user) and the immersive environment control user interface element 716c being two positions away from the first position (e.g., two positions rightward of the left most position), is maintained from FIG. 7C to FIG. 7D even though the computer system is detecting and responding to the input directed to the immersion control element 722a from FIG. 7C to FIG. 7D. For example, the first control element is optionally the immersion control element of the immersive environment control user interface element, and while the computer system is detecting and responding to input directed to the immersion control element, the computer system optionally maintains display of other control elements of the control user interface, such as maintaining display of the media player that control user interface element. In some embodiments, were user input directed to a second control element of the control user interface while the control user interface is being displayed in a respective arrangement relative to a viewpoint of a user of the computer system, the computer system would optionally perform an action with respect to the second control element while maintaining display of the control user interface in the respective arrangement. In some embodiments, when the computer system detects interaction with a control user interface element of the control user interface that includes a set of control elements, such as the notifications user interface element of the control user interface, the computer system moves that control user interface element toward the viewpoint of the user and/or moves back other control user interface elements away from the viewpoint of user (e.g., and optionally de-emphasizes (e.g., fade-out or maintains at a lower brightness level or a higher level of translucency) the other control user interface elements as well). As such, the computer system optionally maintains display of the control user interface (e.g., maintains display of other controls elements of the control user interface) while it detects and responds to inputs directed to particular control elements of the control user interface.

In some embodiments, while displaying the control user interface of the computer system, the computer system detects, via the one or more input devices, a scroll input directed at the control user interface of the computer system, where the scroll input is associated with a direction and a requested amount of scrolling (e.g., a magnitude of the scroll input, such as a speed, distance, and/or duration of the scroll input), such as the scroll input directed to the notifications control user interface element 716d that includes movement (e.g., vertical movement as indicated by the arrow 727) of the hand 702a while the hand 702a is performing an air pinch gesture (e.g., the thumb and index finger of the hand of the user are in contact) in FIG. 7C or the scroll input directed to the control user interface 716 that includes movement of the hand 702a of the user 702 (e.g., horizontal movement direction as indicated by the arrow 727a) in FIG. 7P. In some embodiments, the scroll input includes a first amount of movement of a hand of the user in a first direction, and the computer system corresponds detection of the scroll input to a request to scroll the control user interface. In some embodiments, the control user interface enters a scroll mode in response to detecting an input for scrolling. In some embodiments, the input for scrolling is directed to a first control element of the control user interface that is selectable to initiate scrolling. in some embodiments the input for scrolling includes attention (e.g., based on gaze) of the user directed to the first control element while the hand of the user is performing an air pinch gesture (e.g., the thumb and index finger of the hand of the user coming into contact and then remaining in contact with each other while the hand is moving in a respective direction, and the input for scrolling ceases when the thumb and index finger of the hand of the user is released from contact). In some embodiments, in response to detecting the scroll input, and in accordance with a determination that the direction associated with the scroll input is a first direction (e.g., a vertical or a horizontal direction), such as movement of the hand 702a of the user 702 in the horizontal direction as indicated by the arrow 727a in FIG. 7P, the computer system scrolls the control user interface of the computer system, including scrolling the immersive environment control user interface element and the plurality of system controls in a respective direction corresponding to the first direction and by an amount corresponding to the requested amount of scrolling, such as shown with the scrolling of the user interface elements 716a through 716d, 716l, and 716m from FIG. 7P to FIG. 7Q. In some embodiments, the computer system scrolls the control user interface elements (e.g., the immersive environment control user interface element, media playback control user interface element, the connectivity control user interface element, and/or the other control user interface elements that include one or more control elements) in a direction and magnitude that corresponds to a direction and magnitude associated with the input. In some embodiments, in response to the input including movement in the first direction, the computer system scrolls the control user interface elements in a third or fourth direction (e.g., a same direction as the scroll input or in a direction that is inverted relative to a direction of the scroll input). In some embodiments, were a magnitude associated with the input a first magnitude, the computer system would scroll the control user interface elements by a first amount of scrolling, and were the magnitude associated with the input a second magnitude that is different from the first magnitude, the computer system would scroll the control user interface elements by a second amount of scrolling that is different from the first amount of scrolling. In some embodiments, the greater the magnitude associated with the input, the greater the amount of scrolling that stop is in response to the input. In some embodiments, the control user interface elements are horizontally or vertically paginated in the viewpoint of the user of the computer system. In some embodiments, the resulting scrolling behavior of the control user interface elements is carousel-like. As such, the computer system optionally scrolls the control user interface elements of the control user interface in accordance with the scroll input provided that the scroll input includes movement in the first direction. In some embodiments, in response to detecting the scroll input, and in accordance with a determination that the direction associated with the scroll input is a second direction (e.g., a vertical or a horizontal direction), different from the first direction (e.g., perpendicular to the first direction), the computer system scrolls through content of a first section of the control user interface of the computer system without scrolling through content of a second section, different from the first section, of the control user interface of the computer system in a respective direction corresponding to the second direction and by the amount corresponding to the requested amount of scrolling, such as the scroll of the content of the notifications control user interface element 716d in accordance with the scroll input directed to the notifications control user interface element 716d (e.g., described above) shown from FIG. 7C to FIG. 7G. For example, when the direction associated with the scroll input is the second direction, the computer system optionally scrolls through content of a control user interface element of the control user interface, such as the immersive environment control user interface element. In some embodiments, the control user interface element that the computer system scrolls in response to detecting that the direction associated with the scroll input is the second direction is the control user interface element to which the attention (e.g., based on gaze) of the user is directed while the scrolling movement is being detected. As such, were the attention (e.g., based on gaze) of the user directed to a first control user interface element of the control user interface, such as the immersive environment control user interface element, while the scrolling movement in the second direction is being detected, the computer system would optionally scroll the content of the first control user interface element, and were the attention (e.g., based on gaze) of the user directed to a second control user interface element, different from the first control user interface element, such as the notifications control user interface element, while the scrolling movement in the second direction is being detected, the computer system would optionally scroll the content of the second control user interface element without scrolling the content of the first control user interface element. In some embodiments, content of a control user interface element of the control user interface (e.g., content of the immersive environment control user interface element, media playback control user interface element, the notifications user interface element, the connectivity control user interface element, and/or the other control user interface elements of the control user interface that include one or more control elements) are vertically paginated in the viewpoint of the user of the computer system, and the computer system scrolls the content in response to detecting scrolling inputs that includes movement in the second direction (and optionally in response to detecting that the attention of the user is directed to the content). As such, the computer system optionally scrolls content of a control user interface element of the control user interface in accordance with the scroll input provided that the scroll input includes movement in the second direction. In some embodiments, scrolling of the control user interface elements of the control user interface is performed independent of scrolling of content of a control user interface element. In some embodiments, when the control user interface elements of the control user interface are scrolling in response to input, content of a control user interface element is not being scrolled. In some embodiments, when content of a control user interface element is being scrolled in response to input, the control user interface elements of the control user interface are not being scrolled.

In some embodiments, the direction associated with the scroll input is the first direction, and while displaying the control user interface of the computer system in a first arrangement (e.g., the user interface elements of the control user interface are displayed in a first position and/or orientation relative to each other and/or relative to a viewpoint of the user) that is determined in accordance with the scroll input (e.g., the relative positioning of the control user interface elements of the control user interface is as a result of the scroll input), such as the illustrated order of the user interface elements 716a through 716d, 716l, and 716m in FIG. 7R, which is a result of the scroll input of FIG. 7P, the computer system detects, via the one or more input devices, an input corresponding to a request to cease display of the control user interface of the computer system, such as the attention 714 (e.g., based on gaze) of the user 702 directed to outside the control user interface 716 while the hand 702a performs an air pinch gesture (e.g., the thumb and index finger of the hand of the user coming into contact with each other and then the release thereof) in FIG. 7R. In some embodiments, the input includes attention of the user directed to outside of the control user interface of the computer system optionally while an air pinch gesture is performed. Other inputs such as voice inputs or inputs including pressing of physical component(s) of the computer system or of a remote control that is in communication with the computer system can optionally correspond to the request to cease display of the control user interface as well. In some embodiments, in response to detecting the input, the computer system ceases display of the control user interface of the computer system (and optionally, maintaining display of other content that was concurrently displayed with the control user interface, and/or optionally displaying content that was hidden due to display of the control user interface in the viewpoint of the user of the computer system), such as the ceasing of display of the control user interface 716 from FIG. 7Q to 7A. In some embodiments, while not displaying the control user interface of the computer system, the computer system detects, via the one or more input devices, a second input corresponding to a second request to display the control user interface of the computer system, such as the selection input including input from the hand 702a of the user 702 (e.g., an air pinch gesture) while attention 714 of the user 702 is directed to the control widget user interface 712 in FIG. 7S. In some embodiments, the second input corresponding to the second request to display the control user interface of the computer system includes one or more characteristics of the input corresponding to the request to display the control user interface of the computer system described with reference to step(s) 802 of method 800. In some embodiments, in response to detecting the second input, and in accordance with a determination that less than a first amount of time (e.g., 3 s, 10 s, 30 s, 1 min, 3 min or another period of time) has passed since detecting the input corresponding to the request to cease display of the control user interface of the computer system, the computer system displays, via the one or more display generation components, the control user interface of the computer system in the first arrangement that is determined in accordance with the scroll input, such as displaying the user interface elements 716a through 716d, 716l, and 716m, of the control user interface 716 in their relative order illustrated in FIG. 7Q, which is the relative order resulting from the scroll input in FIG. 7P. As such, the computer system optionally displays the control user interface in the arrangement that control user interface had when the computer system ceased display of the control user interface provided that a time threshold since the ceasing of display of the control user interface has not passed. In some embodiments, in response to detecting the second input, and in accordance with a determination that at least the first amount of time has passed since detecting the input corresponding to the request to cease display of the control user interface of the computer system, the computer system displays, via the one or more display generation components, the control user interface of the computer system in a second arrangement (e.g., a default arrangement, such as a default position and/or orientation relative to each other and/or relative to a viewpoint of the user) that is different from the first arrangement, such as the displaying the user interface elements 716a through 716d, 716l, and 716m of the control user interface 716 in their relative order illustrated in FIG. 7O, which is the relative order before the scroll input of FIG. 7P was detected. In some embodiments, the second arrangement is an arrangement that the control user interface had when the scroll input was initially detected. As such, the computer system optionally displays the control user interface in an arrangement that is different from the arrangement that control user interface had when the computer system ceased display of the control user interface provided that the time threshold since the ceasing of display of the control user interface has passed.

In some embodiments, displaying the control user interface of the computer system in response to the input corresponding to the request to display the control user interface of the computer system includes in accordance with a determination that a first application (e.g., a video conferencing application, a gaming application, a media playback application, and/or another type of application) is in use (and/or is displayed) when the input corresponding to the request to display the control user interface of the computer system is detected, such as the user interface 708b of the video conferencing application in FIG. 7T, displaying a first application user interface element in the control user interface configured to control one or more parameters of the first application, such as the user interface element 716n in FIG. 7U. In some embodiments, displaying the control user interface of the computer system in response to the input corresponding to the request to display the control user interface of the computer system includes in accordance with a determination that a second application is in use (and/or is displayed) (e.g., a video conferencing application, a gaming application, a media playback application, and/or another type of application), different from the first application, when the input corresponding to the request to display the control user interface of the computer system is detected, displaying a second application user interface element in the control user interface configured to control one or more parameters of the second application. For example, were a gaming application in use when the input in FIG. 7T is detected, the computer system 101 would display a gaming application user interface element in the control user interface 716 in FIG. 7U, where the gaming application user interface element would include control(s) for controlling parameter(s) of the gaming application. In some embodiments, if the first application is in use and the second application is not in use, the computer system displays the first application user interface element in the control user interface without displaying the second application user interface element. In some embodiments, if the second application is in use and the first application is not in use, the computer system displays the second application user interface element in the control user interface without displaying the first application user interface element. In some embodiments, if the first application is in use and the second application is in use, the computer system concurrently displays the first application user interface element and the second application user interface element in the control user interface. As such, in some embodiments, the computer system displays application user interface elements in the control user interface when the applications to which they correspond are active on the computer system and forgoes displaying the application user interface elements in the control user interface when the applications to which they correspond are not active on the computer system. In some embodiments, were the control user interface not displayed, the application user interface elements of the control user interface would not be displayed. For example, were an application active on the computer system, and the control user interface not displayed, the application user interface element of the control user interface would optionally not be displayed. In some embodiments, the computer system displays the user interface element provided that an application developer of the application provides one or more parameters for the user to modify. For example, were the application in use a video conferencing application, the parameters are optionally related to video conferencing (e.g., adding/removing persons from the video conferencing, muting/unmuting, enabling or disabling camera feed)), and were the application in use a gaming application, the parameters are optionally related to the game to which the gaming application corresponds. In some embodiments, were an application to be in use, and the application developer of the application did not include parameters for the user to modify, the computer system does not include an application user interface element configured to control one or more parameters of the application in the control user interface. In some embodiments, were an application to be in use, and the application developer of the application did include parameters for the user to modify, the computer system would include the application user interface element configured to control one or more parameters of the application in the control user interface. In some embodiments, the computer system displays respective application user interface elements configured to control one or more parameters of the respective applications independent of whether the application developer of the application includes parameters for the user to modify. In some embodiments, in accordance with the determination that the first application is in use and the second application is in use, the computer system displays concurrently the first application user interface element and the second application user interface element in the control user interface.

FIGS. 9A through 9Z generally illustrate examples of a computer system detecting and responding to requests to display a volume control user interface of the computer system, in accordance with some embodiments.

FIG. 9A illustrates an example of computer system 101 displaying a control user interface 716 of computer system 101 within a three-dimensional environment 700 (e.g., a three-dimensional user interface), in accordance with some embodiments. It should be understood that, in some embodiments, computer system 101 utilizes one or more techniques described with reference to FIGS. 9A-9Z in a two-dimensional environment without departing from the scope of the disclosure. As described above with reference to FIGS. 1-6, computer system 101 optionally includes one or more display generation components 120 (e.g., a head-mounted display) and a plurality of image sensors 314a-c. Image sensors 314a-c optionally include one or more of a visible light camera, an infrared camera, a depth sensor, or any other sensor computer system 101 would be able to use to capture one or more images of a user 702 or a part of user 702 (e.g., one or more hands of user 702, such as hand 702a, or an attention 714 (e.g., based on gaze) of user 702) while user 702 interacts with computer system 101. In some embodiments, image sensors 314a-c may capture gestures or movements of hand 702a, such as the act of pinching or the release thereof, as described in greater detail herein. In some embodiments, computer system 101 displays the user interface or three-dimensional environment 700 to user 702 (and/or the three-dimensional environment 700 is visible via display generation component 120, such as via passive and/or active passthrough), and uses sensors to detect the physical environment and/or movements of the user's hands (e.g., external sensors facing outwards from the user) such as movements that are interpreted by computer system 101 as gestures such as air gestures, and/or gaze of the user (e.g., internal sensors facing inwards towards the face of the user).

As shown in FIG. 9A, computer system 101 displays three-dimensional environment 700 including control user interface 716, system volume control element 716e (for controlling a system-wide volume level of computer system 101), music application 914, and game application 916. In some embodiments, control user interface 716 shares one or more characteristics with control user interface 716 of FIGS. 7C-7Y. FIG. 9A also depicts a top-down view 901 of user 702 interacting with their environment while using computer system 101, which includes a visual representation of the positions of control user interface 716, music application 914, and game application 916 within three-dimensional environment 700. In addition, FIG. 9A depicts attention 714 of user 702 directed at system volume control element 716e while hand 702a performs a gesture (e.g., an air pinch or an air pinch-and-hold).

FIG. 9A also illustrates a plurality of elements associated with control user interface 716 that are described in greater detail with respect to FIG. 7C and method 800. For instance, control user interface 716 includes media control user interface element 716a, connectivity control user interface element 716b, immersive environment control user interface element 716c, notifications control user interface element 716d, volume slider 716e-1, volume icon 716e-2, search control user interface element 716f, control element 716g, current time 716h, current date 716i, Wi-Fi connectivity indicator 716j, and battery level 716k. In some embodiments, media control user interface element 716a includes rewind control 718a, play/pause control 718b, fast-forward control 718c, and playback position indicator/control 718d. In some embodiments, connectivity control user interface element 716b includes Wi-Fi control element 720a, BLUETOOTH control element 720b, wireless communication control element 720c, airplane mode control element 720d, virtual display control element 720e, screen recording control 720f, viewing mirroring control element 720g, focus mode control element 720h, guest mode control element 720i, and spatial tracking mode control 720j. In some embodiments, immersive environment control user interface element 716c includes immersion control element 722a, immersive environment volume control element 722b, time of day control element 722c, control element 722d, and visual representation 722e. In some embodiments, notifications control user interface element 716d includes first notification 724a, second notification 724b, focus mode control element 725a, and clearing control element 725b.

FIGS. 9B-9L illustrate example methods for modifying volume levels of one or more applications and/or computer system 101 itself, in accordance with some embodiments. In some embodiments, in response to detecting user 702 perform the air pinch (or air pinch-and-hold or other appropriate gesture for determining user 702 is requesting to expand system volume control element 716e) gesture with hand 702a while attention 714 is directed to system volume control element 716e, computer system 101 displays audio management panel 726, as illustrated in FIG. 9B. Audio management panel 726 is described in greater detail with respect to method 1000. Similarly, top-down view 901 now shows audio management panel 726 disposed at a position within three-dimensional environment 700 between user 702 and control user interface 716 from the viewpoint of user 702, optionally as described in further detail with reference to method 800.

As illustrated in FIG. 9B, audio management panel 726 optionally includes a volume control user interface 930, a spatial audio control user interface 940, an output device control user interface 950, and an ambient noise control user interface 960. As shown in FIG. 9B and as described further below with reference to method 1000, volume control user interface 930, spatial audio control user interface 940, output device control user interface 950, and ambient noise control user interface 960 are included in a common container element (e.g., the audio management panel 726) despite being referred to as respective user interfaces. In some embodiments, volume control user interface 930 includes one or more volume control elements 726a-932 for controlling one or more volume levels, as described in greater detail with respect to FIGS. 9C-9L and below with reference to method 1000. For example, volume control element 726a optionally controls a system-wide volume level of computer system 101 (e.g., has the same functionality as system volume control element 716e), volume control element 726b optionally controls a volume level of music application 914, and volume control element 932 optionally controls a volume level of game application 916. In some embodiments, computer system 101 displays volume control elements 726a-932 based on the applications that are currently active (e.g., music application 914 and game application 916), and computer system 101 would display different volume control elements were different applications active, as described in greater detail with respect to method 1000. In some embodiments, volume control elements 726a-932 include one or more parts (e.g., a slider and one or more icons) that are individually selectable or otherwise actionable to cause computer system 101 to perform a corresponding action, as described in greater detail with respect to FIGS. 9C-9F.

In some embodiments, spatial audio control user interface 940 includes one or more spatial audio control elements 726e-942 for controlling one or more spatial audio modes, as described in greater detail with respect to FIGS. 9R-9Y and method 1000. For example, spatial audio control element 726e optionally controls a spatial audio mode of music application 914 and spatial audio control element 942 optionally controls a spatial audio mode of game application 916. In some embodiments, spatial audio control user interface 940 includes a global spatial audio control element 944 for controlling a system-wide spatial audio mode of computer system 101. As illustrated in FIG. 9B, global spatial audio control element 944 is optionally set to “ON” when spatial audio is enabled for computer system 101 and/or at least one application (e.g., music application 914, as shown by spatial audio control element 726e being set to “ON”).

In some embodiments, output device control user interface 950 includes one or more output device control elements 726g-726h for controlling one or more output devices associated with computer system 101, as described in greater detail with respect to FIGS. 9M-9N. For example, output device control element 726g optionally controls an audio output of a “Device A” associated with computer system 101 and output device control element 726h optionally controls an audio output of a “Device B” associated with computer system 101. As illustrated in FIG. 9B, when computer system 101 outputs audio via a particular device (e.g., “Device A”), computer system 101 highlights and/or otherwise visually differentiates the output device control element associated with said device (e.g., output device control element 726g).

In some embodiments, ambient noise control user interface 960 includes an ambient noise control element 726i for setting an ambient noise mode of computer system 101, as described in greater detail with respect to FIGS. 9O-9Q. For example, ambient noise control element 726i is optionally selectable to set an ambient noise mode of computer system 101 to at least one of an “OFF” mode, an “Active noise cancellation” mode, and a “Passthrough” mode.

In some embodiments, as illustrated in FIG. 9C, computer system 101 detects attention 714 directed to volume control element 932 while hand 702a performs a gesture (e.g., an air pinch-and-drag gesture). In particular, computer system 101 optionally detects attention 714 directed to a slider 934b included within volume control element 932. In some embodiments, as illustrated in FIG. 9D, upon detecting hand 702a move towards the right while maintaining the gesture (e.g., the air pinch), computer system 101 modifies the volume level of game application 916 in accordance with the movement of hand 702a without modifying the volume level of computer system 101 and music application 914 and updates volume control element 932 to reflect the modified volume level of game application 916. In some embodiments, computer system 101, in real time, modifies the volume level of game application 916 and updates volume control element 932 while hand 702a is moving. In some embodiments, attention 714 is not required to be directed to volume control element 932 (or slider 934b) while the air drag gesture is performed (e.g., after computer system 101 detects hand 702a perform the air pinch while attention 714 was directed to volume control element 932). In some embodiments, computer system 101 modifies and updates the volume levels of different applications (e.g., music application 914 or another application active on computer system 101 or with persistent volume controls) in a process similar (or identical) to the process described above with reference to volume control element 932 (and/or slider 934b). In some embodiments, inputs to sliders associated with different applications (e.g., one or more sliders that are part of one or more volume control elements associated with one or more applications) cause similar (or identical) interactions (e.g., to the sliders themselves, to their respective volume control elements, and/or to their respective applications) as the interactions described above with respect to slider 934b.

In some embodiments, as illustrated in FIG. 9E, computer system 101 detects attention 714 directed to volume control element 726a while hand 702a performs a gesture (e.g., an air pinch-and-drag gesture). In particular, computer system 101 optionally detects attention 714 directed to a slider 934b included within volume control element 726a. In some embodiments, as illustrated in FIG. 9F, upon detecting hand 702a move towards the right while maintaining the gesture (e.g., the air pinch), computer system 101 modifies the system-wide volume level of computer system 101 in accordance with the movement of hand 702a without modifying the volume level of music application 914 and game application 916 and updates volume control element 726a (and system volume control element 716e) to reflect the modified volume level of computer system 101. In some embodiments, computer system 101, in real time, modifies the system-wide volume level of computer system 101 and updates volume control element 726a (and system volume control element 716e) while hand 702a is moving. In some embodiments, attention 714 is not required to be directed to volume control element 726a (or slider 934b) while the air drag gesture is performed (e.g., after computer system 101 detects hand 702a perform the air pinch while attention 714 was directed to volume control element 726a).

In some embodiments, as illustrated in FIG. 9G, while control user interface 716 and audio management panel 726 are not displayed, computer system 101 detects attention 714 directed to a close affordance 918 of game application 916 while hand 702a performs a gesture (e.g., an air pinch). FIG. 9G also illustrates audio management panel 726—shown here for reference, although it is not currently displayed by display generation component 120—to depict how the panel would appear at this point in time, while the game application 916 is open, if it was displayed.

In some embodiments, as illustrated in FIG. 9H, upon detecting user 702 request game application 916 be made inactive (e.g., as illustrated in FIG. 9G), computer system 101 makes game application 916 inactive. In some embodiments, by making game application 916 inactive, computer system 101 ceases to display game application 916 within three-dimensional environment 700 and would cease to display its corresponding audio control elements (e.g., volume control element 932 and spatial audio control element 942) within audio management panel 726 if the panel was displayed, as demonstrated by audio management panel 726 in FIG. 9H.

In some embodiments, as illustrated in FIG. 9I, after making game application 916 inactive, while displaying a home user interface 970 including a game affordance 972, computer system 101 detects attention 714 directed at game affordance 972 while hand 702a performs a gesture (e.g., an air pinch). In some embodiments, upon detecting user 702 requesting game application 916 be made active (e.g., as illustrated in FIG. 9I), computer system 101 makes game application active, as illustrated in FIG. 9J. In some embodiments, as illustrated in FIG. 9J, by making game application 916 active after making game application 916 inactive (as shown in FIGS. 9G-9H), computer system 101 displays game application 916 within three-dimensional environment 700. Additionally, in some embodiments, computer system 101 would display audio control elements (e.g., volume control element 932 and spatial audio control element 942) corresponding to game application 916 within audio management panel 726 if the panel was displayed in the same state as the audio control elements were before game application 916 was made inactive (e.g., volume control element 932 at the same volume level and/or spatial audio control element 942 in the same spatial audio mode), as demonstrated by audio management panel 726 in FIG. 9J.

In some embodiments, as illustrated in FIG. 9K, computer system 101 detects attention 714 directed to a close affordance 918 of music application 914 while hand 702a performs a gesture (e.g., an air pinch). In some embodiments, as illustrated in FIG. 9L, upon detecting user 702 request music application 914 be made inactive (e.g., as illustrated in FIG. 9K), computer system 101 makes music application 914 inactive. In some embodiments, by making music application 916 inactive, computer system 101 ceases to display music application 914 within three-dimensional environment 700. Additionally or alternatively, in some embodiments, computer system 101 would not cease to display its corresponding audio control elements (e.g., volume control element 726b and spatial audio control element 726e) within audio management panel 726 if the panel was displayed (e.g., because music application 914 is a persistent application whose audio control elements persist within audio management panel 726 even when inactive), as demonstrated by audio management panel 726 in FIG. 9L. In some embodiments, when computer system 101 receives one or more inputs to the audio control elements associated with music application 914 (e.g., volume control element 726b and spatial audio control element 924a) while music application 914 is inactive, computer system 101 performs the same one or more actions corresponding to the one or more inputs as if music application 914 was active.

FIGS. 9M-9N illustrate example methods for switching an audio output device associated with computer system 101, in accordance with some embodiments. In some embodiments, as illustrated in FIG. 9M, while displaying audio management panel 726 (and optionally displaying control user interface 716) and audio is being output via “Device A” (as indicated by output device control element 726g being highlighted), computer system 101 detects attention 714 directed at output device control element 726h while hand 702a performs a gesture (e.g., an air pinch).

In some embodiments, as illustrated in FIG. 9N, upon detecting user 702 request audio be output via “Device B” (as illustrated in FIG. 9M), computer system ceases to output audio via “Device A” and outputs subsequent audio via “Device B” and highlights (and/or otherwise visually distinguishes, as described below with reference to method 1000) output device control element 726h. In some embodiments, upon switching audio output devices from a first device to a second device (e.g., from “Device A” to “Device B”), computer system 101 updates one or more audio characteristics and their corresponding audio control elements based on the second device (e.g., “Device B”). For example, computer system 101 optionally retrieves a previously-set volume level for game application 916 (and/or music application 914 and/or computer system 101) that was set when “Device B” last output audio for computer system 101, sets the volume level for game application 916 to the previously-set volume level, and updates volume control element 932 to reflect the previously-set volume level. As another example, computer system 101 optionally determines that spatial audio is not available for game application 916 when “Device B” outputs audio and, in response, ceases to display spatial audio control element 942 within spatial audio control user interface 940 (and disables spatial audio functionalities for game application 916).

FIGS. 9O-9Q illustrate example methods for enabling one or more ambient noise modes of computer system 101, in accordance with some embodiments. In some embodiments, as illustrated in FIG. 9O, while displaying audio management panel 726 (and optionally displaying control user interface 716), computer system 101 detects attention 714 directed at ambient noise control element 726i while hand 702a performs a gesture (e.g., an air pinch).

In some embodiments, as illustrated in FIGS. 9P-9Q, upon detecting the input directed at ambient noise control element 726i (as illustrated in FIG. 9O), computer system 101 enables an ambient noise mode 964 (e.g., “Active noise cancellation” or “Passthrough”) and updates ambient noise control element 726i to reflect ambient noise mode 964. For example, as illustrated in FIG. 9P, computer system 101 optionally enables an “Active noise cancellation” ambient noise mode 964 where computer system 101 processes incoming environmental sounds and generates inverse sound waves to attenuate and/or cancel out at least portions of the ambient noise, as described in greater detail with respect to method 1000. As another example, as illustrated in FIG. 9Q, computer system 101 optionally enables a “Passthrough” ambient noise mode 964 where computer system 101 leverages one or more microphones (e.g., one or more I/O devices 206 of FIG. 2) to capture outside sounds and incorporate them with the primary audio playback of computer system 101, as described in greater detail with respect to method 1000. In some embodiments, enabling the ambient noise mode 964 includes detecting one or more additional inputs, subsequent to the input illustrated in FIG. 9O, such as an input to an element in a list or drop-down menu containing one or more selectable options associated with one or more ambient noise modes.

FIGS. 9R-9Y illustrate example methods for enabling one or more spatial audio modes of computer system 101, in accordance with some embodiments. In some embodiments, as illustrated in FIG. 9R, while displaying audio management panel 726 (and optionally displaying control user interface 716), computer system 101 detects attention 714 directed at spatial audio control element 942 while hand 702a performs a gesture (e.g., an air pinch). In some embodiments, as illustrated in FIG. 9S, upon detecting the input directed at spatial audio control element 942 (as illustrated in FIG. 9R), computer system 101 displays a spatial audio mode menu 946 that includes one or more spatial audio mode elements 948a-948c that are selectable to set the spatial audio mode (e.g., “OFF,” “Fixed,” and “Head-Tracked”) of game application 916. The “Fixed” and “Head-Tracked” spatial audio modes are described in greater detail with respect to FIGS. 9T-9Y and method 1000.

FIGS. 9T-9U illustrate an example “Fixed” spatial audio mode of computer system 101, in accordance with some embodiments. In some embodiments, as illustrated in FIG. 9T, in response to detecting an input directed at spatial audio mode element 948b (e.g., as illustrated in FIG. 9S), computer system 101 enables a “Fixed” spatial audio mode for game application 916. In some embodiments, the “Fixed” spatial audio mode causes subsequent audio associated with game application 916 to be output in a manner which creates the perception that the audio output remains anchored to a specific location within three-dimensional environment 700 (e.g., virtual source location 980 corresponding to game application 916 within three-dimensional environment 700), as described in greater detail with respect to method 1000. In some embodiments, in response to detecting the input directed at spatial audio mode element 948b, computer system 101 updates spatial audio control element 942 to reflect the “Fixed” spatial audio mode being enabled. For example, as user 702 moves within three-dimensional environment 700, as illustrated between FIGS. 9T and 9U, the audio for game application 916 continues to emanate virtually from virtual source location 980, so a simulated distance 982 to the source increases and the sound is perceived from the left relative to a heading direction 984 of user 702.

FIGS. 9V-9W illustrate an example “Head-Tracked” spatial audio mode of computer system 101, in accordance with some embodiments. In some embodiments, as illustrated in FIG. 9V, in response to detecting an input directed at spatial audio mode element 948c (e.g., as illustrated in FIG. 9S if attention 714 was directed to spatial audio mode element 948c), computer system 101 enables a “Head-Tracked” spatial audio mode for game application 916. In some embodiments, the “Head-Tracked” spatial audio mode causes subsequent audio associated with game application 916 to be output in a manner which creates the perception that the audio output remains anchored to the head and/or viewpoint of user 702 (e.g., from virtual source location 980 at simulated distance 982 in heading direction 984 from user 702) rather than to a specific location within three-dimensional environment 700, as described in greater detail with respect to method 1000. In some embodiments, in response to detecting the input directed at spatial audio mode element 948c, computer system 101 updates spatial audio control element 942 to reflect the “Head-Tracked” spatial audio mode being enabled. For example, as user 702 moves within three-dimensional environment 700, as illustrated between FIGS. 9V and 9W, the audio for game application 916 remains at the same simulated distance 982 and is perceived from the same heading direction 984, because virtual source location 980 moves through three-dimensional environment 700 together with user 702.

FIGS. 9X-9Y illustrate an example “Fixed” spatial audio mode of a function controlled via control user interface 716 of computer system 101, in accordance with some embodiments. In some embodiments, as illustrated in FIG. 9X, while displaying control user interface 716, computer system outputs audio corresponding to a function controlled via control user interface 716 (e.g., a music app integrated into control user interface 716 or a system notification function) such that audio corresponding to said function seems to originate from a location of control user interface 716 within three-dimensional environment 700 (e.g., virtual source location 980). The “Fixed” spatial audio mode illustrated in FIGS. 9X-9Y is described in greater detail with respect to FIGS. 9T-9U and method 1000. For example, as user 702 moves within three-dimensional environment 700, as illustrated between FIGS. 9X and 9Y, the audio for the function controlled via control user interface 716 continues to emanate virtually from virtual source location 980 (e.g., the location of control user interface 716), so a simulated distance 982 to the source decreases and the sound is perceived from the right relative to heading direction 984 of user 702.

FIG. 9Z illustrates an example method for controlling one or more audio characteristics associated with virtual display of computer system 101, in accordance with some embodiments. As described below with reference to method 1000, the virtual display 990 includes displayed content from another electronic device in communication with computer system 101. In some embodiments, as illustrated in FIG. 9Z, while a virtual display 990 corresponding to a second computer system 992 in communication with computer system 101 is active, computer system 101 includes one or more audio control elements (e.g., volume control element 936 and spatial audio control element 943) for controlling one or more audio features associated with virtual display 990 within audio management panel 726, as described in greater detail with respect to method 1000. For example, volume control element 936 optionally controls a volume level of virtual display 990 (e.g., the volume level of audio associated with computer system 992 that is output through computer system 101). As another example, spatial audio control element 943 optionally controls a spatial audio output mode of virtual display 990 (e.g., the spatial audio mode of audio associated with computer system 992 that is output through computer system 101). In some embodiments, a display 994 associated with computer system 992 shows content that is independent of one or more elements displayed via virtual display 990 (e.g., does not display one or more elements displayed via virtual display 990). For example, display 994 optionally presents a different application or user interface or is inactive altogether (e.g., blank or turned off).

FIG. 10 is a flow diagram illustrating an example method 1000 for displaying a volume control user interface in response to detecting an input corresponding to a request to expand a system volume control element, in accordance with some embodiments. In some embodiments, method 1000 is performed at a computer system (e.g., computer system 101 in FIG. 1A such as a tablet, smartphone, wearable computer, or head mounted device) including a display generation component (e.g., display generation component 120 in FIGS. 1A, 3A, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, method 1000 is governed by instructions that are stored in a non-transitory computer-readable storage medium and that are executed by one or more processors of a computer system, such as one or more processors 202 of computer system 101 (e.g., control unit 110 in FIG. 1A). Some operations in method 1000 are, optionally, combined and/or the order of some operations is, optionally, changed.

In some embodiments, method 1000 is performed at a computer system in communication with one or more display generation components and one or more input devices, such as computer system 101 in communication with display generation component 120 and input devices 314a through 314c in FIGS. 9A-9Z. In some embodiments, the computer system, the one or more display generation components, and the one or more input devices share one or more characteristics with the computer system, the one or more display generation components, and/or the one or more inputs described with respect to method 800.

In some embodiments, while displaying, via the one or more display generation components, a system volume control element for controlling a volume level of the computer system, the computer system detects (1002a), via the one or more input devices, a first input directed to the system volume control element corresponding to a request to expand the system volume control element, such as computer system 101 detecting, via input devices 314a through 314c, hand 702a perform an air pinch gesture while attention 714 is directed to system volume control element 716e (and/or volume slider 716e-1 or volume icon 716e-2) in FIG. 9A. In some embodiments, the system volume control element is displayed, via the one or more display generation components, within a three-dimensional environment.

In some embodiments, the first input includes input from a hand of the user of the computer system directed to a mechanical component of the computer system (e.g., a rotatable dial, or a push selectable button or component of the computer system), a touch input on a touch screen, an input on a mouse or trackpad, and/or an air gesture (e.g., an air pinch or hand raise detected by a camera and/or hand-tracking sensors). In some embodiments, the first input includes a voice input from the user of the computer system. In some embodiments, the first input includes attention (e.g., based on gaze) of the user of the computer system directed to the system volume control element that is selectable to expand the system volume control.

In some embodiments, the system volume control element is a user interface element that allows the user of the computer system to adjust the overall or context-specific audio output levels of the computer system. In some embodiments, the system volume control element functions as a control mechanism that affects system-wide audio settings or targets the playback volume of a particular application, depending on the first input, the system's current state, and/or predefined criteria, as described in greater detail below. In some embodiments, the system volume control element is displayed as an overlay within a three-dimensional environment. In some embodiments, the system volume control element provides a unified interface for managing multiple audio sources and/or settings simultaneously. In some embodiments, the system volume control element automatically dynamically adapts its functionality based on the active applications or media types, as described in greater detail below. In some embodiments, the system volume control element is part of a control user interface such as the control user interface described with respect to method 800.

In some embodiments, the first input directed to the system volume control element corresponding to the request to expand the system volume control refers to a user action detected through the one or more input devices that specifically targets or interacts with the system volume control element to signal to the computer system to transition the system volume control from a compact or minimal interface to a more detailed volume control user interface (e.g., revealing additional options and/or controls for adjusting the audio output). In some embodiments, the volume control user interface includes the system volume control element and one or more additional elements for controlling one or more audio characteristics and/or settings, as described in greater detail below. In some embodiments, in response to detecting the first input, the volume control user interface is displayed closer to the viewpoint of the user than a position of the system volume control element before detecting the first input. For example, the user optionally performs an input (e.g., tap, click, air pinch, and/or voice command) directed to (e.g., on or while attention is directed to) a visible volume icon or slider (e.g., the system volume control element), prompting the computer system to expand the system volume control to show additional volume controls. In some embodiments, the system volume control element is an overall volume control that scales the combined audio levels from a plurality of sources (e.g., applications) without altering the respective volume of each source relative to each other, thereby controlling the audio playback volume of an output device integrated with or in communication with the computer system.

In some embodiments, in response to detecting a second input different from the first input, directed to the system volume control element, that corresponds to a request to change a system volume level, the computer system adjusts a system volume level in accordance with the second input, optionally without expanding the system volume control element. In some embodiments, the second input is a select and drag input including an air gesture, a voice input, and/or an input detected using a hardware input device in communication with the computer system. In some embodiments, the first input is a selection input (e.g., click, tap, or pinch) or a secondary selection input (e.g., right click, long click, long tap, or long pinch) different from the second input and including an air gesture, a voice input, and/or an input detected using a hardware input device in communication with the computer system. For example, the first input corresponding to the request to expand the system volume control element is optionally a short air pinch (e.g., an air pinch gesture where the time elapsed between the start of the gesture and the end of the gesture is shorter than a threshold amount of time (e.g., 0.01 s, 0.05 s, 0.1 s, 0.3 s, 0.5 s, 1 s, or 3 s)) and the second input corresponding to the request to change the system volume level is a long air pinch and drag (e.g., an air pinch gesture where the time elapsed between the start of the gesture and the end of the gesture is longer than a threshold amount of time (e.g., 0.01 s, 0.05 s, 0.1 s, 0.3 s, 0.5 s, 1 s, or 3 s) and that includes motion of the hand of the user performing the air pinch).

In some embodiments, in response to detecting the first input (1002b) (e.g., in response to computer system 101 detecting hand 702a performing the air pinch while attention 714 is directed to system volume control element 716e in FIG. 9A), in accordance with a determination that one or more first criteria are satisfied, including a criterion that is satisfied when a first application of the computer system is currently active on the computer system (e.g., when the first input is detected) (e.g., music application 914 being active on computer system 101 in FIG. 9B), the computer system displays (1002c), via the one or more display generation components, a volume control user interface that includes a first volume control for controlling a volume level of the first application, such as computer system 101 displaying, via display generation component 120, volume control user interface 930 including volume control element 726b for controlling the volume level of music application 914 in FIG. 9B.

In some embodiments, the one or more first criteria refer to a set of conditions and/or rules evaluated by the computer system to determine whether a particular action should occur. In some embodiments, the one or more first criteria being satisfied refers to the computer system determining that the specified conditions and/or rules have been met or evaluated as true. Some examples of the one or more first criteria include, but are not limited to, whether: an application is currently active on the computer system; the user has requested to expand a volume control (e.g., by selecting an affordance in a system UI such as a control user interface or the system volume control element); a plurality of applications is open; an application or system function has been designated for persistent volume control; a new application has been opened; an application has been closed; and/or the system or user is switching between different audio output devices.

In some embodiments, the first application refers to a software program or process executing on the computer system that provides specific functionality or user-facing features. In some embodiments, the first application is associated with one or more audio outputs. In some embodiments, the first application being currently active on the computer system refers to the first application's executable code being actively loaded into the computer system's memory and processed or executed by the system's processor(s). In some embodiments, the first application currently active on the computer system is a foreground application actively interacting with the user or a background process functioning without direct user interaction. In some embodiments, the first application is considered to be currently active even if it is currently minimized or operating in the background, so long as it continues to consume system resources and/or remains ready to produce audio (e.g., had audio output capability that is currently active on the computer system). In some embodiments, the computer system displays a user interface of the first application while the first application is currently active. In some embodiments, the computer system does not display a user interface of the first application while the first application is currently active.

In some embodiments, the volume control user interface is a user interface element (or panel) presented by the computer system that includes controls for managing audio output—such as system- or application-specific volume levels—and optionally includes additional audio-related settings, such as spatial audio modes, output device options, noise cancellation features, balance controls, equalizers, and/or interactive presets (e.g., “cinema mode” or “gaming mode”). In some embodiments, the computer system renders the volume control user interface within a larger interface (e.g., a central audio management panel) that includes the volume control user interface and one or more interfaces for controlling additional audio settings (e.g., spatial audio settings, output devices, and/or ambient noise), as described in greater detail below. In some embodiments, a layout or scope of the volume control interface adapts in real time (e.g., revealing or hiding features based on the active applications, user and/or system preferences, and/or environmental conditions). In some embodiments, the volume control user interface is integrated with the control user interface described above. In some embodiments, the volume control user interface is an overlay displayed at a position within the three-dimensional environment that is closer than the control user interface from a viewpoint of the user of the computer system.

In some embodiments, the first volume control refers to a specialized volume adjustment interface that is distinct from a general or system-wide volume control (e.g., the system volume control element) and enables the user of the computer system to regulate the playback volume specifically for the first application currently active on the computer system (e.g., relative to the volume(s) of other audio source(s) (e.g., applications, content items, and/or an operating system) of the computer system, without adjusting the volume level(s) of the other audio source(s) and/or without adjusting the system volume). In some embodiments, the first volume control is presented as a user interface element (e.g., slider, dial, or number) within a volume control user interface that additionally includes a system volume control element.

In some embodiments, a volume level is a measurement or setting that determines the amplitude or loudness of audio output (e.g., from a particular application or system function, or a system volume level for a plurality of audio sources). In some embodiments, controlling the volume level of the first application refers to adjusting or otherwise modifying one or more characteristics of the audio output associated with the first application. Some examples of the one or more characteristics of the audio output include, but are not limited to, loudness (e.g., adjusting the overall decibel level or amplitude of the audio signal), equalization/tone control (e.g., tweaking frequency bands (e.g., bass, midrange, treble) to alter the tonal balance), spatial or three-dimensional audio settings (e.g., changing how audio is positioned or perceived in a three-dimensional sound field (e.g., stereo vs. window-anchored sound)), channel balance (e.g., modifying the relative volume or prominence between multiple audio channels (e.g., left/right, front/rear)), dynamic range compression (e.g., controlling the difference between the quietest and loudest parts of the audio to maintain consistent sound levels), noise control features (e.g., applying active noise cancellation or ambient sound passthrough to filter or admit external noises), and/or audio enhancements or effects (e.g., introducing reverberation, surround sound processing, or other special effects that shape the listening experience).

In some embodiments, in response to detecting the first input (1002b), in accordance with a determination that the one or more first criteria are not satisfied due to the first application not being currently active on the computer system (e.g., game application 916 not being active on computer system 101 in FIG. 9H), the computer system displays (1002d), via the one or more display generation components, the volume control user interface without displaying the first volume control for controlling the volume level of the first application in the volume control user interface, such as if computer system 101 displayed volume control user interface 930 (e.g., in response to detecting hand 702a performing the air pinch gesture while attention 714 is directed at system volume control element 716e, as in FIG. 9A) without displaying volume control element 932 for controlling the volume level of game application 916 in volume control user interface 930, as demonstrated by audio management panel 726 in FIG. 9H.

In some embodiments, the one or more first criteria not being satisfied refers to the computer system determining that the specified conditions and/or rules have not been met or have been evaluated as false (e.g., even if there is only one false criterion among a plurality of true criteria). In some embodiments, the one or more first criteria not being satisfied refers to the first application being deemed as not currently active on the computer system. In some embodiments, the one or more first criteria are not satisfied when the first application is closed or is otherwise not actively executed on the computer system. In some embodiments, the one or more first criteria are not satisfied when the first application is in a suspended or dormant state that prevents it from producing audio. In some embodiments, the one or more first criteria are not satisfied when the first application is being executed on the computer system but is not capable of producing audio.

In some embodiments, displaying the volume control user interface without displaying the first volume control in the volume control user interface refers to the computer system rendering or presenting the volume control user interface while refraining from rendering or presenting a dedicated interface element that adjusts the audio output of the first application within the volume control user interface. In some embodiments, the computer system displays one or more volume control(s) specific to a first set of applications and does not display one or more volume control(s) specific to a second set of applications (e.g., based on the one or more first criteria). In some embodiments, despite displaying the volume control user interface without displaying the first volume control, the computer system displays other volume control(s) and/or interface elements (e.g., a system-wide volume control, such as the system volume control element, or volume controls for applications different from the first application).

By detecting the first input directed to the control user interface and conditionally displaying or forgoing display of the first volume control based on the one or more first criteria, the method ensures that relevant volume controls are displayed at the appropriate time based on user input and based on the current application(s) that are currently active on the computer system, thereby reducing unnecessary system overhead. In addition, by not displaying volume controls for applications that are not currently active, the method ensures that there are no extraneous inputs directed to said volume controls, reducing clutter and complexity in the user interface, and further reducing unnecessary system overhead. This approach optimizes resource usage and improves user interaction, resulting in increased battery life.

In some embodiments, the first input includes a selection of an affordance corresponding to the system volume control element displayed, via the one or more display generation components, in a user interface of an operating system of the computer system, such as attention 714 being directed at system volume control element 716e displayed in control user interface 716 of computer system 101 in FIG. 9A. In some embodiments, the first input including the selection of the affordance includes the system detecting a user action (e.g., via the one or more input devices) that is directed to an icon, button, slider, handle, or other affordance that represents the system volume control element within the user interface (e.g., a control user interface). Some examples of selections of the affordance corresponding to the system volume control element include, but are not limited to, an air gesture (e.g., a short or long air pinch), a tap, a tap-and-hold, a click, a click-and-hold, a double-tap, a two-finger tap, a gaze dwell (e.g., longer than a certain duration of time, such as 0.5 s, 1 s, 2 s, or 5 s), a voice command, a press of a hardware key, and/or another detectable user input directed to the affordance corresponding to the system volume control element. In some embodiments, the computer system displays the user interface of the operating system that contains the affordance corresponding to the system volume control element overlaid on an application interface currently displayed on the computer system. In some embodiments, the computer system displays the user interface of the operating system with a respective appearance and/or functionality irrespective of which application interface lies beneath it. Displaying the system volume control element in the control user interface enhances user interactions with the computer system by concurrently displaying multiple control elements at once, thereby reducing inputs needed to access controls and use the controls to configure the computer system, thereby reducing user inputs and preserving power consumption and battery life of the computer system.

In some embodiments, in response to detecting the first input, in accordance with a determination that one or more second criteria, different from the one or more first criteria, are satisfied, including a criterion that is satisfied when a second application of the computer system, different from the first application, is currently active on the computer system (e.g., game application 916 being active on computer system 101 in FIG. 9B), the computer system displays, via the one or more display generation components, the volume control user interface including a second volume control for controlling a volume level of the second application, such as computer system 101 displaying, via display generation component 120, volume control user interface 930 including volume control element 932 for controlling the volume level of game application 916 in FIG. 9B. In some embodiments, the one or more second criteria share one or more characteristics with the one or more first criteria described above. In some embodiments, the one or more second criteria being different from the one or more first criteria refers to the one or more second criteria being focused on conditions and/or rules related to the second application and the one or more first criteria being focused on conditions and/or rules related to the first application. In some embodiments, the second application is considered different from the first application when it constitutes a separate software program, process, and/or function on the computer system (e.g., distinguishable in at least one aspect such as name, codebase, purpose, identifier, or execution state). In some embodiments, the second volume control for controlling the volume level of the second application shares one or more characteristics with the first volume control for controlling the volume level of the first application described above. In some embodiments, the volume level of the second application shares one or more characteristics with the volume level of the first application described above.

In some embodiments, when the one or more first criteria and the one or more second criteria are both satisfied, the volume control user interface concurrently includes the first volume control and the second volume control. In some embodiments, when the one or more first criteria are not satisfied and the one or more second criteria are satisfied, the volume control user interface includes the second volume control and does not include the first volume control. In some embodiments, the computer system rearranges a layout of the volume control user interface to accommodate newly added controls (e.g., by resizing and/or moving interface elements) so that all active-app volume controls (e.g., the first volume control and the second volume control) remain visible (and/or accessible in response to scrolling), via the one or more display generation components. In some embodiments, when the one or more first criteria and the one or more second criteria are both satisfied, the computer system visually distinguishes (e.g., via highlights, color changes, icons, labels, and/or other indicators) the first volume control from the second volume control such that the first volume control is identifiable as the volume control for the first application and the second volume control is identifiable as the volume control for the second application.

In some embodiments, in response to detecting the first input, in accordance with a determination that the one or more second criteria are not satisfied due to the second application not being currently active on the computer system (e.g., game application 916 not being active on computer system 101 in FIG. 9H), the computer system displays, via the one or more display generation components, the volume control user interface without displaying the second volume control for controlling the volume level of the second application in the volume control user interface, such as if computer system 101 displayed volume control user interface 930 (e.g., in response to detecting hand 702a performing the air pinch gesture while attention 714 is directed at system volume control element 716e, as in FIG. 9A) without displaying volume control element 932 for controlling the volume level of game application 916 in volume control user interface 930, as demonstrated by audio management panel 726 in FIG. 9H. In some embodiments, the one or more second criteria not being satisfied shares one or more characteristics with the one or more first criteria not being satisfied described above. In some embodiments, displaying the volume control user interface without displaying the second volume control in the volume control user interface shares one or more characteristics with displaying the volume control user interface without displaying the first volume control in the volume control user interface described above. In some embodiments, when the one or more first criteria are satisfied and the one or more second criteria are not satisfied, the computer system displays the volume control user interface including the first volume control for controlling the volume level of the first application without displaying the second volume control. By conditionally displaying or forgoing displaying the second volume control based on the one or more second criteria, the method causes active and relevant audio controls to be rendered, thereby reducing unnecessary UI rendering and computational overhead. This approach conserves system resources and can extend the battery life of the computer system and reduces the opportunity for user errors.

In some embodiments, after displaying the volume control user interface with the first volume control, while the first application of the computer system is currently active on the computer system (e.g., game application 914 being active on computer system 101 in FIG. 9G), the computer system detects an event that corresponds to making the first application inactive on the computer system, such as detecting hand 702a perform an air pinch gesture while attention 714 is directed to close affordance 918 of game application 916 in FIG. 9G. In some embodiments, making an application inactive on the computer system means that the computer system terminates, closes, and/or otherwise transitions the application out of a state in which it is actively loaded (e.g., being currently active and/or optionally able to process or produce audio output). In some embodiments, detecting the event that corresponds to making the first application inactive on the computer system refers to the computer system detecting that the first application's process has been terminated, closed, suspended, and/or otherwise transitioned out of an active state (e.g., in response to detecting an input, such as selecting a “close” or “exit” button associated with the first application or removing an application's process via a task manager or command-line interface). In some embodiments, the system automatically ceases the first application upon detecting the application has remained idle for a threshold period of time (e.g., 1 minute, 2 minutes, 5 minutes, 10 minutes, 30 minutes, or 1 hour) and/or consumes excessive resources. In some embodiments, an application ceases upon encountering a critical error or crash.

In some embodiments, in response to detecting the event, the computer system initiates a process to make the first application inactive on the computer system, such as computer system 101 making game application 914 inactive on computer system 101 in FIG. 9H. In some embodiments, making the first application inactive causes the computer to reevaluate the one or more criteria described above from being satisfied to not being satisfied. In some embodiments, in response to detecting the event while displaying the volume control user interface, the computer system updates, via the one or more display generation components, the volume control user interface to no longer include the first volume control in the volume control user interface. In some embodiments, in response to detecting the event, the computer system retains a respective volume level for the first application by storing the respective volume level in a data structure (e.g., a local or remote file, database, or system registry). Some example methods for retaining the respective volume level include, but are not limited to, writing the respective volume level to a local configuration file or system registry keyed to the application's identifier, synchronizing the respective volume level through a user-specific profile or cloud service (e.g., for cross-session and/or cross-device persistence), storing the respective volume level temporarily in a cache or checkpoint until a certain time threshold expires (and/or other criteria are satisfied), and/or other methods for storing the respective volume level such that it is available to the computer system upon relaunching of the first application (e.g., making the first application active after being made inactive).

In some embodiments, while the first application is inactive on the computer system, the computer system detects an event corresponding to a request to display the volume control user interface, such as detecting hand 702a performing the air pinch gesture while attention 714 is directed at system volume control element 716e in FIG. 9A. In some embodiments, the event corresponding to the request to display the volume control user interface shares one or more characteristics with a first input directed to the system volume control element corresponding to a request to expand the system volume control element described above.

In some embodiments, in response to detecting the event corresponding to the request to display the volume control user interface, the computer system displays, via the one or more display generation components, the volume control user interface without displaying the first volume control such as if computer system 101 displayed volume control user interface 930 without displaying volume control element 932 for controlling the volume level of game application 916 in volume control user interface 930, as demonstrated by audio management panel 726 in FIG. 9H. In some embodiments, the computer system detects the event corresponding to making the first application inactive on the computer system while displaying the volume control user interface and, in response, updates the volume control user interface to cease displaying the first volume control by modifying or refreshing the volume control user interface (e.g., while it is being displayed) so that the first volume control is removed or hidden. In some embodiments, displaying the volume control user interface without displaying the first volume control includes the computer system rearranging a layout of the volume control user interface (e.g., by resizing and/or moving interface elements, such as any remaining volume controls) to occupy the space previously used by the first volume control or to reduce the overall footprint of the volume control user interface.

By removing the volume control for a first application from the volume control user interface in response to detecting the first application is inactive on the computer system, the method causes relevant controls to remain, thereby reducing interface clutter and associated resource overhead. This approach prevents a user from inadvertently adjusting audio settings for an inactive application, thereby eliminating wasted processing on redundant inputs and helping to conserve system resources and battery life.

In some embodiments, after displaying the volume control user interface with the first volume control, while the first application of the computer system is currently active on the computer system (e.g., music application 914 being active on computer system 101 in FIG. 9I), the computer system detects a first event that corresponds to making a second application active on the computer system, such as detecting hand 702a performing the air pinch gesture while attention 714 is directed at game affordance 972 in FIG. 9I. In some embodiments, the first event that corresponds to making the second application active on the computer system refers to a system-detectable occurrence indicating that a new application, distinct from the first application, is being launched or brought into an active state (e.g., a user selecting an affordance, the system automatically starting a background service, or a remote command triggering application initialization).

In some embodiments, in response to detecting the first event, the computer system initiates a process to make the second application active on the computer system, such as making game application 916 active on computer system 101 in FIG. 9J. In some embodiments, making an application (e.g., the second application) active refers to the computer system starting or launching the executable code of a software program (e.g., by transitioning it from a non-active state, such as dormant or suspended, into an active state).

In some embodiments, while the second application is active on the computer system, the computer system detects a second event corresponding to a request to display the volume control user interface, optionally as described above, such as detecting hand 702a performing the air pinch gesture while attention 714 is directed at system volume control element 716e in FIG. 9A. In some embodiments, in response to detecting the second event, the computer system displays, via the one or more display generation components, the volume control user interface including the first volume control and a second volume control for controlling a volume level of the second application (e.g., in accordance with a determination that one or more second criteria are satisfied), such as if computer system 101 displayed volume control user interface 930 including volume control element 726e for controlling the volume level of music application 914 and volume control element 932 for controlling the volume level of game application 916 in volume control user interface 930, as demonstrated by audio management panel 726 in FIG. 9J. In some embodiments, the one or more second criteria share one or more characteristics with the one or more first criteria.

In some embodiments, displaying the volume control user interface including the first volume control and the second volume control refers to the computer system adding and/or reconfiguring interactive elements within the volume control user interface so that existing volume controls (e.g., the first volume control) for the first application and a newly introduced volume control (e.g., the second volume control) for the second application are displayed concurrently (e.g., within the same volume control user interface). In some embodiments, displaying the volume control user interface including the first volume control and the second volume control includes the computer system adapting the layout automatically (e.g., by resizing or repositioning existing elements or enlarging the space occupied by the volume control user interface to accommodate the second volume control without obscuring existing volume controls, such as the first volume control). In some embodiments, displaying the volume control user interface including the second volume control includes retrieving and applying a previously saved volume level setting for the second application (e.g., a predetermined setting from a user profile or a volume level of the second application when it was last active), as described in greater detail below. In some embodiments, when the second application is active on the computer system and the first application is not active on the computer system, the volume control user interface includes the second volume control without including the first volume control.

By updating the volume control user interface to include volume controls for newly activated applications, the method ensures that the system efficiently reflects only currently active audio sources, reducing unnecessary interface complexity and computation. This approach optimizes resource usage by eliminating overhead associated with persistently rendering controls for applications that are not yet active, thereby improving the overall performance of the computer system and extending battery life, and reduces the opportunities for user error.

In some embodiments, displaying the volume control user interface including the first volume control and the second volume control includes, in accordance with a determination that a last used volume level of the second application is a first respective volume level (e.g., the volume level of game application 916 shown by volume control element 932 being the last used volume level before game application 916 was made inactive in FIG. 9G), the volume level of the second application is the first respective volume level, as illustrated by audio management panel 726 in FIG. 9J by computer system 101 setting the volume level of game application 916, upon making game application 916 active, to the same volume level (e.g., the last used volume level) of game application 916 when game application 916 was made inactive by computer system 101 (e.g., as shown in FIG. 9G).

In some embodiments, the last used volume level of the second application is the most recent volume level that was applied to the second application before it ceased playback, was made inactive (e.g., was closed), or was switched away from in a previous session. In some embodiments, the last used volume level shares one or more characteristics with the retained respective volume level for the first application described above. In some embodiments, in response to detecting the first event, the computer system automatically applies the same volume setting the user (or the system) had previously assigned to the second application (e.g., the first respective volume level) upon activating the second application (e.g., after it was previously made inactive or from an earlier session). In some embodiments, the computer system retrieves the stored first respective volume level from a user-specific profile or data structure (e.g., as described above) and applies the first respective volume level to the second application as soon as it becomes active. In some embodiments, the computer system presents a prompt that is selectable to confirm the volume level being reloaded from a prior session (e.g., a prompt requiring the user to confirm setting the volume level to the first respective volume level). In some embodiments, displaying the volume control user interface including the first and second volume controls, wherein the second volume control is set to the first respective volume level, includes visually indicating (e.g., via the second volume control) the current volume level (e.g., the first respective volume level) for the audio output of the second application.

In some embodiments, when the volume level was set to a specialized audio configuration (e.g., equalizer profile or spatial audio setting) before the second application was made inactive (e.g., a last used audio configuration), the computer system restores the specialized audio configuration for the second application upon being made active (e.g., re-initiating the second application) and optionally visually indicates the restored specialized audio configuration (e.g., via one or more of the methods described herein). In some embodiments, displaying the volume control user interface including the first volume control and the second volume control includes, in accordance with a determination that the last used volume level of the second application is a second respective volume level different from the first respective volume level (e.g., the volume level of music application 914 shown by volume control element 726b being the last used volume level before music application 914 was made inactive in FIG. 9K), the volume level of the second application is the second respective volume level, such as computer system 101 setting the volume level of music application 914, upon making music application 914 active after making music application inactive in FIG. 9K, to the same volume level (e.g., the last used volume level) of music application 914 when music application 914 was made inactive by computer system 101 (as shown in FIG. 9K), if music application 914 did not have persistent volume controls (e.g., as shown in FIG. 9L). In some embodiments, the second respective volume level shares one or more characteristics with the first respective volume level.

By automatically restoring the previously set volume level of the first application upon re-activation, the method decreases repetitive user input (and, consequently, repetitive system operations) and reduces the need for recalibration. This approach helps conserve processing power and battery life, thereby improving the overall efficiency of the computer system's audio management.

In some embodiments, while displaying, via the one or more display generation components, the volume control user interface, in accordance with a determination that a second application, different from the first application, that satisfies one or more second criteria, is currently active on the computer system (e.g., music application 914 being active on computer system 101 in FIG. 9K), the computer system displays, via the one or more display generation components, the volume control user interface including a second volume control for controlling a volume level of the second application, such as computer system 101 displaying volume control user interface 930 including volume control element 726b for controlling the volume level of music application 914 in FIG. 9K.

In some embodiments, the second application shares one or more characteristics with one or more applications described above. In some embodiments, the one or more second criteria share one or more characteristics with the one or more first and/or second criteria described above. In some embodiments, displaying the volume control user interface including the second volume control for controlling the volume level of the second application shares one or more characteristics with displaying one or more volume controls described above. In some embodiments, the second volume control for controlling the volume level of the second application shares one or more characteristics with one or more volume controls described above. In some embodiments, the volume level of the second application shares one or more characteristics with one or more volume levels described above.

In some embodiments, the one or more second criteria are satisfied when the second application is in a predetermined list of applications for which the computer system displays a volume control in the volume control user interface irrespective of whether or not the application is active on the computer system. For example, music or video applications and/or real-time communication applications satisfy the one or more second criteria. In some embodiments, one or more system processes satisfy the one or more second criteria, such as a system process for presenting audio associated with a virtual display, as described in more detail below.

In some embodiments, while displaying, via the one or more display generation components, the volume control user interface, in accordance with a determination that the second application that satisfies the one or more second criteria is not currently active on the computer system (e.g., music application 914 being inactive on computer system 101 in FIG. 9L), the computer system displays, via the one or more display generation components, the volume control user interface including the second volume control for controlling the volume level of the second application, such as computer system 101 displaying volume control user interface 930 including volume control element 726b for controlling the volume level of music application 914 in FIG. 9L. In some embodiments, displaying the volume control user interface including the second volume control when the second application is not currently active on the computer system refers to a scenario in which the computer system displays the dedicated volume control for the second application, even though the second application is not actively running (and/or producing audio). In some embodiments, the computer system visually distinguishes (e.g., by highlighting or labeling) volume controls for inactive applications from volume controls for active applications. In some embodiments, the second volume control is operable to receive one or more inputs instructing the computer system to set the volume level for the second application while the second application is inactive, and upon initiating the second application, the computer system applies the volume level consistent with the one or more inputs. In some embodiments, the computer system does not display volume control elements for applications that do not satisfy the one or more second criteria, such as the first application, when these applications are not active on the computer system, as described above with respect to the first application.

By providing a persistent volume control for the second application even when it is not actively running, the method reduces overhead otherwise needed to re-display or re-check the volume each time the second application becomes active. This approach decreases redundant processing, conserves system resources, and helps extend battery life by streamlining how audio settings are managed across application states.

In some embodiments, the system volume control element is concurrently displayed, via the one or more display generation components, with a control user interface, such as computer system 101 displaying system volume control element 716e concurrently with control user interface 716 in FIG. 9A. In some embodiments, the control user interface shares one or more characteristics with the control user interface described with reference to method 800. In some embodiments, the control user interface is a user interface of an operating system of the computer system. In some embodiments, the control user interface is a virtual interface (or a component of a virtual interface) through which users can access, configure, and/or manipulate various features or settings of the computer system. In some embodiments, concurrently displaying the system volume control with the control user interface refers to both interface components being visible and interactive at the same time within the computer system's display environment (e.g., enabling a user to access and operate each element without having to switch or close one in order to see or use the other). In some embodiments, the system volume control element appears as an overlay or widget alongside the control user interface. In some embodiments, the system volume control element is integrated into a panel or menu that is part of the control user interface. In some embodiments, the system volume control element and the control user interface are each rendered at a distinct position in a three-dimensional environment (e.g., yet both remain visible within the field of view of the user).

By concurrently displaying the system volume control element with the control user interface, the method reduces extraneous transitions between separate interfaces, thereby decreasing CPU usage and power consumption. This approach also minimizes the time spent rendering multiple overlays or switching between elements and reduces the user inputs needed to access the volume control user interface, thereby extending battery life and improving system responsiveness.

In some embodiments, in response to detecting the first input, in accordance with a determination that one or more second criteria (e.g., different from the one or more first criteria) are satisfied, including the criterion that is satisfied when the first application of the computer system is currently active on the computer system (e.g., music application 914 being active on computer system 101 in FIG. 9B), the computer system displays, via the one or more display generation components, a spatial audio control user interface that includes a first spatial audio control for controlling a spatial audio mode of the first application concurrently with the volume control user interface, such as computer system 101 displaying spatial audio control user interface 940 that includes spatial audio control 726e for controlling a spatial audio mode of music application 914 concurrently with volume control user interface 930.

In some embodiments, the one or more second criteria share one or more characteristics with the one or more first and/or second criteria described above. Some examples of the one or more second criteria include, but are not limited to, whether the first application is currently active on the computer system, the first application is actively generating audio output (e.g., playing music or video content), the first application is flagged for spatial audio in system or user preferences, the system is connected to hardware that supports multi-channel audio (e.g., specialized headphones or speakers), the first application is launched in a mode that requires positional audio (e.g., VR or AR), policy settings dictate the use of spatial audio for a certain application (e.g., application guidelines mandating spatial audio in certain situations), user permissions allow the first application to manipulate advanced audio settings, the system detects head-tracking data relevant to three-dimensional audio (e.g., motion sensors in a VR headset), the user or system has globally enabled a spatial audio toggle for all supported applications (e.g., a master switch), and/or other criteria that are relevant to whether the system is able to output spatial audio for the first application.

In some embodiments, the spatial audio control user interface is a specialized user interface element that provides one or more options and/or controls for managing three-dimensional or immersive audio settings (e.g., toggling spatial audio modes, adjusting positional parameters, and/or configuring head-tracking or other advanced audio processing features). In some embodiments, the spatial audio control user interface is operable by a user to select among multiple spatial audio modes (e.g., “stereo” or “off,” “fixed,” and/or “head-tracked”), as described in greater detail below. In some embodiments, the first spatial audio control is a dedicated user interface element within the spatial audio control user interface that specifically governs the spatial or immersive audio mode of the first application. In some embodiments, the first spatial audio control provides a toggle or switch for enabling or disabling spatial audio specifically for the first application, regardless of system-wide (or other application) audio settings. In some embodiments, the first spatial audio control is selectable to present (e.g., presenting one or more modes in a separate panel, tab, or interface in response to a user selection of the first spatial audio control) spatial audio in one of a plurality of available spatial audio modes (e.g., “off,” “fixed,” and/or “head-tracked”), as described in greater detail below.

In some embodiments, the computer system retains previously specified spatial audio settings so that when the computer system restarts an application or resumes a session, the system re-applies the previously specified settings automatically (e.g., sharing one or more characteristics with retaining previously specified volume levels, as described above). In some embodiments, displaying the spatial audio control user interface concurrently with the volume control user interface refers to the computer system rendering both interfaces at the same time such that each remains visible and accessible from a point of view of the user. In some embodiments, the spatial audio control user interface and the volume control user interface occupy distinct regions of the display (or the three-dimensional environment). In some embodiments, the computer system renders the spatial audio control user interface and the volume control user interface within a larger, unified interface (e.g., the central audio management panel). In some embodiments, the central audio management panel is a unified user interface that consolidates multiple audio controls (e.g., volume levels, spatial audio settings, output devices, and/or ambient noise) into a single, cohesive display. In some embodiments, the computer system concurrently displays, via the central audio management panel, one or more of the audio control interfaces (e.g., the spatial audio control user interface, the volume control user interface, and/or other control user interfaces described herein) or displays a tabbed layout, with each tab dedicated to a different audio control interface. In some embodiments, when the one or more first and second criteria are satisfied, the computer system displays the volume control user interface including the first volume control and the spatial audio control user interface including the first spatial audio control (e.g., all within the central audio management panel).

In some embodiments, in response to detecting the first input, in accordance with a determination that the one or more second criteria are not satisfied (e.g., due to game application 916 being inactive on computer system 101 as in FIG. 9H), the computer system displays, via the one or more display generation components, the spatial audio control user interface concurrently with the volume control user interface without displaying the first spatial audio control for controlling the spatial audio mode of the first application in the spatial audio control user interface, such as if computer system 101 displayed spatial audio control user interface 930 (e.g., in response to detecting hand 702a performing the air pinch gesture while attention 714 is directed at system volume control element 716e, as in FIG. 9A) without displaying spatial audio control element 932 for controlling the spatial audio mode of game application 916 in spatial audio control user interface 940, as demonstrated by audio management panel 726 in FIG. 9H. In some embodiments, when the one or more first criteria are satisfied and the one or more second criteria are not satisfied, the computer system displays the volume control user interface including the first volume control and the spatial audio control user interface not including the first spatial audio control (e.g., all within the central audio management panel). In some embodiments, when the one or more second criteria are not satisfied, the spatial audio control user interface includes general or system-wide spatial audio options (e.g., a master switch or hardware-level three-dimensional audio settings) and optionally one or more spatial audio controls for one or more applications other than the first application (provided the one or more applications satisfy respective one or more criteria similar to the one or more second criteria).

By concurrently displaying both the spatial audio control user interface and the volume control user interface, the method reduces processing overhead and screen-rendering cycles that would otherwise result from toggling between separate interfaces. Additionally, omitting the first spatial audio control when it is not applicable conserves computational resources and extends battery life by avoiding the rendering and management of unnecessary UI components (as well as preventing inadvertent user inputs).

In some embodiments, the first spatial audio control includes one or more selectable options for setting the spatial audio mode of the first application to at least one of a fixed mode or a head-tracked mode, such as spatial audio mode elements 948a through 948c that are selectable to set the spatial audio mode of game application 916 to a “Fixed” mode (e.g., spatial audio mode element 948b) or a “Head-Tracked” mode (e.g., spatial audio mode element 948c) in FIG. 9S. In some embodiments, the one or more selectable options refer to a set of user-accessible choices within the first spatial audio control, each corresponding to a distinct manner of rendering three-dimensional sound for the first application (e.g., “off,” “fixed mode,” and/or “head-tracked mode”). In some embodiments, the computer system displays the one or more selectable options in response to detecting an input directed to the first spatial audio control (e.g., within the first spatial audio control or as a separate panel or sub-menu alongside or overlaid on the first spatial audio control). In some embodiments, when the first spatial audio control is set to “off,” the computer system disables spatial audio processing (e.g., the computer system renders audio output for the first application in a standard format, such as stereo or mono). In some embodiments, when the first spatial audio control is set to the “fixed mode,” the computer system spatializes the audio output of the first application to a single, static position and/or orientation relative to the user (e.g., rather than dynamically shifting as the user moves), as described in greater detail below. In some embodiments, when the first spatial audio control is set to the “head-tracked” mode, the computer system spatializes the audio output of the first application in a manner that is adapted to head movements of the user (and optionally other user movements) to provide an immersive three-dimensional sound field that changes orientation as the user looks and/or moves around, as described in greater detail below.

In some embodiments, while displaying, via the one or more display generation components, the spatial audio control user interface including the first spatial audio control (e.g., computer system 101 displaying spatial audio control user interface 940 including spatial audio control element 942 in FIG. 9S), the computer system detects, via the one or more input devices, a user selection of one of the one or more selectable options for setting the spatial mode of the first application, such as computer system 101 detecting hand 702a perform the air pinch gesture while attention 714 is directed to spatial audio mode element 948b in FIG. 9S. In some embodiments, detecting the user selection of one of the one or more selectable options refers to the computer system detecting an action performed by the user (e.g., via the one or more input devices) that indicates a choice among the available spatial audio modes for the first application. In some embodiments, the user selection includes one or more of tapping, clicking, or air pinching on a graphical button or toggle that corresponds to the desired spatial audio mode, voice commands, and/or another user input which is detectable by the computer system to indicate which of the one or more selectable options the user has selected.

In some embodiments, in response to detecting the user selection, in accordance with a determination that the user selection corresponds to a request to set the spatial audio mode of the first application to the fixed mode (e.g., computer system 101 detects attention 714 directed to spatial audio mode element 948b when hand 702a performs the air pinch gesture, as in FIG. 9S), the computer system sets the spatial audio mode of the first application to the fixed mode, such as computer system 101 setting the spatial audio mode of game application 916 to the “Fixed” mode in FIGS. 9T-9U. In some embodiments, setting the spatial audio mode of the first application to the fixed mode refers to the computer system applying a configuration in which the audio output is dynamically adjusted based on the changing orientation and/or viewpoint of the user (e.g., based on user head and/or body movements) to create the perception that the audio output corresponding to the first application remains anchored to a specific location within the environment (e.g., a location corresponding to the first application within a three-dimensional environment). In some embodiments, when the spatial audio mode of the first application is set to the fixed mode, the computer system continuously updates audio rendering parameters in real time (e.g., using data from head-tracking sensors, such as gyroscopes, accelerometers, infrared markers, and/or other appropriate input devices described herein). In some embodiments, when the spatial audio mode of the first application is set to the fixed mode, the computer system outputs audio such that it seems to originate from a first location of the first application within the three-dimensional environment with respect to a first viewpoint of a user of the computer system, and, upon the user transitioning to a second viewpoint different from the first viewpoint, the audio still sounds like it originates from the first location within the three-dimensional environment (e.g., causing the perceived direction and/or distance of the audio to shift relative to the new viewpoint of the user).

In some embodiments, in response to detecting the user selection, in accordance with a determination that the user selection corresponds to a request to set the spatial audio mode of the first application to the head-tracked mode (e.g., if computer system 101 detected attention 714 directed to spatial audio mode element 948c, rather than spatial audio mode element 948b, when hand 702a performs the air pinch gesture in FIG. 9S) the computer system sets the spatial audio mode of the first application to the head-tracked mode, such as computer system 101 setting the spatial audio mode of game application 916 to the “Head-Tracked” mode in FIGS. 9V-9W. In some embodiments, setting the spatial audio mode of the first application to the head-tracked mode refers to the computer system applying a configuration in which the three-dimensional audio output of the first application remains anchored to the head and/or viewpoint of the user (e.g., rather than to a location in the environment), unaffected by the head and/or body movements of the user (e.g., to provide a stable listening perspective where sounds do not shift position relative to the listener). In some embodiments, when the spatial audio mode of the first application is set to the head-tracked mode, the computer system outputs audio so that it continues to sound like it is playing from a constant position relative to the viewpoint of the user (e.g., a position at or near the first application relative to a viewpoint of the user when the computer system detected the user selection), such that when the user transitions from a first viewpoint to a second viewpoint within the three-dimensional environment, the audio still seems to originate from the same direction and/or the same distance relative to the head of the user (e.g., the location in the three-dimensional environment where the audio seems to originate from shifts with the movements of the user). By allowing the user to switch between fixed and head-tracked modes on demand, the method avoids unnecessary spatial audio computations when they are not desired, thereby reducing processing overhead and conserving battery life.

In some embodiments, the first spatial audio control includes a selectable option that, when selected, causes the computer system to change a state of (e.g., enable or disable) spatial audio for the first application, such as spatial audio control element 942 including spatial audio mode element 948a in FIG. 9S. In some embodiments, when the computer system detects a selection of the selectable option corresponding to enabling the spatial audio for the first application, the computer system displays, via the one or more display generation components, the one or more selectable options for setting the spatial mode of the first application. In some embodiments, when the computer system detects a selection of the selectable option corresponding to enabling the spatial audio for the first application, the computer system automatically applies a spatial audio mode (e.g., fixed or head-tracked) to the audio of the first application (e.g., based on the spatial mode of the first application when spatial audio was last enabled for the first application or based on a predefined setting for the first application). In some embodiments, when the computer system detects a selection of the selectable option corresponding to disabling the spatial audio for the first application, the computer system outputs audio corresponding to the first application in a non-spatial mode (e.g., stereo).

In some embodiments, the computer system displays, via the one or more display generation components, a global toggle (e.g., master switch) that the computer system employs to activate or deactivate the system-wide capability for three-dimensional or immersive audio processing. In some embodiments, when global spatial audio is enabled, the computer system automatically applies a fixed mode, head-tracking mode, or another spatial audio mode across supported applications. In some embodiments, enabling global spatial audio does not automatically cause the computer system to apply spatial audio to every application (e.g., the first application), but rather allows individual user selections (e.g., a user selection of one of the one or more selectable options for setting the spatial mode of the first application) or the retrieval of previously stored preferences (e.g., when the first application had spatial audio enabled during a previous session). In some embodiments, when global spatial audio is disabled for the computer system, the first spatial audio control (and other spatial audio controls) become disabled (e.g., grayed out) or is omitted altogether from the spatial audio control user interface (e.g., the criterion that is satisfied when the spatial audio is enabled for the computer system is not satisfied). In some embodiments, disabling global spatial audio for the computer system causes the computer system to automatically force multiple (or, optionally, all) active applications to revert to standard stereo or mono output.

By providing a global toggle that enables or disables spatial audio across the system, the method prevents unnecessary spatial audio processing (e.g., for applications that do not benefit from it), thereby reducing CPU load and extending battery life, and reduces the input needed to turn spatial audio on or off for multiple applications at once. In addition, enabling spatial audio on a per-application basis further conserves resources by applying spatial audio only where needed, thus improving the overall efficiency of the computer system's audio management.

In some embodiments, in response to detecting the first input, in accordance with a determination that one or more third criteria, different from the one or more first criteria or the one or more second criteria, are satisfied, including a criterion that is satisfied when a virtual display of a second computer system is currently active on the computer system (e.g., virtual display 990 being active on computer system 101 in FIG. 9Z), the computer displays, via the one or more display generation components, the volume control user interface including a second volume control for controlling a volume level of the virtual display of the second computer system and the spatial audio control user interface including a second spatial audio control for controlling a spatial audio mode of the virtual display of the second computer system, such as if computer system 101 displayed volume control user interface 930 and spatial audio control user interface 940 (e.g., in response to detecting hand 702a performing the air pinch gesture while attention 714 is directed at system volume control element 716e, as in FIG. 9A) including volume control element 936 and spatial audio control element 943 for controlling the volume level and spatial audio mode of virtual display 990 in volume control user interface 930 and spatial audio control user interface 940, as demonstrated by audio management panel 726 in FIG. 9Z. In some embodiments, the virtual display of the second computer system is a representation or instance of the graphical output (e.g., a streamed remote desktop session) of the second computer system (e.g., a computer system that is different from and in communication with the first computer system) that is rendered by, or otherwise accessible through, the first computer system (e.g., displayed by the one or more display generation components in communication with the first computer system).

Some examples of the one or more third criteria include, but are not limited to, whether the first computer system is currently streaming a remote desktop from the second computer system (e.g., a virtual display session is currently active), the user has explicitly requested viewing and/or controlling the screen of the second computer system, the second computer system has granted permission for its display and/or audio to be mirrored, the user or system policies allow remote or virtual displays to be shown and/or allow their audio to be output, the second computer system is not in a sleep or hibernation state, and/or the second computer system is currently generating an audio output.

In some embodiments, the first computer system streams, emulates, and/or mirrors the virtual display of the second computer system and the virtual display is operable by a user of the first computer system (e.g., via mouse clicks, keyboard stokes, touch gestures, and/or air gestures) to interact with an interface of the second computer system as though it was locally displayed. In some embodiments, the first computer system integrates the virtual display of the second computer system into a three-dimensional environment where the interface of the second computer system appears as a floating (or curved) screen within the field of view of the user. In some embodiments, the first computer system outputs an audio output of the virtual display (e.g., application sounds rendered on the second computer system or operating system notifications associated with the second computer system). In some embodiments, displaying the volume control user interface (and/or the spatial audio control user interface) including the second volume control (and/or the second spatial audio control) shares one or more characteristics with displaying the volume control user interface including one or more volume controls (and/or spatial audio controls) described above. In some embodiments, the second volume control for controlling the volume level of the virtual display of the second computer system shares one or more characteristics with one or more volume controls for controlling the volume level of one or more applications described above. In some embodiments, the second spatial audio control for controlling the spatial audio mode of the virtual display of the second computer system shares one or more characteristics with the first spatial audio control for controlling the spatial audio mode of the first application described above.

In some embodiments, in response to detecting the first input, in accordance with a determination that the one or more third criteria are not satisfied (e.g., when virtual display 990 is not active on computer system 101, as in any of FIGS. 9A-9Y), the computer system displays, via the one or more display generation components, the volume control user interface without displaying the second volume control for controlling the volume level of the virtual display of the second computer system in the volume control user interface, such as displaying volume control user interface 930 without displaying volume control element 936 for controlling the volume level of virtual display 990 in volume control user interface 930 in FIG. 9B.

In some embodiments, in response to detecting the first input, in accordance with the determination that the one or more third criteria are not satisfied (e.g., when virtual display 990 is not active on computer system 101, as in any of FIGS. 9A-9Y), the computer system displays the spatial audio control user interface without displaying the second spatial audio control for controlling the spatial audio mode of the virtual display of the second computer system in the spatial audio control user interface, such as displaying spatial audio control user interface 940 without displaying spatial audio control element 943 for controlling the spatial audio mode of virtual display 990 in spatial audio control user interface 940 in FIG. 9B. In some embodiments, displaying the volume control user interface without displaying the second volume control in the volume control user interface shares one or more characteristics with displaying the volume control user interface without displaying one or more volume controls in the volume control user interface described above.

By selectively displaying or forgoing displaying volume and/or spatial controls for the virtual display of the second computer system when the virtual display is active, the method avoids processing overhead that would otherwise be spent on managing audio for an inactive or non-existent source and reduces the opportunity for user errors. This approach reduces system resource consumption and battery usage.

In some embodiments, the volume control user interface is included in a control user interface for the computer system displayed, via the one or more display generation components, at a first location in a three-dimensional environment (e.g., at a first location relative to a viewpoint of the user), such as computer system 101 displaying volume control user interface 930 in control user interface 716 (e.g., overlaid on control user interface 716 as in FIG. 9B) at virtual source location 980 in three-dimensional environment 704 in FIGS. 9X-9Y. In some embodiments, the volume control user interface being included in the control user interface refers to the volume control user interface being a component or section within user interface that manages various system and/or application functions.

In some embodiments, the three-dimensional environment shares one or more characteristics with the three-dimensional environment described with reference to method 800. In some embodiments, the first location in the three-dimensional environment is a designated spatial coordinate, point, or region within the virtual or augmented space presented by the computer system. In some embodiments, the first location in the three-dimensional environment serves as a reference point for rendering and/or perceiving certain interactive elements (e.g., the control user interface and/or the volume control user interface) and, in the context of spatial audio, functions as a virtual origin for sound output. In some embodiments, the first location is determined relative to an initial viewpoint of the user (e.g., directly in front of the user when the system first boots and/or when the control user interface or an application launches). In some embodiments, the first location is set by the user (e.g., via a gesture or command) to reposition the control user interface within the three-dimensional environment. In some embodiments, the first location is world-locked (e.g., does not move within the three-dimensional environment based on changes in the viewpoint of the user) or viewpoint-locked (e.g., moves within the three-dimensional environment with the viewpoint of the user).

In some embodiments, in accordance with a determination that a spatial audio mode of a function controlled via the control user interface is set to the fixed mode (e.g., the spatial audio mode of a music function controlled via control user interface 716 being set to the “Fixed” mode, as in FIGS. 9X-9Y), the computer system outputs audio corresponding to the function controlled via the control user interface such that the audio seems to originate from the first location in the three-dimensional environment, such as computer system 101 outputting audio corresponding to the music function controlled via control user interface 716 such that the audio seems to originate from virtual source location 980 in three-dimensional environment 704 in FIGS. 9X-9Y. In some embodiments, a function controlled via the control user interface refers to a system feature and/or application whose operational parameters (e.g., those related to audio output) are adjustable, controllable, and/or otherwise manipulatable through interactive elements in the control user interface (e.g., toggling notification sounds on/off and/or pausing or resuming an audio output of a music streaming service). For example, the function is media playback controlled via a respective user interface element of the controls user interface described with reference to method(s) 800 and/or 1000. For example, a function controlled via the control user interface is optionally a system-level feature (e.g., notifications) and/or an application-specific feature (e.g., an individual application's playback channel).

In some embodiments, outputting audio corresponding to the function controlled via the control user interface such that the audio seems to originate from the first location when the spatial audio mode is set to the fixed mode refers to presenting the spatial audio so that it sounds like it is playing from the position of the control user interface (the first location), irrespective of any changes in the viewpoint of the user and/or head orientation. In some embodiments, while the control user interface is not being displayed, the computer system outputs the spatial audio for the function as though playing from the location at which the control user interface would be displayed if the computer system was displaying the control user interface. In some embodiments, the computer system calculates a single reference point (e.g., aligned with the first location) and consistently applies it as the origin for sound output (e.g., such that the user turning their head does not alter the perceived source of the audio). In some embodiments, the function is not associated with another user interface element being displayed by the computer system.

By anchoring the audio of the function controlled via the control user interface to a fixed location in the three-dimensional environment, the method avoids the continual recalculations and sensor polling necessary for real-time head-tracked audio. This approach reduces CPU overhead and power consumption, thereby improving the computer system's overall performance and battery life.

In some embodiments, in response to detecting the first input, in accordance with a determination that one or more second criteria, different from the one or more first criteria, are satisfied, including a criterion that is satisfied when a first audio output device is currently available to output audio (e.g., “Device A” being available to output audio in FIG. 9M), the computer system displays, via the one or more display generation components, an audio output device control user interface that includes a first audio output device control for controlling an audio output of the first audio output device concurrently with the volume control user interface, such as computer system 101 displaying output device control user interface 950 including output control element 726g for controlling the audio output of “Device A” concurrently with volume control user interface 930 in FIG. 9M. In some embodiments, the first audio output device refers to a specific hardware or virtual component capable of producing audible sound (e.g., speakers, headphones, and/or a virtual audio channel) that is in communication with the computer system to output audio.

Some examples of the one or more second criteria include, but are not limited to, whether the first audio output device is connected to the computer system (e.g., plugged into a headphone jack or USB port), a Bluetooth or other wireless protocol is currently established (e.g., pairing confirmed), the first audio output device is recognized and initialized by the operating system (e.g., driver loaded successfully), the first audio output device has sufficient power or battery remaining (e.g., wireless headset charge level above a threshold), the first audio output device is not in a muted or standby state, user and/or system permissions allow audio routing through the first audio output device (e.g., enterprise device access policies), network connectivity is available for network-based audio devices (e.g., Wi-Fi speakers), the firmware or drivers of the first audio output device match compatibility requirements, the first audio output device is not restricted by user profiles or parental controls (e.g., limited device usage times), and/or a hardware switch on the first audio output device is in an “on” or “unlocked” position (e.g., a toggle on a headset). In some embodiments, the first audio output device being currently available to output audio refers to the computer system recognizing it is able to route audio to the first audio output device under the existing hardware and/or software configuration (e.g., one or more of the examples described above with respect to the one or more second criteria).

In some embodiments, the audio output device control user interface is a specialized user interface element presented by the computer system that provides one or more options and/or controls (e.g., the first audio output device control) for selecting, configuring, and/or managing one or more audio output devices recognized by the system (e.g., the first audio output device). In some embodiments, the audio output device control user interface includes an audio output device control for each audio output device accessible to the computer system (e.g., able to reproduce audio generated by the computer system). In some embodiments, each audio output device control in the audio output device control user interface is shared by all applications (e.g., the first application, the second application, and/or other applications of the computer system) that are able to produce audio. In some embodiments, the first audio output device control is a dedicated user interface element within the audio output device control user interface that specifically manages the audio output settings (e.g., availability, volume level, balance, equalizer settings, and/or other advanced features) for the first audio output device. In some embodiments, the first audio output device control is selectable to enable or disable the first audio output device (e.g., to cause the system to route audio to or away from the first audio output device). In some embodiments, the computer system references user preferences and/or previous settings stored by the computer system to automatically restore a last known volume level and/or configuration associated with the first audio output device when the first audio output device becomes active (or is enabled to route audio through the first audio output device).

In some embodiments, the audio output device control user interface and the volume control user interface (and/or the spatial audio control user interface) each occupy a distinct region of the display (or the three-dimensional environment). In some embodiments, the computer system renders the audio output device control user interface and the volume control user interface (and/or the spatial audio control user interface) within a respective interface (e.g., the central audio management panel). In some embodiments, when the one or more first criteria, the one or more second criteria associated with the spatial audio control user interface, and the one or more second criteria associated with the audio output device control user interface are satisfied, the computer system displays the volume control user interface including the first volume control, the spatial audio control user interface including the first spatial audio control, and the audio output device control user interface including the first audio output device control (e.g., all within the central audio management panel). In some embodiments, the computer system rearranges and/or resizes the audio output device control user interface to include the first audio output device control alongside other audio output device controls. In some embodiments, in accordance with a determination that the one or more second criteria are satisfied with respect to a second audio output device different from the first audio output device, the computer system displays a second audio output device control for controlling the audio output of the second audio output device in manner similar to the above-described manner of displaying the first audio output device control in accordance with the determination that the one or more second criteria are satisfied with respect to the first audio output device. In some embodiments, the computer system displays the second audio output device control without displaying the first audio output device control. In some embodiments, the computer system displays the first audio output device control without displaying the second audio output device control. In some embodiments, the computer system displays the second audio output device control concurrently with displaying the first audio output device control.

In some embodiments, in response to detecting the first input, in accordance with a determination that the one or more second criteria are not satisfied due to the first audio output device not being currently available to output audio (e.g., if “Device A” was not available to output audio in FIG. 9M), the computer system displays, via the one more display generation components, the audio output device control user interface concurrently with the volume control user interface without displaying the first audio output device control for controlling the audio output of the first audio output device in the audio output device control user interface, such as computer system 101 displaying output device control user interface 950 without displaying output control element 726g for controlling the audio output of “Device A” concurrently with volume control user interface 930, if “Device A” was not available to output audio in FIG. 9M.

In some embodiments, displaying the audio output device control user interface concurrently with the volume control user interface (and/or the spatial audio control user interface) without displaying the first audio output device control refers to the computer system displaying both interfaces simultaneously (e.g., within the central audio management panel, any suitable consolidated interface, or as separate interfaces) without the dedicated control for managing audio output device settings for the first audio output device. In some embodiments, when the one or more first criteria and the one or more second criteria associated with the spatial audio control user interface are satisfied and the one or more second criteria associated with the audio output device control user interface are not satisfied, the computer system displays the volume control user interface including the first volume control, the spatial audio control user interface including the first spatial audio control, and the audio output device control user interface not including the first audio output device control (e.g., all within the central audio management panel). In some embodiments, when the one or more second criteria are not satisfied, rather than omitting the first audio output device control, the computer system displays the first audio output device control within the audio output device control user interface with one or more visual characteristics associated with the device existing but being currently inactive and/or inaccessible (e.g., grayed-out, labeled, and/or not selectable).

By conditionally displaying the first audio output device control when the first audio output device is available to output audio, the method prevents unnecessary rendering and management of device-specific controls, thereby reducing CPU load and saving power and reducing the opportunities for user errors. This approach limits audio management features to those actually pertinent, ultimately improving both performance and battery life of the computer system.

In some embodiments, while displaying, via the one or more display generation components, the volume control user interface including the system volume control element and the first volume control (e.g., computer system 101 displaying volume control user interface 930 including volume control element 726a (and/or system volume control element 716e) and volume control element 932) the computer system detects, via the one or more input devices, a second input directed to the first volume control corresponding to a request to modify the volume level of the first application to a respective volume level, such as computer system 101 detecting hand 702a perform an air pinch-and-drag gesture while attention 714 is directed to volume control element 932 (and/or volume slider 934a) in FIGS. 9C-9D. In some embodiments, the second input directed to the first volume control corresponding to the request to modify the volume level of the first application to a respective volume level refers to a user-initiated or system-recognized action (e.g., a tap, click, air gesture, and/or voice command) targeting or directed toward the user interface element for the volume level of the audio output of the first application that instructs the computer system to adjust the audio output of the first application to a particular loudness and/or amplitude setting (or adjust the audio output by a respective magnitude of loudness and/or amplitude). In some embodiments, the second input is a click-and-drag motion (or an air pinch-and-drag gesture) on a dedicated slider or dial within the first volume control. In some embodiments, the second input is a click-and-drag action or an air gesture (e.g., a pinch-and-drag) on a slider or dial within the volume control user interface (e.g., at least a portion of the first volume control). In some embodiments, the second input is a tap, click, long press, short air pinch, long air pinch, or a similar input on an increment or decrement button associated with the volume control of the first application. In some embodiments, the second input is a voice command directed to the first application (e.g., “Set the volume of the first application to 50%”) or a general voice command detected while the first application is in focus (e.g., “Set volume to 50%”). In some embodiments, the second input involves selecting a preset volume profile (e.g., “music mode” or “meeting mode”) that instructs the computer system to configure the volume level of the first application to a predetermined setting. In some embodiments, the second input is triggered by hardware control (e.g., a physical knob) mapped by the system to the volume control of the first application (e.g., detecting an input from the physical knob while the first application is in focus).

In some embodiments, in response to detecting the second input, the computer system modifies the volume level of the first application to the respective volume level in accordance with the second input without modifying the volume level of the computer system, such as computer system 101 modifying the volume level of game application 916 to the volume level shown in FIG. 9D in accordance with the air pinch-and-drag gesture without modifying the volume level of computer system 101 (as shown by volume element 726a) and/or the volume level of music application 914 (as shown by volume element 726b). In some embodiments, modifying the volume level of the first application to the respective volume level in accordance with the second input and without modifying the volume level of the computer system (and optionally without modifying the volume level of one or more applications different from the first application) refers to the computer system setting the volume level of the first application to the respective volume level and leaving the overall system volume (and optionally the volumes of one or more applications different from the first application) unaltered. In some embodiments, setting the volume level of the first application to the respective volume level refers to the process by which the computer system applies a new audio amplitude or loudness value to the audio output of the first application, such that any subsequent audio playback from the first application occurs at the updated level. In some embodiments, in response to detecting the second input (and optionally before or after setting the volume level of the first application to the respective volume level), the computer system updates the volume level displayed in the first volume control to reflect the audio output for the first application being at the respective volume level.

As described above, in some embodiments, setting the volume level of the first application does not adjust the volume level of the overall system, or the volume levels of respective system processes and/or other applications running on the computer system. In some embodiments, in response to detecting the second input, the computer system updates the first volume control to reflect the respective volume level while leaving the overall system volume (e.g., the system volume control element and optionally the volume controls for one or more different applications) unaltered. In some embodiments, the second input corresponds to a request to modify one or more first characteristics of the audio output of the first application and, in response to detecting the second input, the computer system modifies the one or more first characteristics of the audio output of the first audio output without modifying one or more characteristics of the audio output of the system and/or one or more different applications (e.g., analogous to the one or more first characteristics of the audio output of the first audio output). In some embodiments, modifying the volume level of the first application to the respective volume level and without modifying the volume level of the computer system (and optionally without modifying the volume level of one or more different applications) shares one or more characteristics with setting the volume level of the first application to the respective volume level in response to detecting the second input described above. In some embodiments, when the volume control user interface includes the first volume control and a second volume control for controlling a second volume level for a second application, in response to detecting the second input, the computer system modifies the volume level of the first application to the respective volume level in accordance with the second input without modifying the volume level of the second application (e.g., and updates the first volume control to reflect the respective volume level without updating the second volume control).

By enabling per-application volume adjustments without reconfiguring the system-wide audio output, the method eliminates unnecessary inputs and recalculations that would otherwise affect all audio streams and reduces user error. This approach reduces CPU usage and helps conserve power.

In some embodiments, in response to detecting the first input, the computer system displays, via the one or more display generation components, an ambient noise control user interface concurrently with the volume control user interface (e.g., computer system 101 displaying ambient noise control user interface 960 concurrently with volume control user interface 930 in FIG. 9B), the ambient noise control user interface including one or more selectable options for setting an ambient noise mode of the computer system to at least one of an active noise cancellation mode or a passthrough mode, such as if ambient noise control user interface 960 included selectable options (e.g., in response to an input directed to ambient noise control element 726i, similar to spatial audio mode elements 948a through 948c of FIG. 9S) to set ambient noise mode 964 of the computer system to an “Active noise cancellation” mode (as in FIG. 9P) or a “Passthrough” mode (as in FIG. 9Q).

In some embodiments, the ambient noise control user interface is a specialized user interface element presented by the computer system that provides one or more options and/or controls (e.g., the one or more selectable options for setting the ambient noise mode of the computer system) for selecting, configuring, and/or managing ambient noise settings (e.g., active noise cancellation and/or passthrough features) on the computer system. In some embodiments, the one or more selectable options for setting the ambient noise mode of the computer system refer to one or more choices within the ambient noise control user interface that are selectable (e.g., via a click, tap, air pinch or other gesture, and/or voice command) to enable a different configuration for handling external or environmental sounds.

In some embodiments, the active noise cancellation mode refers to a setting where the computer system processes incoming environmental sounds and generates inverse sound waves to attenuate and/or cancel out at least portions of the ambient noise (e.g., thereby reducing the volume and/or impact of external sounds). In some embodiments, when an active audio output device does not support active noise cancellation, the computer system does not display the selectable option for setting the ambient noise mode to the active noise cancellation mode. In some embodiments, the passthrough mode refers to a setting where the computer system allows (or amplifies) external or ambient sounds through the system's audio pathway (e.g., to allow the user to remain aware of their surroundings while still listening to audio from the computer system). In some embodiments, when the passthrough mode is enabled, the computer system leverages one or more microphones (e.g., one or more of the one or more input devices) to capture outside sounds and incorporate them with the primary audio playback of the computer system. Other examples of ambient noise modes include, but are not limited to, an “off” mode (e.g., disabling special noise processing), a wind noise reduction mode (e.g., targeting low-frequency wind turbulence and/or microphone buffeting), a speech enhancement mode (e.g., filtering and/or amplifying speech frequencies), an adaptive noise cancellation mode (e.g., dynamically adjusting noise cancellation intensity based on real-time analysis of ambient sound), and/or other noise processing modes that serve a discrete purpose to the user. In some embodiments, the computer system references user preferences and/or previous settings stored by the computer system to automatically restore a previously selected ambient noise mode (and/or to restore one or more characteristics of the ambient noise mode, such as the magnitude of external sound suppression, admittance, and/or amplification), such as when initiating a user session or when audio is first output by the computer system.

In some embodiments, displaying the ambient noise control user interface concurrently with the volume control user interface (and/or the spatial audio control user interface and/or the audio output device control user interface) refers to the computer system displaying both interfaces, via the one or more display generation components, at the same time such that each remains visible and accessible from a point of view of the user. In some embodiments, the ambient noise control user interface and the volume control user interface (and/or the spatial audio control user interface and/or the audio output device control user interface) occupy different regions of the display (or the three-dimensional environment). In some embodiments, the computer system renders the ambient noise control user interface and the volume control user interface (and/or the spatial audio control user interface and/or the audio output device control user interface) within a larger, shared interface (e.g., the central audio management panel).

In some embodiments, while displaying, via the one or more display generation components, the ambient noise control user interface, the computer system detects, via the one or more input devices, a selection of one of the one or more selectable options for setting the ambient noise mode of the computer system, such as if computer system 101 detected a selection to a selectable option (e.g., similar to a selection to one of spatial audio mode elements 948a through 948c of FIG. 9S) associated with respective ambient noise mode 964 (e.g., an “Active noise cancellation” mode or a “Passthrough” mode) in FIG. 9O. In some embodiments, detecting the selection of one of the one or more selectable options for setting the ambient noise mode of the computer system shares one or more characteristics with detecting one or more inputs and/or events described above. In some embodiments, detecting the selection of one of the one or more selectable options for setting the ambient noise mode of the computer system refers to the computer system registering a user action (e.g., a click, tap, air pinch or other gesture, and/or voice command) that corresponds to a specific ambient noise mode choice (e.g., active noise cancellation, passthrough, or another mode).

In some embodiments, in response to detecting the selection, in accordance with a determination that the selection corresponds to a request to set the ambient noise mode of the computer system to the active noise cancellation mode, the computer system sets the ambient noise mode of the computer system to the active noise cancellation mode, such as the active noise cancellation mode described above, such as computer system 101 setting ambient noise mode 964 to the “Active noise cancellation” mode in FIG. 9P. In some embodiments, setting the ambient noise mode of the computer system to the active noise cancellation mode includes the computer system visually representing, via the ambient noise control user interface, an indication that the computer system is currently in the active noise cancellation mode (e.g., via a notification, highlighting or an icon change).

In some embodiments, in response to detecting the selection, in accordance with a determination that the selection corresponds to a request to set the ambient noise mode of the computer system to the passthrough mode, the computer system sets the ambient noise mode of the computer system to the passthrough mode, such as the passthrough mode of the ambient noise mode described above, such as computer system 101 setting ambient noise mode 964 to the “Passthrough” mode in FIG. 9Q. In some embodiments, setting the ambient noise mode of the computer system to the passthrough mode includes the computer system visually representing, via the ambient noise control user interface, an indication that the computer system is currently in the passthrough mode (e.g., via a notification, highlighting or an icon change).

By allowing users to selectively engage noise processing modes (e.g., active noise cancellation vs. passthrough) when needed, the method conserves processing and power resources that would otherwise be spent on unnecessary audio computations. This approach ensures battery life is extended and CPU load is reduced by matching the complexity of noise processing to the user's immediate needs.

In some embodiments, the volume level of the first application is set to a first volume level while the computer system outputs audio corresponding to the first application via a first audio output device similar to the manner of outputting audio using an audio output device described above, such as the volume level of game application 916 being the respective volume level shown by volume control element 932 while computer system outputs audio corresponding to game application 916 via “Device A,” as shown by output device control element 726g, in FIG. 9M.

In some embodiments, while displaying, via the one or more display generation components, the volume control user interface including the first volume control for controlling the volume level of the first application, the computer system detects, via the one or more input devices, a second input corresponding to a request to output audio via a second audio output device, different from the first audio output device, such as computer system 101 detecting hand 702a perform an air pinch gesture while attention 714 is directed to output device control element 726h corresponding to “Device B” in FIG. 9M. In some embodiments, detecting the second input shares one or more characteristics with detecting one or more inputs, events, and/or selections described above. In some embodiments, the second input corresponding to the request to output audio via the second audio output device refers to a user action or system event recognized by the computer system that specifically indicates switching audio playback of the first application from its current device (e.g., the first audio output device) to another distinct device (e.g., the second audio output device). Some examples of the second input corresponding to the request to output audio via the second audio output device include, but are not limited to, selecting the second audio output device in a device list (e.g., a selection of an audio output device displayed within the audio output device control user interface described above or another method for selecting the second audio output device); plugging in, pairing, or otherwise connecting the second audio output device (e.g., inserting headphones or connecting via Bluetooth); pressing a hardware control or button that cycles through audio output devices (or specifically selects the second audio output device); and/or the first audio output device becomes unavailable or stops functioning (e.g., loses power, connection, and/or encounters an error). In some embodiments, detecting the second input includes one or more of the techniques or characteristics described above with respect to the audio output device control user interface described above.

In some embodiments, in response to detecting the second input, the computer system outputs audio corresponding to the first application via the second audio output device, such as computer system 101 outputting audio corresponding to game application 916 via “Device B,” as shown by output device control element 726h, in FIG. 9N. In some embodiments, outputting audio corresponding to the first application via the second audio output device refers to the computer system, upon detecting the second input, rerouting the audio stream for the first application from its previously active audio output device (e.g., the first audio output device) to the newly selected (or, optionally, newly available) audio output device (e.g., the second audio output device) similar to the manner of outputting audio using audio output devices described above. In some embodiments, the computer system implements a fade-out/fade-in effect and/or a short pause during the switch from the first audio output device to the second audio output device. In some embodiments, in response to detecting the second input, the computer system automatically re-initializes and/or adapts one or more advanced audio features (e.g., noise cancellation and/or spatial audio) for the second audio output device.

In some embodiments, in response to detecting the second input, the computer system sets the volume level of the first application to a second volume level, different from the first volume level, such as computer system 101 setting the volume level of game application 916 to a different volume level (e.g., associated with “Device B”) shown by volume control element 932 in FIG. 9N. In some embodiments, setting the volume level of the first application to the second volume level in response to detecting the second input refers to the computer system adjusting the loudness and/or amplitude at which the audio associated with the first application is played through the second audio output device (e.g., similar to setting the volume level of the first application to the respective volume level described above). In some embodiments, the second volume level is associated with a stored preference, a default system setting for the second audio output device, a previous setting stored by the computer system corresponding to the last-known volume level of the first application when audio playback was set to the second audio output device (or a similar audio output device), or a new user-defined volume level. For example, the computer system optionally retrieves a previously saved per-device volume level for the first application (e.g., “80% on headphones” and/or “60% on speakers”) or a last-known volume level of the first application when audio playback was set to the second audio output device (e.g., when audio corresponding to the first application was last output via the second audio output device, the volume level was set to “70%”), and applies the volume level immediately when the audio output switches to the second audio output device.

In some embodiments, in response to detecting the second input, the computer system sets the volume level of the first application to the second volume level specifically for the second audio output device without modifying the volume level of the first application for the first audio output device. For example, after setting the volume level of the first application to the second volume level for the second audio output device, upon detecting a third input corresponding to a request to output audio via the first audio output device, the computer system sets the volume level of the first application to the first volume level (e.g., the last known volume level specific to the first audio output device). In some embodiments, setting the volume level of the first application to the second volume level occurs before the computer system outputs audio corresponding to the first application via the second audio output device.

By automatically applying device-specific volume levels upon switching audio outputs, the method reduces the need for the user to manually reconfigure volume each time, thereby reducing repetitive commands and potential misconfiguration. This approach decreases user interaction overhead and prevents unnecessary inputs to the volume levels of one or more applications, which preserves system resources and battery life.

It should be understood that the particular order in which the operations in methods 800 and/or 1000 have been described is merely exemplary and is not intended to indicate that the described order is the only order in which the operations could be performed. One of ordinary skill in the art would recognize various ways to reorder the operations described herein. In some embodiments, aspects/operations of methods 800 and/or 1000 may be interchanged, substituted, and/or added between these methods. For example, the system volume control element of methods 800 and/or 1000, user interface(s) of application(s) of methods 800 and/or 1000, volume control(s) of methods 800 and/or 1000, control user interface of the computer system of methods 800 and/or 1000, virtual display functionalities and controls of methods 800 and/or 1000, the three-dimensional environments of methods 800 and/or 1000, the virtual content and/or virtual objects of methods 800 and/or 1000, the interactions with the user interfaces of methods 800 and/or 1000, are optionally interchanged, substituted, and/or added between these methods. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, TWITTER IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

1. A method comprising:
at a computer system that is in communication with one or more display generation components and one or more input devices:
detecting, via the one or more input devices, an input corresponding to a request to display a control user interface of the computer system; and
in response to detecting the input corresponding to the request to display the control user interface of the computer system, displaying, via the one or more display generation components, the control user interface of the computer system, including concurrently displaying:
an immersive environment control user interface element configured to control one or more environment parameters of an immersive environment of the computer system; and
a plurality of system controls configured to control a plurality of system functions of the computer system.

2. The method of claim 1, wherein the immersive environment control user interface element includes an immersion control element for controlling a level of immersion of the immersive environment of the computer system, and wherein the method comprises:
while displaying a first immersive environment of the computer system at a first level of immersion, and while displaying the control user interface of the computer system, including the immersive environment control user interface element, including the immersion control element, detecting, via the one or more input devices, an input directed to the immersion control element, wherein the input corresponds to a request to change a level of immersion of the first immersive environment from the first level of immersion to a second level of immersion that is different from the first level of immersion; and
in response to detecting the input directed to the immersion control element, changing the level of immersion of the first immersive environment from the first level of immersion to the second level of immersion in accordance with the input directed to the immersion control element.

3. The method of claim 1, wherein the immersive environment control user interface element includes an immersive environment volume control element for controlling a volume level of the immersive environment of the computer system, and wherein the method comprises:
while displaying a first immersive environment of the computer system, while presenting audio associated with the first immersive environment at a first volume level, and while displaying the control user interface of the computer system including the immersive environment volume control element displayed in the immersive environment control user interface element, detecting, via the one or more input devices, an input directed to the immersive environment volume control element, wherein the input corresponds to a request to change a volume level of the first immersive environment from the first volume level to a second volume level that is different from the first volume level; and
in response to detecting the input directed to the immersive environment volume control element, changing the volume level of the first immersive environment from the first volume level to the second volume level in accordance with the input directed to the immersive environment volume control element.

4. The method of claim 1, wherein the immersive environment control user interface element includes a time of day control element for changing a time of day setting of the immersive environment of the computer system, and wherein the method comprises:
while displaying a first immersive environment of the computer system with the time of day setting of the first immersive environment having a first value, and while displaying the control user interface of the computer system, including the immersive environment control user interface element, including the time of day control element, detecting, via the one or more input devices, one or more inputs including an input directed to the time of day control element, wherein the one or more inputs correspond to a request to change the time of day setting of the first immersive environment from having the first value to having a second value that is different from the first value; and
in response to detecting the one or more inputs, changing the time of day setting of the first immersive environment from having the first value to having the second value, including displaying, via the one or more display generation components, the first immersive environment with the time of day setting of the first immersive environment having the second value.

5. The method of claim 1, wherein the immersive environment control user interface element includes a first control element for changing the immersive environment of the computer system, and wherein the method comprises:
while displaying a first immersive environment of the computer system, and while displaying the control user interface of the computer system, including the immersive environment control user interface element, including the first control element, detecting, via the one or more input devices, one or more inputs including an input directed to the first control element, wherein the one or more inputs correspond to a request to change the immersive environment of the computer system from the first immersive environment to a second immersive environment that is different from the first immersive environment; and
in response to detecting the one or more inputs, displaying, via the one or more display generation components, the second immersive environment of the computer system.

6. The method of claim 1, wherein the immersive environment control user interface element includes a visual representation of the immersive environment of the computer system designated as being in use, and wherein:
in accordance with a determination that the immersive environment of the computer system is a first immersive environment, the immersive environment control user interface element includes a visual representation of the first immersive environment designated as being in use; and
in accordance with a determination that the immersive environment of the computer system is a second immersive environment that is different from the first immersive environment, the immersive environment control user interface element includes a visual representation of the second immersive environment designated as being in use, without including the visual representation of the first immersive environment, wherein the visual representation of the second immersive environment is different from the visual representation of the first immersive environment.

7. The method of claim 6, wherein the visual representation of the immersive environment of the computer system designated as being in use is displayed with a first amount of depth visual effect, wherein the first amount of depth visual effect is a nonzero depth visual effect.

8. The method of claim 6, comprising:
while displaying the immersive environment of the computer system, and while displaying the control user interface of the computer system, including the immersive environment control user interface element and the visual representation of the immersive environment designated as being in use, detecting, via the one or more input devices, an input directed to the visual representation of the immersive environment designated as being in use; and
in response to detecting the input directed to the visual representation of the immersive environment designated as being in use, updating display of the immersive environment control user interface element to include first information about a physical location corresponding to the immersive environment.

9. The method of claim 1, wherein:
the immersive environment control user interface element is configured to control the one or more environment parameters of the immersive environment of the computer system in accordance with a determination that the request to display the control user interface of the computer system is detected while not displaying respective content of a respective application in an immersive mode of the respective application at a first level of immersion; and
in accordance with a determination that the input corresponding to the request to display the control user interface of the computer system is detected while displaying the respective content of the respective application in the immersion mode of the respective application, the immersive environment control user interface element is configured to control one or more environment parameters of the application, without being configured to control the one or more environment parameters of the immersive environment of the computer system.

10. The method of claim 1, wherein the plurality of system controls displayed concurrently with the immersive environment control user interface element include one or more media playback controls.

11. The method of claim 1, wherein the plurality of system controls displayed concurrently with the immersive environment control user interface element include a system volume control element.

12. The method of claim 11, comprising:
while displaying the control user interface of the computer system including the system volume control element, detecting, via the one or more input devices, an input directed to the system volume control element, wherein the input directed to the system volume control element corresponds to a request to expand the system volume control element;
in response to detecting the input directed to the system volume control element, displaying, via the one or more display generation components, a volume control user interface that includes:
a first volume control for controlling a volume level of a first application; and
a second volume control for controlling a volume level of a second application different from the first application;
while displaying the volume control user interface, and while a volume level of a first application is at a first volume level, detecting, via the one or more input devices, an input directed to the first volume control, wherein the input directed to the first volume control corresponds to a request to change the volume level of the first application from the first volume level to a second volume level that is different from the first volume level; and
in response to detecting the input directed to the first volume control, changing the volume level of the first application from the first volume level to the second volume level.

13. The method of claim 1, wherein the plurality of system controls includes:
a first system control element for controlling a first system function of the computer system; and
a second system control element, different from the first system control element, for controlling a second system function the computer system that is different from the first system function of the computer system.

14. The method claim 1, wherein the computer system is a first computer system, wherein the plurality of system controls includes a first control element for controlling establishment of a connection between the first computer system and a second computer system that is different from the first computer system to use the one or more display generation components to display user interfaces of the second computer system, and wherein the method comprises:
detecting, via the one or more input devices, one or more inputs including an input directed to the first control element; and
in response to detecting the one or more inputs, modifying establishment of the connection between the first computer system and the second computer system in accordance with the one or more inputs.

15. The method of claim 1, wherein the plurality of system controls includes a first control element for controlling a spatial tracking mode of operation of the computer system, and wherein the method comprises:
detecting, via the one or more input devices, one or more inputs including an input directed to the first control element; and
in response to detecting the one or more inputs, updating a current spatial tracking mode of operation of the computer system in accordance with the one or more inputs.

16. The method of claim 1, wherein the plurality of system controls displayed concurrently with the immersive environment control user interface element include one or more application-specific controls configured to control one or more application functions of one or more applications on the computer system.

17. The method of claim 1, wherein:
displaying the control user interface of the computer system includes displaying in a first arrangement relative to each other a plurality of user interface elements including:
the immersive environment control user interface element; and
a second control user interface element configured to control one or more parameters of a first system function of the plurality of system functions of the computer system, wherein the one or more parameters of the first system function are different from the one or more environment parameters of the computer system; and
the method comprises:
while displaying the control user interface of the computer system including the plurality of user interface elements in the first arrangement, detecting, via the one or more input devices, one or more inputs, the one or more inputs corresponding to a request to change an arrangement of the plurality of the user interface elements from the first arrangement to a second arrangement relative to each other that is different from the first arrangement; and
in response to detecting the one or more inputs, displaying, via the one or more input devices, the plurality of user interface elements in the second arrangement relative to each other.

18. The method of claim 1, wherein:
displaying the control user interface of the computer system includes displaying a plurality of user interface elements including:
the immersive environment control user interface element; and
one or more additional user interface elements configured to control one or more parameters of one or more system functions of the plurality of system functions of the computer system, wherein the one or more system functions are different from the one or more environment parameters of the computer system; and
the method comprises:
while displaying the control user interface of the computer system including the plurality of user interface elements, detecting, via the one or more input devices, one or more inputs, the one or more inputs corresponding to a request to update the plurality of user interface elements with respect to a first user interface element; and
in response to detecting the one or more inputs, displaying, via the one or more input devices, the plurality of user interface elements in accordance with the request to update the plurality of user interface elements with respect to the first user interface element.

19. The method of claim 1, wherein the plurality of system controls displayed concurrently with the immersive environment control user interface element include a search user interface element that is selectable to display a search user interface, and wherein the method comprises:
while displaying the control user interface of the computer system including the search user interface element, detecting, via the one or more input devices, one or more inputs including an input directed to the search user interface element; and
in response to detecting the one or more inputs, updating display, via one or more display generation components, of the control user interface of the computer system to include the search user interface.

20. The method of claim 1, wherein the plurality of system controls displayed concurrently with the immersive environment control user interface element include a notifications user interface element including one or more representations of notifications from one or more applications on the computer system.

21. The method of claim 20, wherein displaying the notifications user interface element includes displaying a focus mode control element for controlling presentation of the one or more notifications from the one or more applications on the computer system, and wherein the focus mode control element is associated with a respective value, and the method comprises:
in response to detecting a notification event:
in accordance with a determination that the respective value is a first value, forgoing presentation of a first notification in a first manner corresponding to the notification event; and
in accordance with a determination that the respective value is a second value that is different from the first value, presenting the first notification in the first manner corresponding to the notification event.

22. The method of claim 1, comprising presenting, via the one or more display generation components, a three-dimensional environment, wherein the control user interface of the computer system is displayed in the three-dimensional environment.

23. The method of claim 1, wherein:
displaying the control user interface of the computer system includes displaying in a viewpoint of a user of the computer system a plurality of user interface elements in a first arrangement relative to each other, the plurality of user interface elements including:
the immersive environment control user interface element; and
a second control user interface element configured to control one or more parameters of a first system function of the plurality of system functions of the computer system, wherein the one or more parameters of the first system function are different from the one or more environment parameters of the computer system; and
the method comprises:
while displaying the control user interface of the computer system with the plurality of user interface elements in the first arrangement relative to each other in the viewpoint of the user of the computer system:
detecting, via the one or more input devices, an input directed to a first control element of the control user interface of the computer system; and
in response to detecting the input directed to the first control element of the control user interface of the computer system, performing an action with respect to the first control element while maintaining display of the control user interface of the computer system with the plurality of user interface elements in the first arrangement relative to each other in the viewpoint of the user of the computer system.

24. The method of claim 1, comprising:
while displaying the control user interface of the computer system, detecting, via the one or more input devices, a scroll input directed at the control user interface of the computer system, wherein the scroll input is associated with a direction and a requested amount of scrolling; and
in response to detecting the scroll input:
in accordance with a determination that the direction associated with the scroll input is a first direction, scrolling the control user interface of the computer system, including scrolling the immersive environment control user interface element and the plurality of system controls in a respective direction corresponding to the first direction and by an amount corresponding to the requested amount of scrolling; and
in accordance with a determination that the direction associated with the scroll input is a second direction, different from the first direction, scrolling through content of a first section of the control user interface of the computer system without scrolling through content of a second section, different from the first section, of the control user interface of the computer system in a respective direction corresponding to the second direction and by the amount corresponding to the requested amount of scrolling.

25. The method of claim 24, wherein the direction associated with the scroll input is the first direction, and wherein the method comprises:
while displaying the control user interface of the computer system in a first arrangement that is determined in accordance with the scroll input, detecting, via the one or more input devices, an input corresponding to a request to cease display of the control user interface of the computer system;
in response to detecting the input, ceasing display of the control user interface of the computer system;
while not displaying the control user interface of the computer system, detecting, via the one or more input devices, a second input corresponding to a second request to display the control user interface of the computer system; and
in response to detecting the second input:
in accordance with a determination that less than a first amount of time has passed since detecting the input corresponding to the request to cease display of the control user interface of the computer system, displaying, via the one or more display generation components, the control user interface of the computer system in the first arrangement that is determined in accordance with the scroll input; and
in accordance with a determination that at least the first amount of time has passed since detecting the input corresponding to the request to cease display of the control user interface of the computer system, displaying, via the one or more display generation components, the control user interface of the computer system in a second arrangement that is different from the first arrangement.

26. The method of claim 1, wherein displaying the control user interface of the computer system in response to the input corresponding to the request to display the control user interface of the computer system includes:
in accordance with a determination that a first application is in use when the input corresponding to the request to display the control user interface of the computer system is detected, displaying a first application user interface element in the control user interface configured to control one or more parameters of the first application; and
in accordance with a determination that a second application is in use, different from the first application, when the input corresponding to the request to display the control user interface of the computer system is detected, displaying a second application user interface element in the control user interface configured to control one or more parameters of the second application.

27. A computer system that is in communication with one or more input devices and one or more display generation components, the computer system comprising:
one or more processors;
memory; and
one or more programs, wherein the one or more programs are stored in the memory and configured to be executed by the one or more processors, the one or more programs including instructions for:
detecting, via the one or more input devices, an input corresponding to a request to display a control user interface of the computer system; and
in response to detecting the input corresponding to the request to display the control user interface of the computer system, displaying, via the one or more display generation components, the control user interface of the computer system, including concurrently displaying:
an immersive environment control user interface element configured to control one or more environment parameters of an immersive environment of the computer system; and
a plurality of system controls configured to control a plurality of system functions of the computer system.

28. A non-transitory computer readable storage medium storing one or more programs, the one or more programs comprising instructions, which when executed by one or more processors of a computer system that is in communication with one or more input devices and one or more display generation components, cause the computer system to perform operations comprising:
detecting, via the one or more input devices, an input corresponding to a request to display a control user interface of the computer system; and
in response to detecting the input corresponding to the request to display the control user interface of the computer system, displaying, via the one or more display generation components, the control user interface of the computer system, including concurrently displaying:
an immersive environment control user interface element configured to control one or more environment parameters of an immersive environment of the computer system; and
a plurality of system controls configured to control a plurality of system functions of the computer system.

29-55. (canceled)
